(19) United States
(12) Patent Application Publication
(10) Pub. No.: US 2012/0245858 A1
(43) Pub. Date: Sep. 27, 2012

(54) APPARATUSES AND METHODS FOR ANALYSIS OF SAMPLES THROUGH MULTIPLE THICKNESSES

(75) Inventors: Scott Alan Carpenter, Cupertino, CA (US); Raymond C. Gatti, Oakland, CA (US)

(73) Assignee: NuFORENSICS, Inc.

(21) Appl. No.: 13/049,903

(22) Filed: Mar. 17, 2011

(51) Int. Cl. G06F 15/00; G01N 23/02; G01B 15/02

(52) U.S. Cl. 702/28

(57) ABSTRACT

Apparatuses, methods, software, and systems for analyzing homogenous samples containing signal-emitting entities, such as, but not limited to, radioisotopes, are disclosed. The apparatuses mainly involve sample-container apparatuses that shape samples into different thicknesses; equipment; and software for detecting, processing, preserving, and presenting the signals and computational results. The methods mainly involve characteristic signal acquisition and processing in order to compute sample self-attenuation of signals emitted from within special sample-container apparatuses. The software intelligently pairs characteristic signals from samples of varying thicknesses; carries out the sample self-attenuation, transmittance, and other computations related to signal-detection-efficiency calibration of the detection system; and identifies and quantifies signal emitters. The systems primarily integrate and support the methods, apparatuses, and software as various embodiments that identify and quantify signal emitters within homogenous samples.

### STATEMENT OF GOVERNMENT INTEREST

This invention was made with Government support under Contract No. DE-AC02-05CH11231 awarded by the United States Department of Energy. The Government has certain rights in this invention.

### BACKGROUND

1. Technical Field

The present disclosure is generally related to sample analysis, and in particular, it is related to correcting for sample self-attenuation of signals emitted from within the sample. Emitted signals include gamma-rays (“g-rays”), x-rays, beta-rays, and alpha-rays that often follow the decay of radioisotopes but may also include stimulated x-ray emissions from non-radioactive isotopes or any other type of signal that attenuates as it travels through a volume of homogenous sample. One important application of this disclosure, among others, is reliable non-destructive nuclear forensic identification and quantitation of radioisotopes in a homogenous sample.

2. Description of the Related Art

The United States Environmental Protection Agency (“EPA”) reports that over 1,000 U.S. locations are contaminated with radiation. These sites range in size from small spaces in laboratories to massive nuclear weapons facilities. Such contamination is found in air, water, and soil, as well as in equipment and buildings. Radiation levels around such contaminated sites are closely monitored. Clean-up teams use modern technologies to assess the situation and take appropriate actions to limit potential hazards to people, the environment, the economy, and equipment. Besides such sites, general soil, air, and water sampling is required around mines, wells, basement construction, underground parking garages, and lower-level dwellings to ensure that natural radionuclides left over from the formation of the Earth's crust pose no elevated health risk. It is estimated that approximately one-third of all lung cancers are due in part to inhalation of radioactive radon gas that arises from the natural radioactive decay chains. If the price and reliability of sample analysis can be improved, then wider knowledge of the local hazards posed by natural ambient radioactivity and radon can be economically measured so that mitigating action can be taken when necessary for health and safety. Then there is the entire nuclear fuel cycle, from prospecting to mining, fuel production, operational sampling, and disposition. Nuclear power plant, hospital cyclotron, and radiopharmaceutical wastes also need sampling and measurement. In addition, scientific aging studies of lake, river, and ocean sediment rely on precise and accurate quantitation of radioisotopes in the soils, especially the radioisotope lead-210 (“Pb-210”). The International Atomic Energy Agency (“IAEA”) conducts sampling for compliance. Lunar and planetary rovers conduct sampling at a great distance. However, these measurements can be expensive and complex. Therefore, there is need for simple, reliable, and economical means for analyzing homogenous samples purported to contain signal emitters.

The Sample Self-Attenuation Problem.

One common type of signal emitter is a radioisotope. Radioisotopes emit several different kinds of signals primarily depending on the type of radioisotope. Some signals require chemical separation of a sample into like components to be followed by alpha-particle or beta-particle counting. Other signals, especially gamma-rays and x-rays, are readily detected by scintillators or solid-state crystals. Some apparatuses, methods, software, and systems are used for analyzing samples that emit gamma-ray and x-ray signals. However, their results are often far from accurate and require either expert skill to implement, or certain a priori knowledge about the sample composition that often isn't available. Simpler radioanalytical implementations suffer from the potential for very large errors in their reported results primarily due to simplifying assumptions and a general lack of important knowledge about the sample composition. Several common prior-art methods are briefly described now.

Create a Compositional Sample Analogue.

If the composition of a homogenous sample slated for assay is well characterized, e.g. if the elemental content is known, then one conventional approach to identifying and quantifying the signal emitters contained therein involves creating a compositional analogue of the sample and introducing known quantities of signal emitters from which the signal attenuation within the sample analogue can be computed and logically assigned to the assay sample, thus allowing its internal signal emitters to be quantified. There are several drawbacks to this sample analysis method, however, not the least of which is the problem of determining the composition of the assay sample so that an analogue can be prepared. In addition, analogue samples have their own list of difficulties. This analytical method is labor-intensive; time-consuming; and requires expert skill and training; it introduces uncertainty into the analytical procedure; it requires additional radioactivity in the form of tracer radioisotopes; and the homogeneity of the compositional analogue can be difficult to prove, especially if the analogue samples are solids.

Introduce a Tracer Directly into the Homogenous Sample.

By adding known quantities of signal emitter directly into the homogenous sample, it is possible to determine the signal attenuation within the sample and then ascribe such signal attenuation to the characteristic signals of the native signal emitters, in order to allow their quantification. The drawbacks to this method include the difficulty in verifying tracer homogeneity, especially if the sample is a solid or viscous liquid. In addition, the structure of the original sample will be somewhat disrupted, especially if the sample was a solid and was crushed or stirred in order to distribute the tracers homogenously. The process itself is labor intensive, time-consuming, and requires expert skill and training to implement; it creates waste; tracer lines may interfere with sample lines; the tracer signals may cause additional background noise and induce additional signal emission, e.g. induced x-ray fluorescence.

Sample Decomposition.

One conventional approach for identifying and quantifying unknown-sample-borne signal emitters (e.g. radioisotopes) is to perform sample decomposition and chemical separation to isolate different types of signal emitters according to their physical properties. Once isolated, thin sub-samples may be prepared for measurement by various analytical apparatuses, or, alternatively, the signal emitters can be incorporated into samples of known composition. Both of these sub-sample preparations are presumed to eliminate or facilitate determination of sub-sample self-attenuation. However, sample decomposition and chemical separation have undesired drawbacks that require careful attention. They are labor intensive, time-consuming, and require expert skill and training to avoid inherent dangers and carry out correctly; they introduce uncertainty into the analytical procedure; they produce additional toxic chemical and radiological waste, e.g. radioactive tracers, acidification, heating, boiling, and other chemical treatments; and they are sample-destructive.

Stochastic Modeling.

A different conventional approach uses numerical methods (one popular numerical method is the “Monte Carlo” method) to determine sample self-attenuation. But to be effective and reliable, numerical methods generally require detailed knowledge of sample composition, e.g. nature and amounts of the sample constituents—which may not be known—and the characteristic cross-sections for interaction between signals and the sample constituents. Monte Carlo-type numerical methods are not easily automated and generally require expert knowledge to implement properly.

A Grid of Compositional Standards and Resulting Characteristic Peak Ratios.

A conventional approach that creates a series of individual compositional homogeneous volume “standard-samples” loaded with known tracer quantities in order to build a ‘table’ of ratios comparing self-attenuation and characteristic peaks for such standard-samples. Then, samples having unknown composition and signal-emitter quantities can have their measured characteristic peak-height ratios compared to the standard-sample ratios, in order to interpolate between grid points to estimate and correct for each unknown-sample particular self-attenuation of emitted signals. This is a complicated, time-consuming procedure requiring skill and training. At low characteristic-signal energy or for thick samples, the sample self-attenuation is very sensitive to sample composition, which self-attenuation limits the whole procedure to higher characteristic signal energies or thin samples. In addition, each sample volume shape requires its own set of compositional standard-samples.

Use Thin Samples or High Characteristic Signal Energy.

Signal attenuation usually decreases as the signal energy increases. So then, to limit sample self-attenuation to less than some estimated value, operators prefer higher characteristic signal energies. This approach is one of the most widely used approaches in the measurement and quantitation of homogenous signal-emitting samples. The drawback here is that even at higher characteristic signal energies and thin samples, the sample self-attenuation is still significant. As the characteristic signal energy decreases or as the sample thickens, the magnitude of sample self-attenuation increases. At lower characteristic signal energies, the sample self-attenuation is substantial. A simple method is needed to determine sample self-attenuation at all characteristic signal energies, but especially at low characteristic signal energy.

Use a Beam-Through (“Beam-Thru”) Reference Source.

Another method used to determine sample self-attenuation is to use an external reference source to beam characteristic signals through the homogenous sample of interest. This approach also has several drawbacks: the expense of owning and managing the point sources; the potential interference of the beam-thru reference source characteristic signals with the sample characteristic signals; the introduction of other interferences, e.g. induced fluorescence spectral peaks; and elevated spectral noise.

In summary, conventional methods are employed to determine sample self-attenuation or to minimize the self-attenuation by keeping the sample thin or by relying on high-energy characteristic signals. In particular, because low-energy characteristic signals are very sensitive to sample composition, extraordinary skill is required to determine sample self-attenuation of low-energy characteristic signals. A simpler method is needed to determine sample self-attenuation that neither requires external beam-thru sources nor the addition of tracers to the sample volume.

Two prior-art apparatuses, methods, and systems used today are described in detail. The first prior-art description limits homogenous sample analysis to thin samples or high-energy characteristic signal emission so that the relatively small sample self-attenuation can be ignored. The second prior-art description uses an external beam-thru reference source to measure each homogenous sample transmittance over an energy range of interest.

### I. Common Prior Art for Analyzing Sample Unknowns

One type of tool for identifying and quantifying radioisotopes in homogenous samples is the gamma-ray/x-ray detection system. Such detection systems of this type usually include a cooling system, a semiconductor or scintillator crystal, pulse-shaping electronics, radiation shielding, and spectrum-analysis software.

### A Typical Detection System Setup (FIG. 1)

Referring now to FIG. 1, there is illustrated a typical counting-system setup 100. At the top is a radioactive sample 106 held within a cup-like container (“cup”) 104 that has a lid 102. The sample fills the cup to a certain depth (d) 122 in the direction of the detector 110. The sample mass (Mₛₘₚₗ) may be computed by weighing an empty sample-container apparatus 104 with its lid 102 (M_{cup}), followed by adding in the sample 106 (smpl) and weighing the sample, cup and lid together (M_{cup+smpl}). The sample mass (Mₛₘₚₗ) is the difference between the two weights.

Mₛₘₚₗ=M_{cup+smpl}−M_{cup} [1]

A particular signal emitter (Rⱼ) (e.g. a radioisotope) in a unit of sample mass has an emission rate that is commonly reported as “specific activity” (SpA_{Rj,smpl}). Such specific activity often results in the emission of energy-specific decay photons called “characteristic photons” that act like the lines of a radionuclide ‘fingerprint’ in the emission spectra. A given specific signal emitter may emit several characteristic photons, and each has an energy-specific (Eᵢ) probability for emission called “yield-fraction” (YF_{Rj,Ei}). When a characteristic signal is emitted from a small volume-of-sample 124 within a whole sample 106, it must pass through some portion of such sample in order to escape the sample entirely. There is a probability that the emitted signal is attenuated as it passes through and interacts with the surrounding sample. The fraction of characteristic signals that are attenuated within the sample can be called the “sample-specific attenuated-fraction” (AttnF_{Ei,smpl}). The other fraction that was not attenuated within the sample, i.e. the fraction that escapes the sample undiminished in energy, can be called the “sample-specific escaped-fraction” (EscF_{Ei,smpl}). Therefore, for any given sample, the sample-specific attenuated-fraction and sample-specific escaped-fraction terms sum to unity.

AttnF_{Ei,smpl}+EscF_{Ei,smpl}=1 [2a]

To correct for that fraction of characteristic signals that is attenuated in the sample 106, a “sample-specific attenuation-corrected factor” (AttnCF_{Ei,smpl}) is defined.

$${AttnCF}_{Ei , smpl} = \frac{1}{{EscF}_{Ei , smpl}} = {( {EscF}_{Ei , smpl} )}^{- 1} = \frac{1}{1 - {AttnF}_{Ei , smpl}} \qquad [ 2 b ]$$

For those characteristic signals that escape the sample 106, only a fraction are headed in a direction to intercept the detector; this fraction is called the “geometry-fraction, (GF)”, which is defined by the solid angle 126 spanned by the sensitive volume of the detector 110. Before reaching the detector, those sample-escaped characteristic signals within the solid angle 126 must pass through attenuating materials that include the sample-container apparatus wall 104; any air or gas between the sample-container apparatus wall 104 and the detector window 108; the detector window 108; and the detector dead layer; and thence be fully absorbed in the detector 110 itself. Each of these materials has a probability for attenuating and absorbing characteristic photons emitted from the sample 106. The fraction of characteristic signals that escaped the sample to register in the detection system 100 as full-energy counts (C_{Ei,smpl}) is called the “captured-fraction” (CapF_{Ei}).

In addition to the detector window 108, a sturdy casing 112 also helps to vacuum-seal the detector 110. Barring other loss mechanisms, characteristic signals that fully absorb and register in the detector produce electrical pulses that are passed along to associated commercial pulse-shaping electronics 114. The shaped pulses are commonly passed to a computer 116 that has spectrum-analysis software installed 118. The pulses are stored and they accumulate so long as the detection system 100 continues counting them. Over time, enough pulses taken together form what is commonly called a ‘gross spectrum’, where the word, “gross” indicates that pulses due to the non-sample ambient background signal emission have not yet been ‘subtracted out’ to leave only those pulses coming from the sample 106. The spectrum analysis software 118 usually allows for removing most of such non-sample background counts by calling in and normalizing an ambient background emission spectrum 200 (in FIG. 2) to the sample counting time (tₛₘₚₗ), thence subtracting out such normalized ambient background emission spectrum from the gross characteristic spectrum, to yield the net characteristic sample spectrum 130. The spectrum 130 is comprised of many peaks ‘riding on top of’ a sample-derived background, which is different from the non-sample ambient background signal emission. Each characteristic decay peak acts, analogously, like a line in an emission spectrum ‘fingerprint’, and when multiple lines are combined with their well known characteristic signal-emission yield-fractions (YF_{Rj,Ei}), they uniquely identify individual signal emitters within the sample 106. Spectrum-analysis software 118 often use A commercial or user-developed database of signal emitters (Rⱼ) and their characteristic-decay yield-fractions (YF_{Rj,Ei}) to attempt to identify the signal emitters (Rⱼ) in the sample. A human expert should visually review the spectrum and signal-emitter identifications made by the spectrum-analysis software because the software often misidentifies the signal emitters.

It would be advantageous to measure the three terms independently: sample-specific escaped-fraction (EscF_{Ei,smpl}), geometry-fraction (GF), and captured-fraction (CapF_{Ei}), but existing methods for doing so are not easily implemented. Thus, commonly, these three terms are treated as a single grouped term that can be called the “sample-specific detected-fraction” (DetF_{Ei,smpl}).

DetF_{Ei,smpl}=(EscF_{Ei,smpl}*GF*CapF_{Ei}) [3]

The number of counts (C_{Ei,smpl}) in a spectral peak is partly computed by the length of counting time (tₛₘₚₗ). The sample counting time (tₛₘₚₗ) may be shorter than the length of time as measured by a typical wristwatch (t_{wristwatch}) because sample counting time (tₛₘₚₗ) rejects those short ‘snippets’ of time taken by the detection system ‘dead time’ (t_{dead}), ‘rise time’ (tᵣᵢₛₑ), ‘pileup’ (tₚᵢₗₑᵤₚ), and possibly other phenomena (tₒₜₕₑᵣ) that limit the actual length of time that the detection system is available (tₛₘₚₗ) to register peak counts (C_{Ei,smpl}).

tₛₘₚₗ=(t_{wristwatch})−(t_{dead}+tᵣᵢₛₑ+tₚᵢₗₑᵤₚ+tₒₜₕₑᵣ) [4]

It is convenient to define the equipment and software that performs signal detection, processing, preservation, and presentation as a ‘subsystem’ 120.

The relationship between each spectral peak's counts (C_{Ei,smpl}) and the other terms is shown in the “count-balance equation” of [4a].

C_{Ei,smpl}=Mₛₘₚₗ*SpA_{Rj,smpl}*YF_{Rj,Ei}*(EscF_{Ei,smpl}*GF*CapF_{Ei})*tₛₘₚₗ [4a]

The characteristic peak counts (C_{Ei,smpl}) is equal to the sample mass (Mₛₘₚₗ), multiplied by the specific activity (SpA_{Rj,smpl}), multiplied by the characteristic yield-fraction (YF_{Rj,Ei}) for each radionuclide (Rⱼ), multiplied by the sample-specific escaped-fraction (EscF_{Ei,smpl}), multiplied by the geometry-fraction (GF), multiplied by the captured-fraction (CapF_{Ei}), and multiplied by the sample counting time (tₛₘₚₗ). Because the three grouped terms shown in parentheses in [4a] are not easily computed individually, they are commonly treated as a single variable called the “sample-specific detected-fraction” (DetF_{Ei,smpl}), and the count-balance equation simplifies to [4b].

C_{Ei,smpl}=Mₛₘₚₗ*SpA_{Rj,smpl}*YF_{Rj,Ei}*(DetF_{Ei,smpl})*tₛₘₚₗ [4b]

Equation [4b] summarizes the detection system setup in FIG. 1.
Analyzing Unknowns within a Given Sample

One of the main goals of the signal-detection system is the analysis of samples containing unknown signal emitters whose quantities are also unknown. One type of signal-detection system is the radiation detection system. One common class of sample is that which is sufficiently homogenous in composition throughout its volume and observable by a signal detector. One methodology for analyzing such homogenous unknown-samples is comprised of three major parts. The first part is ambient background counting. The second part is to perform a sample-specific detected-fraction calibration (DetF_{Ei,smpl}) of the signal-detection system. The third part is to measure and analyze unknown-samples to determine their signal-emitting sources. In addition to these three main parts are other supporting steps, e.g. escape-peak corrections and peak summing-in and summing-out corrections, among others, which supporting steps are covered in the literature and are not described here.

### Part 1. Ambient Background Counting

Sample counting produces a gross characteristic spectrum that usually contains, as a component, characteristic photons originating from ambient background signal emissions from sources external to the sample. Consequently, ambient background counting is performed to determine the count rate of characteristic ambient background signal emissions, so that the ambient background emission spectrum can be normalized to, and then subtracted out of, a gross characteristic spectrum, thus leaving only the net characteristic spectrum attributable to the signal emitters in the sample. FIG. 2 shows an ambient background counting system setup 200 that is used to obtain a spectrum of the ambient background environment. The ambient background signal emissions can come from the sample-container apparatus materials, counting chamber materials, detection system materials, cosmic rays, natural radioactive decay series in the ground beneath the detector, and in the air as radioactive radon and its ‘daughters’; and possibly other non-sample sources. An empty sample-container apparatus is part of the ambient background counting system setup 200. The empty sample-container apparatus consists of a cap 202, container wall 204, and an internal empty space 206 void of any sample. The size, shape, and position of the empty sample-container apparatus with respect to the detector 110 (FIG. 1) should be the same as that planned for containers holding standard-samples used to calibrate the counting system, and for containers holding unknown-samples to be measured and analyzed by the counting system. Because ambient background count rates are usually low, it is common to take a long background count (t_{bkgrd}). Subsystem 120 detects characteristic signals, processes them, preserves them, and presents them as an ambient characteristic background spectrum 230, an illustration of which is shown at the bottom of FIG. 2. To ensure that characteristic ambient background radiation levels are not changing significantly, an ambient characteristic background spectrum is taken periodically, perhaps once each week or month, depending on many circumstances usually judged by the experience of the operator or by established protocol.

### Part 2. Sample-Specific Detected-Fraction Calibration (FIG. 3)

Before signal-detection systems can be used to quantify signal emitters, based on their characteristic emission spectra, a detection-efficiency calibration of some kind is usually required. One such system 300 for calibrating signal detection efficiency is illustrated in FIG. 3, where a compositionally well known standard-sample 306 is prepared in the same type of container cup 304 and cap 302, and placed in the same position relative to the detector 110 in FIG. 1, as were the container cup 204 and cap 202 that were used to determine an ambient background emission spectrum 230 in FIG. 2. The counting-system calibration is composed of a subsystem 326 used to acquire the standard-sample characteristic emission spectrum 330. The subsystem 326 consists of a standard-sample 306 put into a capped 302 container cup 304 to a particular depth 322 in the direction of the signal detection, processing, preservation, and presentation subsystem 120. A certain fraction of the standard-sample characteristic photons 324 intercept subsystem 120. Subsystem 120 normalizes a characteristic ambient background emission spectrum 200 to the standard-sample counting time (t_{stnd}) and then subtracts that normalized characteristic ambient background emission spectrum from the gross measured standard-sample spectrum (the gross spectrum is not illustrated in FIG. 3) to produce a net standard-sample emission spectrum 330 comprised of multiple spectral peaks. A commercial or user-developed spectral peak processing subsystem 334 computes, for each characteristic spectral peak of interest, a sample-specific detected fraction calibration (DetF_{Ei,stnd}), and all of these calibration points 338 together are fitted to one or more smooth functions that, when combined together, is called the “calibration curve” 344 and covers the entire usable energy detection range of the signal-detection system. An operator may choose to use the detected-fraction calibration points 338, calibration curve 344, or both, in order to include characteristic peaks not present in the standard-sample. It is convenient to refer to the calibration points and curve jointly as the “sample-specific detected-fraction calibration” 348.

The first step of one common method for performing a counting-system sample-specific detected-fraction calibration (DetF_{Ei,stnd}) is to count one or more signal-emitting standard-samples (stnd) 306 having known mass (M_{stnd}), signal emitter identity (Rⱼ), and specific activity quantity (SpA_{Rj,stnd}) for an amount of counting time (t_{stnd}) to produce a gross sample spectrum that includes the combined characteristic radiation derived from the standard-sample radioactive content and from the ambient background radiation. After normalizing and subtracting the ambient background emission spectrum 200, the remaining spectrum is comprised of the net standard-sample counts 330 showing several spectral peak-counts (C_{Ei,stnd}). From this information the sample-specific detected-fraction calibration (DetF_{Ei,stnd}) can be computed, and one common process for doing so is now described.

Equation [3] is rewritten using subscripts to indicate that the sample is a known standard-sample (stnd) that is being counted.

DetF_{Ei,stnd}=(EscF_{Ei,stnd}*GF*CapF_{Ei}) [5]

As long as the volume-shape and position relative to the detection system for all samples to be counted remains the same (standard-samples and unknown-samples), and as long as the type of sample-container apparatus is always of the same type, shape, and size, then the geometry-fraction term (GF) remains constant for all characteristic photons, independent of the particular homogenous sample composition, and the characteristic capture-fraction term (CapF_{Ei}) keeps the same characteristic value independent of the particular homogenous sample composition. Because the sample-specific escaped-fraction term (EscF_{Ei,stnd}) deals directly with the probability of a characteristic photon escaping a particular sample un-attenuated, it does depend on the particular sample composition. In addition, because the standard-sample sample-specific escaped-fraction (EscF_{Ei,stnd}) is one of the grouped terms in the sample-specific detected fraction calibration term (DetF_{Ei,stnd}), it too depends on the composition of the standard-sample. The count-balance Equations [4a] and [4b] are rewritten using subscripts to indicate that a standard-sample (stnd) is being counted.

C_{Ei,stnd}=M_{stnd}*SpA_{Rj,stnd}*YF_{Rj,Ei}*(EscF_{Ei,stnd}*GF*CapF_{Ei})*t_{stnd} [6a]

C_{Ei,stnd}=M_{stnd}*SpA_{Rj,stnd}*YF_{Rj,Ei}*(DetF_{Ei,stnd})*t_{stnd} [6b]

The terms of Equation [6b] are rearranged to solve for the sample-specific detected-fraction calibration (DetF_{Ei,stnd}).

$${DetF}_{Ei , stnd} = \frac{{C}_{Ei , stnd}}{{M}_{stnd} * {SpA}_{Rj , stnd} * {YF}_{Rj , Ei} * {t}_{stnd}} \qquad [ 7 a ]$$

With enough characteristic spectral peaks over the energy range of interest, curve-fitting may be performed to determine one or more fitted functions (of energy, Eᵢ) [7b] that smoothly approximate 344 the individual calibration points 338.

$$\frac{{C}_{Ei , stnd}}{{M}_{stnd} * {SpA}_{Rj , stnd} * {YF}_{Rj , Ei} * {t}_{stnd}} \to {DetF ( {E}_{i} )}_{stnd} \qquad [ 7 b ]$$

The sample-specific detected-fraction, DetF_{Ei,stnd} or DetF(Eᵢ)_{stnd}, defines what fraction of all emitted characteristic photons are counted (C_{Ei,stnd}) by the detection system. At the bottom of FIG. 3 is shown an illustration of the sample-specific detected-fraction curve 344, which shows that, with increasing characteristic energy (Eᵢ) the detected fraction rises to a maximum before falling as characteristic energy increases still further. At even higher energy, the detected fraction approaches zero. The mid-energy range of characteristic photons sets the best balance between being “energetic enough” to escape the sample material and penetrate the intervening materials to fully absorb and register in the active volume of the detector; yet “not so energetic” that too few characteristic photons fully absorb and register in the detector material. Once the detection system is efficiency-calibrated, it is ready to use to acquire spectra of unknown-samples (unkn) having substantially the same sample composition as that of the standard-sample (stnd), and to analyze those unknown-sample spectra to identify and quantify radioisotopes within those unknown-samples.

### Part 3. Radioisotope Identification and Quantitation (FIG. 4)

FIG. 4 shows one prior-art system 400 for determining radioisotope identity and quantity 450 in homogeneous unknown-samples (unkn) 406 that are placed in the same type of container cup 404 and cap 402, and placed in the same position relative to the detector 110 in FIG. 1, as was the standard-sample that was used to perform a sample-specific detected-fraction calibration 300 in FIG. 3.

The system 400 is composed of a subsystem 426 used to acquire unknown-sample characteristic emission spectrum 430. The subsystem 426 consists of an unknown-sample 406 put into a capped 402 container cup 404 to a particular depth 422 in the direction of the signal detection, processing, preservation, and presentation subsystem 120. A certain fraction of the unknown-sample characteristic photons 424 intercept subsystem 120. Subsystem 120 normalizes a characteristic ambient background emission spectrum 200 to the unknown-sample counting time (tᵤₙₖₙ), and then subtracts that normalized characteristic ambient background emission spectrum from a gross measured unknown-sample spectrum (the gross spectrum is not illustrated in FIG. 4) to produce a net unknown-sample emission spectrum 430 comprised of multiple spectral peaks. A commercial or user-developed spectral-peak-processing subsystem 434 reads as input the sample-specific detected-fraction calibration (DetF_{Ei,stnd}) 300 and, for each characteristic spectral peak in the unknown-sample net spectrum 430, computes and reports their source emitting radioisotopes and their specific activities 450.

Determining the radioisotope identification and quantitation in a homogeneous unknown-sample 406 begins by placing the unknown-sample (unkn) in proximity to the detector as illustrated in the upper-right side of FIG. 4. The mass of the unknown-sample (Mᵤₙₖₙ) is known because it is weighed, possibly by the method described in the discussion surrounding Equation [1]. The unknown-sample spectrum-acquisition subsystem 426 begins counting, and after a length of counting time (tᵤₙₖₙ), a gross unknown-sample spectrum is acquired (the gross spectrum is not illustrated in FIG. 4). Subsystem 120 normalizes the background spectrum 200 to the unknown-sample counting time (tᵤₙₖₙ), and then subtracts out the normalized background spectrum 200, leaving a net unknown-sample characteristic emission spectrum 430. Each characteristic decay peak in the spectrum has an associated number of recorded counts (C_{Ei,unkn}). Equation [3] is rewritten using subscripts to indicate that it is an unknown-sample (unkn) that is being counted.

DetF_{Ei,unkn}=(EscF_{Ei,unkn}*GF*CapF_{Ei}) [8]

As long as the volume-shape and position relative to the detection system for all samples to be counted remains the same (standard-samples and unknown-samples), and as long as the type of sample-container apparatus is always of the same type, shape, and size, then the geometry-fraction term (GF) remains constant for all characteristic photons, independent of the particular homogenous sample composition, and the characteristic capture-fraction term (CapF_{Ei}) keeps the same characteristic value independent of the particular homogenous sample composition. Because the sample-specific escaped-fraction term (EscF_{Ei,unkn}) deals directly with the probability of a characteristic photon escaping a particular sample un-attenuated, it does depend on the particular sample composition. In addition, because the unknown-sample sample-specific escaped-fraction (EscF_{Ei,unkn}) is one of the grouped terms in the sample-specific detected-fraction calibration term (DetF_{Ei,unkn}), it too depends on the composition of the unknown-sample. The count-balance Equations [4a] and [4b] are now rewritten with different subscripts to indicate that an unknown-sample (unkn) is being counted.

C_{Ei,unkn}=Mᵤₙₖₙ*SpA_{Rj,unkn}*YF_{Rj,Ei}*(EscF_{Ei,unkn}*GF*CapF_{Ei})*tᵤₙₖₙ [9a]

C_{Ei,unkn}=Mᵤₙₖₙ*SpA_{Rj,unkn}*YF_{Rj,Ei}*(DetF_{Ei,unkn})*tᵤₙₖₙ [9b]

The terms of Equations [9a] and [9b] are rearranged to solve for the specific-activity quantities (SpA_{Rj,unkn}) of the identified radioisotopes (Rⱼ) in the unknown-sample.

$$\begin{matrix}{SpA}_{Rj , unkn} = \frac{{C}_{Ei , unkn}}{{M}_{unkn} * {YF}_{Rj , Ei} * ( {EscF}_{Ei , unkn} * {GF}_{Ei} * {CapF}_{Ei} ) * {t}_{unkn}} & [ 10 a ] \\ {SpA}_{Rj , unkn} = \frac{{C}_{Ei , unkn}}{{M}_{unkn} * {YF}_{Rj , Ei} * ( {DetF}_{Ei , unkn} ) * {t}_{unkn}} & [ 10 b ]\end{matrix}$$

Now that the unknown-sample net spectrum 430 is obtained, the three known terms in [10b] are the characteristic peak counts (C_{Ei,unkn}), the unknown sample mass (Mᵤₙₖₙ), and the counting time (tᵤₙₖₙ). The three unknown terms remaining in [10b] are the specific activity (SpA_{Rj,unkn}), characteristic yield-fraction (YF_{Ri,Ei}), and the sample-specific detected-fraction (DetF_{Ei,unkn}).

To determine the yield-fraction term (YF_{Rj,Ei}), the operator commonly uses commercial or user-developed spectral peak processing 434 to map each characteristic spectral peak to a specific radioisotope identity (Rⱼ). An operator should always review automated software identifications because such identifications are often wrong. Once the radioisotopes (Rⱼ) are presumed to be correctly identified, the associated yield-fraction values (YF_{Rj,Ei}) can be obtained from published lists.

To quantify the specific activity (SpA_{Rj,unkn}) of each identified radioisotope (Rⱼ), only the sample-specific detected fraction (DetF_{Ei,unkn}) remains to be calculated. The operator's next action, the results of which are often erroneous, is to call in the standard-sample “detected-fraction calibration points” (DetF_{Ei,stnd}) 338 or the “detected-fraction calibration curve” (DetF(Eᵢ)_{stnd}) 344 and substitute either of such values for the unknown-sample sample-specific detected fraction term (DetF_{Ei,unkn}) from Equation [10b]. For example, substituting DetF(Eᵢ)_{stnd} for DetF_{Ei,unkn}, we obtain:

$${SpA}_{Rj , unkn} = \frac{{C}_{Ei , unkn}}{{M}_{unkn} * {YF}_{Rj , Ei} * {DetF ( Ei )}_{stnd} * {t}_{unkn}} \qquad [ 10 c ]$$

The result of Equation [10c] is often erroneous because it presumes that the difference in sample attenuation between the standard-sample and the unknown-sample is relatively small when compared to other uncertainties, when this is often not the case.

### Prior Art Subsystem Summary (FIG. 5)

Referring now to FIG. 5, for the purpose of describing a conventional system 500 of apparatuses, methods, and software used to identify and quantify radioisotopes in homogenous samples, there summarizes a subsystem block diagram of the overall system 500.

Prior to being able to report the identity and quantity of radioisotopes in unknown-samples, first the signal detection efficiency of the system must be calibrated (300). Three subsystems 326, 334, and 348 are described to accomplish such calibration (300). A standard-sample whose composition is known is used by subsystem 326 to acquire the standard-sample characteristic decay photon spectrum. The spectral-peak-processing subsystem 334 identifies and processes each spectral peak to determine the detection system sample-specific detected-fraction calibration. The sample-specific detected-fraction calibration in 348 covers the energy range of interest, and these values will be used by the unknown-sample-analysis system 400 to identify and quantify radioisotopes in the unknown-sample.

The unknown-sample-analysis system 400 is further comprised of three subsystems 426, 434, and 450. Subsystem 426 determines the net characteristic spectrum emanating from an unknown-sample. The spectral-peak-processing subsystem 434 uses the sample-specific detected-fraction calibration values 348 to make corrections to the spectral-peak counts 426 to make up for the inefficiency of the signal-detection system in detecting all emitted characteristic photons. The identity and specific activity subsystem 450 documents the identity and quantity of radioisotopes found in the analyzed unknown-sample.

### Prior Art Methodological Summary (FIG. 6)

FIG. 6 illustrates the methodological steps 600 used by many operators to identify and quantify signal emitters within homogenous samples. The primary activity and result of Step-1 (610), is to acquire an ambient background emission spectrum.

The primary activity and result of Step-2 (622), is to count a homogenous standard-sample of known signal emitters in order to acquire a gross spectrum that contains both the characteristic signals coming from within the standard-sample and the characteristic signals coming from the ambient background. The primary activity and result of Step-3 (624), is to take the ambient background emission spectrum 610 that was obtained in Step-1, normalize it to the counting time of the standard-sample gross spectrum obtained in Step-2 (622), and then to subtract the normalized ambient background emission spectrum from the gross spectrum resulting in the net standard-sample characteristic emission spectrum 624. The primary activity and result of Step-4A (626), is to compute, for each spectral peak in the standard-sample characteristic emission spectrum, a sample-specific detected-fraction calibration point. The primary activity and result of Step-4B (628), is to compute, from the sample-specific detected-fraction calibration points, a smooth sample-specific detected-fraction curve, function, or ‘patchwork’ of curves or functions, to cover the energy range of interest. Steps 2, 3, 4A, and 4B are usually performed in order, and thus represent a series of consecutive steps that result in the sample-specific detected-fraction calibration 620.

The primary activity and result of Step-5 (642), is to count a homogenous unknown-sample of unknown signal emitters and quantities in order to acquire a gross spectrum that contains both the characteristic signals coming from within the unknown-sample and those signals coming from the ambient background emission spectrum. The primary activity and result of Step-6 (644), is to take the ambient background emission spectrum that was obtained in Step-1 (610), normalize it to the counting time of the unknown-sample gross spectrum 642 obtained in Step-5, and then to subtract the normalized ambient background emission spectrum 610 from the gross spectrum, resulting in the net unknown-sample characteristic emission spectrum 644. The primary activity and result of Step-7 (646) is to identify and quantify the signal emitters within the unknown-sample by using the inverse of the sample-specific detected-fraction calibration points 626 or curve 628 to correct up the characteristic peaks in the unknown-sample net emission spectrum 644. The operator or established protocol usually determines which of the calibration points 626 and calibration curve 628 to use in the peak-correction computations for a given unknown-sample and emission spectrum, in order to identify and quantify the signal emitters 646 present. Steps 5, 6, and 7 are usually performed in order, and thus represent a series of consecutive steps that result in identifying and quantifying the signal emitters within an unknown-sample 640.

### The Operator's Dilemma (FIGS. 7 and 8)

The dilemma faced by operators who use the just described system is that the system only works well when all of the unknown-samples undergoing analysis and all of the standard-samples used to determine the sample-specific detected-fraction calibration have the same homogeneous composition and density. However, if as often occurs, the composition or density of the standard-samples and unknown-samples are even slightly different, then severe under-reporting of the radiation in the unknown-samples can result because characteristic photons attenuate differently in different sample compositions. The sample-specific escaped-fraction (EscF_{Ei,smpl}) will differ for any two samples of differing composition, and their respective sample-specific detected-fractions (DetF_{Ei,smpl}) will then also differ.

If: EscF_{Ei,unkn}≠EscF_{Ei,stnd} [11a]

then: (EscF_{Ei,unkn}·GF·CapF_{Ei})≠(EscF_{Ei,stnd}·GF·CapF_{Ei}) [11b]

and: (DetF_{Ei,unkn})≠(DetF_{Ei,stnd}) [11c]

Consequently, Equation [10c] cannot be used to determine the specific activities of radioisotopes in unknown-samples (SpA_{Rj,unkn}) whose compositions differ from the standard-sample. To appreciate the magnitude of the inaccuracy involved when specific sample compositions are not taken into account, a brief analysis of two key factors—sample thickness (or depth) and signal energy—are now described.

The effect on sample self-attenuation from the first key factor, i.e. sample thickness or sample-depth (x-axis), is illustrated by graph 700 in FIG. 7, which compares how the values of the sample-specific escaped-fractions for a homogeneous water sample (EscF_{46keV,water}) (thick dashed line 758) and a typical soil sample (EscF_{46keV,soil}) (solid line 704) vary with sample thickness (x, in cm) for a 46.5-keV characteristic decay photon from the radioactive isotope lead-210 (Pb-210). The 46.5-keV characteristic decay photon is one of the most important, most commonly counted radionuclide gamma-rays used in environmental studies; it is used to age-date sediments in lakes, estuaries, and coastal marine environments; it is used to assess regional radon risk; and it plays a role in uranium exploration, among other uses.

As a first example of how sample thickness affects sample self-attenuation, FIG. 7 shows that, for a 10-cm thick typical soil sample 714, only about one-tenth (0.1) of the 46.5-keV photon emissions escape from the soil sample un-attenuated; the other nine-tenths (0.9) are attenuated within the soil sample. However, FIG. 7 compares the aforementioned soil sample to a 10-cm-thick water sample 718, where not quite four-tenths (0.4) of the 46.5-keV photon emissions escape from the water sample un-attenuated, and the other six-tenths (0.6) are attenuated within the water sample. Thus, if an operator counts a 10-cm thick soil sample in a counting system that was calibrated using a water-based standard; and neglects to account for the difference in sample self-attenuation between the soil-based unknown-sample and the water-based standard-sample; then the operator will report a Pb-210 radioactivity level nearly four times too low!

(EscF_{46keV,water,10cm})/(EscF_{46keV,soil,10cm})≈(0.4)/(0.1)≈4 [12a]

As a second example of how sample thickness affects sample self-attenuation, FIG. 7 also shows that, for a 2-cm thick typical soil sample 764, that only about four-tenths (0.4) of the 46.5-keV photon emissions escape from such soil sample un-attenuated, whereas the other six-tenths (0.6) are attenuated within the soil sample. However, FIG. 7 compares the aforementioned soil sample to a 2-cm-thick water sample 768, where about eight-tenths (0.8) of the 46.5-keV photon emissions escape from the water sample un-attenuated, and the other two-tenths (0.2) are attenuated within the water sample. Thus, if an operator counts a 2-cm thick soil sample in a counting system that was calibrated using a water-based standard; and neglects to account for the difference in sample self-attenuation between the soil and the water samples; then the operator will report a Pb-210 radioactivity level nearly two times too low!

(EscF_{46keV,water,2cm})/(EscF_{46keV,soil,2cm})≈(0.8)/(0.4)≈2 [12b]

In the examples of both the 10-cm and 2-cm thick soil samples, the under-reporting of the radiation content can be severe, which might lead to under-classifying otherwise dangerous samples; to scientifically inaccurate environmental sediment studies that result in poor policy decision-making; to increased radon health risks; or failure to recognize violations of environmental, safety, and waste regulations, etc.

The effect on sample self-attenuation from the second key factor, i.e. signal energy, is illustrated by graph 800 in FIG. 8, which shows how the “Radiation Under-reporting Factor (EscF_{water}/EscFₛₒᵢₗ)”, y-axis, varies with “Characteristic Energy, Eᵢ, (keV)”, x-axis. As a first example of the relationship between signal energy dependence and self-attenuation within different sample compositions, FIG. 8 shows that, for a relatively high-energy, 1000-keV gamma-ray 812 emitted from a 10-cm-thick, homogeneous water standard-sample versus the same energy emitted from a 10-cm-thick, homogeneous soil sample, a larger fraction of the characteristic photons escape the water standard-sample (EscF_{1000keV,water}/EscF_{1000keV,soil}). As a result, if such discrepancy is not taken into account for the soil sample, then radiation from the soil sample will be under-reported by a factor of 1.2 (i.e. under-reported by 20%), which may be too much of an error for most scientific work, and which may violate environmental safety regulations. In contrast, if the water standard-sample and the soil sample are both reduced to 2-cm in thickness for the same 1000-keV gamma-rays 816, then the radiation from the soil sample will be under-reported by only a few percent. This fact might inadvertently provide the motivation to decrease the quantity of sample analyzed in order to lower the discrepancy between attenuations of different sample compositions, even when the characteristic photon energy is high.

As a second example of the relationship between signal energy dependence and self-attenuation within different sample compositions, FIG. 8 shows that for a relatively low-energy 46.5-keV gamma-ray 822 emitted from a 10-cm-thick homogeneous water standard-sample versus the same energy emitted from a 10-cm-thick homogeneous soil sample, a much larger fraction of the characteristic photons escape the water standard-sample, and thus, if the discrepancy is not taken into account, radiation from the soil sample will be under-reported by a factor of 4. If the water standard-sample and the soil sample are both reduced to only half a centimeter (0.5 cm) in thickness 826, then the under-reporting of radiation from the soil sample falls to a factor of 1.2 (i.e. under-reported by 20%), and so there is always a motivation to decrease the quantity of sample analyzed in order to lower the discrepancy between attenuations of different sample compositions, especially if the characteristic energy is low. At low energy, the attenuation of photons is very sensitive to the composition of the sample, and it only takes a minor difference in sample composition to make a big difference in the probability for characteristic photons to escape the sample.

Operators may attempt to ignore the under-reporting of radioactivity between the water standard-sample and soil sample by minimizing the effects of differing sample compositions, such as by using thin samples or by using only high-energy signals of over 1000 keV. Nevertheless, the error introduced when differing sample compositions are treated as if they have the same transparency can still be quite large.

Without a method for determining each sample self-attenuation, low-energy signals or thick samples can lead to severe radiation under-reporting. A simple method is desired that determines the sample-specific escaped-fraction (EscF_{Ei,smpl}) for every standard-sample, and for every unknown-sample. The next prior-art method describes a relatively simple but problematic common method for determining each sample escaped-fraction (EscF_{Ei,smpl}); it is the beam-thru method.

### II. Common Prior Art for Determining Sample Self-Attenuation

The field of radio spectroscopy seeks a simple method for measuring the fraction of characteristic photons that escape each homogeneous sample, known as the “sample-specific escaped-fraction” (EscF_{Ei,smpl}). Doing so ‘un-mingles’ the sample attenuation from the geometry-fraction (GF) and the captured-fraction (CapF_{Ei}) to count characteristic photons. Equations [13a] to [13c] develop the relationship between the sample-specific detected-fraction (DetF_{Ei,smpl}) and the sample-free detected-fraction (DetF_{Ei,smplFr}).

DetF_{Ei,smpl}=(EscF_{Ei,smpl}*GF*CapF_{Ei}) (see Equation [3] and FIG. 1 discussion) [13a]

DetF_{Ei,smpl}=EscF_{Ei,smpl}*(GF*CapF_{Ei}) [13b]

DetF_{Ei,smpl}=EscF_{Ei,smpl}*(DetF_{Ei,smplFr}) [13c]

DetF_{Ei,smplFr} includes only the two terms, GF and CapF_{Ei}, which are both independent of sample attenuation and thus hold constant for all homogeneous samples of similar volume-shape and counting position with respect to the detection system.

DetF_{Ei,smplFr}=(GF*CapF_{Ei}) [14]

Substituting Equation [13c] for DetF_{Ei,smpl} into Equation [4b] gives the count-balance Equation [15] for any sample.

C_{Ei,smpl}=Mₛₘₚₗ*SpA_{Rj,smpl}*YF_{Rj,Ei}*EscF_{Ei,smpl}*(DetF_{Ei,smplFr})*tₛₘₚₗ [15]

The characteristic-peak count (C_{Ei,smpl}) is equal to the sample mass (Mₛₘₚₗ), multiplied by the specific activity (SpA_{Rj,smpl}), multiplied by the characteristic yield-fraction (YF_{Rj,Ei}) for each radionuclide (Rⱼ), multiplied by EscF_{Ei,smpl}, multiplied by DetF_{Ei,smplFr}, and multiplied by the sample counting time (tₛₘₚₗ).

There are several methods for determining EscF_{Ei,smpl} and DetF_{Ei,smplFr} independent of DetF_{Ei,smpl}; and among these methods are:
beam-thru;
stochastic modeling, e.g. Monte Carlo modeling; and
peak-ratio interpolation between point-sources and standard-samples of various composition.

The beam-thru method for determining EscF_{Ei,smpl} is commonly used because of its relative simplicity to implement compared to the other methods. The other methods are complicated, time-consuming, and usually need additional knowledge about the sample composition that is often not available. These methods also have variation and combinations in their implementation; and can still result in imprecise and unreliable results. Only the beam-thru method is discussed here, for the purpose of elucidating the novelty and usefulness of the current methods, apparatuses, software, and systems disclosed herein. The other prior-art methods are described in the literature and bear no resemblance to the disclosure described herein.

### Beam-Assisted Sample Analysis

One common beam-assisted method for sample analysis can be described in four key parts. Part-1 is acquisition of an ambient background emission spectrum, as described in the discussion of FIG. 2, and how the ambient background emission spectrum is used to remove the ambient background emission component from standard-sample and unknown-sample spectra. Part-2 determines the sample-free characteristic beam spectrum, which serves as the baseline for determining the attenuation of the beam-thru standard-samples and unknown-samples. Part-3 determines the beam-assisted sample-specific escaped-fraction for standard-samples (EscF_{Ei,stnd}) and the sample-free detected-fraction calibration (DetF_{Ei,smplFr}) of the particular detection system in use, which is different from the previously described sample-specific detected-fraction calibration (DetF Ei,stnd) in the discussion of FIG. 3. Part-4 determines the beam-assisted sample-specific escaped-fraction for unknown-samples (EscF_{Ei,unkn}) and radioisotope identities (Rⱼ) and specific-activity quantities in unknown-samples (SpA_{Rj,unkn}), which is different from the previously described unknown-sample analysis in the discussion of FIG. 4. Because Part-1, determination of the ambient background emission spectrum, is essentially the same as that described in the discussion of FIG. 2, it will not be described again. This discussion begins with Part-2, determination of the sample-free characteristic-beam spectrum.

### Part 2. Sample-Free Characteristic-Beam Spectrum (FIG. 9)

FIG. 9 illustrates the basic system setup 900 for determining the sample-free characteristic-beam spectrum, which will be used later to help determine the sample-specific escaped-fraction of homogeneous standard-samples (EscF_{Ei,stnd}) and unknown-samples (EscF_{Ei,unkn}). Just above the empty sample-container apparatus is a radioactive reference source 960 that serves as the source of characteristic beams that pass through the sample-container apparatus. Two useful features of a radioactive reference source are (1) that it should have several characteristic beams that span the energy range of interest, e.g. the beam spectrum 964 illustrated in FIG. 9; and (2) that all of the source beams 962 in the solid angle subtended by the detector 110 in FIG. 1, must pass through the sample-container apparatus and sample on their way to intercept the detector. The detector is part of the signal detection, processing, preservation, and presentation subsystem 120 in FIG. 9. Because radioactive reference sources usually have elevated (i.e. “hot”) radioactivity to provide good counting statistics and to facilitate shorter counting times, backscatter of the hot reference source by the surrounding detector materials may elevate the background noise in the detected spectrum. To minimize this noise, a collimator or backscatter shield may be added (although neither is shown in FIG. 9). Just below the reference source is an empty sample-container apparatus comprised of a cap 902, container wall 904, and an internal empty space 906 devoid of any sample. The size, shape, and position of both the radioactive reference source and the empty sample-container apparatus with respect to the detector should be the same as that planned for those containers holding standard-samples used to calibrate the counting system and for those containers holding unknown-samples to be measured and analyzed by the counting system. Subsystem 120 normalizes and subtracts out an ambient background emission spectrum 230 (in FIG. 2) from the gross sample-free beam spectrum (not shown) to produce a net sample-free beam spectrum 964. The ambient background emission spectrum is acquired by the ambient background emission spectrum acquisition subsystem 200. The illustrated spectrum 964 shows 14 singlet characteristic-beam peaks distributed rather evenly across the energy range. After a period of sample-free beam counting time (t_{bm,smplFr}), each beam peak has a number of counts above the background noise (C_{Ei,bm,smplFr}).

To ensure that the ambient background emission spectrum and the sample-free characteristic-beam spectrum do not significantly change over time, they are acquired periodically, perhaps once every week or month, depending on the judgment and experience of the operator or by established protocol.

### Part 3. Beam-Assisted Detection-Efficiency Calibration (FIG. 10)

Before signal-detection systems are used to quantify radioisotopes in unknown-samples, they usually first require a detection efficiency calibration of some kind. FIG. 10 illustrates one such system 1000 for calibrating signal-detection efficiency, where a compositionally, well known standard-sample 1006 is filled to a depth (x_{stnd}) 1022 in the same type of container cup 1004 and cap 1002, and placed in the same position relative to the detector, as were the empty sample-container apparatuses used to acquire both an ambient background emission spectrum 230 in FIG. 2 and a baseline characteristic-beam spectrum 964 in FIG. 9. Referring back to FIG. 10, the ambient background emission spectrum is acquired by the ambient background emission spectrum acquisition subsystem 200. The baseline characteristic beam spectrum is acquired by the ambient background emission spectrum acquisition subsystem 900. Just above the standard-sample-container apparatus is the same reference source 960 that was used to produce the baseline characteristic-beam spectrum in FIG. 9, and it will be the same reference source that is used in Part-4 to determine unknown-sample characteristic-signal attenuation. Characteristic signals emanate (dashed lines 1068) from the radioactive reference source 960, and a fraction of them pass through the sample-container apparatus and the standard-sample 1006 contained therein. Those signals within the solid angle subtended by the detector act somewhat like a beam through a slab of thickness x_{stnd} 1022 of the standard-sample 1006. Some of the beam is attenuated in the sample-container apparatus materials (cap 1002 and wall 1004) and in the standard-sample 1006, but a fraction passes through the sample un-attenuated (dashed lines 1068). The reference beam characteristic transmitted fraction through the standard-sample (BmTrnsF_{Ei,stnd}) is used to determine the sample-specific escaped-fraction (EscF_{Ei,stnd}) from the standard-sample, from whence the sample-free detected-fraction calibration (DetF_{Ei,smplFr}) is computed.

To avoid contaminating any characteristic sample spectral peaks by characteristic reference source spectral peaks—and if the beam reference source is hot enough—some operators may choose to count the radioactive reference source and the radioactive standard-sample simultaneously for a relatively short time, and then count just the standard-sample by itself without the reference source on top for a relatively long time. But in the present particular description, the radioactive reference source 960 and the radioactive standard-sample are assumed to be counted simultaneously and for an equal length of counting time (t_{bm,smpl}=tₛₘₚₗ).

The signal detection, processing, preservation, and presentation subsystem 120 acquires at least three spectral components into a single composite gross spectrum. Among the spectral components are the ambient radiation background; the attenuated reference-source radiation; and the attenuated standard-sample radiation. (The gross composite spectrum is not shown in FIG. 10.) Subsystem 120 also normalizes a characteristic ambient background emission spectrum 200 to the standard-sample counting time (t_{stnd}), and then subtracts out that normalized characteristic ambient background emission spectrum from the composite gross spectrum to produce a net composite spectrum 1072 still comprised of the attenuated reference-source radiation and the attenuated standard-sample radiation. The resulting total spectral-peak counts (C_{Ei,Tot}) is a composite of the sample-attenuated-beam counts (C_{Ei,AttnBm}); the standard-sample counts (C_{Ei,smpl}), and possibly other counts, e.g. induced-fluorescence counts or system-effects counts that are not addressed here because they are not needed to teach the disclosure.

C_{Ei,Tot}=C_{Ei,AttnBm,stnd}+C_{Ei,stnd}+ . . . [16]

The counting system calibration is composed of a subsystem 1040 that acquires the net characteristic composite spectrum 1072.

A commercial or user-developed spectral-peak-processing subsystem 1078 performs three main computing functions: The first computing function determines which reference spectral beam peaks are useful for computing the characteristic transmittance of the beam through the standard-sample (BmTrnsF_{Ei,stnd}); and which standard-sample-emanated peaks are useful for computing the sample-free detected-fraction calibration (DetF_{Ei,smplFr}). In the net composite spectrum 1072, the sample-attenuated beam peaks (C_{Ei,AttnBm,stnd}; shown as a dashed line) that fall between the standard-sample peaks (C_{Ei,smpl}; shown as a solid line) can be used directly to compute the characteristic beam-transmitted-fraction (BmTrnsF_{Ei,stnd}). In FIG. 10, five useful singlet characteristic beam peaks are identified, (i.e. beam peaks 1, 4, 6, 7, and 13). That means that nine beam peaks out of the original 14 beam peaks form multiplet peaks that would require de-convolution before use, but that discussion isn't necessary for purposes of this disclosure. Below the solid spectral line of the composite spectrum 1072 are shown the numbers of the useful standard-sample singlet peaks, which are numbered 1 through 8. While de-convolution could free-up more standard-sample peaks for further analysis, if desired, such discussion isn't necessary for purposes of this disclosure.

The second computing function uses the useful standard-sample-attenuated beam peaks (C_{Ei,AttnBm,stnd}) numbered 1, 4, 6, 7, and 13 in the composite spectrum 1072, compared to their corresponding sample-free baseline beam peaks (C_{Ei,Bm,smplFr}) also numbered 1, 4, 6, 7, and 13 in the composite spectrum 964 acquired in Part-2 and illustrated in FIG. 9, to compute as a function of energy the sample-specific escaped-fraction for the standard-sample (EscF_{Ei,stnd}) 1082 in FIG. 10. This is a multi-step process.

The first step in the second computing function is to normalize the sample-free beam counting time (t_{bm,smplFr}) to the standard-sample counting time (t_{bm,stnd}). Count-time normalization is often done by turning each counting into a count rate, as in Equations [17a] and [17b].

$$\begin{matrix}{CR}_{Ei , SmplFrBm} = \frac{{C}_{Ei , SmplFrBm}}{{t}_{SmplFrBm}} & [ 17 a ] \\ {CR}_{Ei , AttnBm , stnd} = \frac{{C}_{Ei , AttnBm , stnd}}{{t}_{AttnBm , stnd}} & [ 17 b ]\end{matrix}$$

The second step in the second computing function is to compute the beam-transmitted-fraction through the standard-sample (BmTrnsF_{Ei,stnd}) using the count rates of the characteristic beam pairs.

$${BmTrnsF}_{Ei , stnd} = {e}^{- μ \cdot \overline{d}} = \frac{{CR}_{Ei , AttnBm , stnd}}{{CR}_{Ei , SmplFrBm}} = ( \frac{{C}_{Ei , AttnBm , stnd}}{{C}_{Ei , SmplFrBm}} ) ( \frac{{t}_{SmplFrBm}}{{t}_{AttnBm , stnd}} ) \qquad [ 18 a ]$$

where CR_{Ei,SmplFrBm} is the characteristic count rate of the beam photons after passing through an empty sample-container apparatus; CR_{Ei,AttnBm,stnd} is the characteristic count rate of the beam photons after passing through the sample-container apparatus and standard-sample; and although it is not needed for the computation, e is the base of all natural logarithms, μ is the characteristic sample-specific, linear attenuation coefficient (or “μ_{Ei,stnd}”); and d̅_{stnd} is the mean depth (or thickness) of the standard-sample in the direction of the detector, which, in many cases, is similar enough to the sample-depth normal to the detector's surface (d_{stnd}) 1022 and [18a] becomes:

$${BmTrnsF}_{Ei , stnd} = {e}^{- μ \cdot d} = \frac{{CR}_{Ei , AttnBm , stnd}}{{CR}_{Ei , SmplFrBm}} = ( \frac{{C}_{Ei , AttnBm , stnd}}{{C}_{Ei , SmplFrBm}} ) ( \frac{{t}_{SmplFrBm}}{{t}_{AttnBm , stnd}} ) \qquad [ 18 b ]$$

The thicker the sample, the greater the attenuation, and the smaller the beam-transmitted-fraction (BmTrnsF_{Ei,stnd}) becomes. The standard-sample-depth (d_{stnd}) can be measured, but it is only needed to ensure that, when unknown-samples are analyzed later in Part-4, their depth is also approximately the same, which ensures that the geometry-fraction (GF) and the sample-free detected-fraction (DetF_{Ei,smplFr}) remain constant across the samples.

Assumption: d_{stnd}≅dᵤₙₖₙ [19]

The sample-specific, characteristic linear attenuation coefficient (μ_{Ei,stnd}) is computed by taking the natural logarithm of both sides of the equality in Equation [18b].

$$\begin{matrix}ln ( {BmTrnsF}_{Ei , MtrxSp} ) = - {μ}_{Ei , stnd} * {d}_{stnd} & [ 20 a ] \\ {μ}_{Ei , stnd} = \frac{- ln ( {BmTrnsF}_{Ei , stnd} )}{{d}_{stnd}} & [ 20 b ]\end{matrix}$$

The third step in the second computing function is to compute the sample-specific escaped-fraction (EscF_{Ei,stnd}) 1082 for the homogenous standard-sample 1006. Given a radioactive homogeneous standard-sample of depth d_{stnd}, a characteristic photon production rate (ProdR_{Ei,stnd}), and an un-attenuated characteristic photon sample-exit rate (ExitR_{Ei,stnd}), the sample-specific escaped-fraction (EscF_{Ei,stnd}) can be computed from Equation [21a].

$${EscF}_{Ei , stnd} = \frac{{ExitR}_{Ei , stnd}}{{ProdR}_{Ei , stnd}} = \frac{1}{d} {\int }_{0}^{d} ( {e}^{- μ \cdot d} ) d x = \frac{1}{μ \cdot d} ( 1 - {e}^{- μ \cdot d} ) \qquad [ 21 a ]$$

Equation [21a] can be rewritten in terms of the beam-transmitted-fraction (BmTrnsF_{Ei,stnd}) by substituting BmTrnsF_{Ei,stnd} from Equation [18b] for e^{-μ·d} inside the parentheses of Equation [21a], and by substituting −ln(BmTrnsF_{Ei,Stnd}) from Equation [20a] for (−μ_{Ei,stnd}·d_{stnd}) into the denominator of Equation [21a], resulting in:

$${EscF}_{Ei , stnd} = \frac{{BmTrnsF}_{Ei , stnd} - 1}{ln ( {BmTrnsF}_{Ei , stnd} )} \qquad [ 21 b ]$$

Referring back to FIG. 10, five discrete computed sample-specific escaped-fraction solutions 1084 correspond to five sample-free (in 964 in FIG. 9) and attenuated singlet beam-peak (in 1072) pairs. Because the sample-specific escaped-fractions need to be known for the standard-sample characteristic peaks—which occur at different characteristic energy than those beam-peak singlets—the five computed sample-specific escaped-fraction points are usually fitted to a smooth function 1086.

The fourth step of the second computing function is to compute a smooth function (a “curve”) fitted to the beam-derived, sample-specific escaped-fraction points. The farther apart the adjacent sample-specific escaped-fraction (EscF_{Ei,stnd}) solutions are, the worse the statistics become. Thus, it is desired that the reference source spectrum produce as many singlet or easily de-convoluted spectral peaks as possible, and that adjacent peaks spread relatively evenly and frequently across the entire energy range of the spectrum, so that the interpolation between adjacent peaks is modest and allows for developing a useful energy-dependent, sample-specific escaped-fraction, fitted function, EscF(Eᵢ)_{stnd}.

$$\frac{{BmTrnsF}_{Ei , stnd} - 1}{ln ( {BmTrnsF}_{Ei , stnd} )} \to {EscF ( {E}_{i} )}_{stnd} \qquad [ 21 c ]$$

As FIG. 10 illustrates, one of the drawbacks of the reference-source beam-thru method for determining the sample-specific escaped-fraction (EscF_{Ei,smpl}) is that the beam lines and the volume standard-sample lines often interfere with each other, and possibly with other spectral peaks, e.g. induced-fluorescence peaks and system-effect peaks, making it difficult to find enough ‘clean’ beam lines to determine an accurate sample-specific escaped-fraction (EscF_{Ei,smpl}). The composite spectrum 1072 of FIG. 10 shows that only five of the 14 original beam lines remain pure, i.e. beam line numbers 1, 4, 6, 7, and 13; and yet the fitted sample-specific escaped-fraction curve 1086 appears relatively smooth.

The third computing function of the commercial or user-developed, spectral-peak-processing subsystem 1078 is to use the standard-sample characteristic spectral peaks in combination with the fitted sample-specific escaped-fraction [EscF(Eᵢ)_{stnd}] 1086, in order to determine the detection system sample-free detected-fraction calibration (DetF_{Ei,smplFr}) 1088. First, the count-balance Equation [15] is rewritten using subscripts appropriate for the standard-sample (“stnd”):

C_{Ei,stnd}=M_{stnd}*SpA_{Rj,stnd}*YF_{Rj,Ei}*EscF_{Ei,stnd}*DetF_{Ei,smplFr})*t_{stnd} [22]

The terms of Equation [22] are rearranged to solve for the sample-free detected-fraction calibration (DetF_{Ei,smplFr}):

$${DetF}_{Ei , smplFr} = \frac{{C}_{Ei , stnd}}{{M}_{stnd} * {SpA}_{Rj , stnd} * {YF}_{Rj , Ei} * {EscF}_{Ei , stnd} * {t}_{stnd}} \qquad [ 23 ]$$

The number of ‘clean’ characteristic peak counts (C_{Ei,stnd}) is known because the detection system recorded them, and the spectrum analysis revealed them to be singlets or Subsystem 120 was able to de-convolute them. De-convolution, although undesirable because of the uncertainty it adds to the result, may be needed because, out of the approximately 19 volume-standard-radioisotope peaks (shown as the dark thick trace in the composite spectrum 1072), only eight peaks, by visual inspection, appear to be singlets (i.e. individual isolated peaks). Further, the trace of the sample-free detected-fraction calibration points initially rises to a maximum and then falls and turns asymptotic to the horizontal axis at very high energy. Finding a function to fit such rising and falling points is sometimes more challenging than to fit the points that rise smoothly like the sample-specific escaped-fraction curve 1068. Consequently, it is desired to have as many solution points as possible for the sample-free detected-fraction calibration in order to maximize the useful statistics on the fitted curve between individual solution points.

The standard-sample mass (M_{stnd}), radionuclide identity (Rⱼ), specific activities (SpA_{Rj,stnd}), and energy-specific (Eᵢ) radionuclide yield-fractions (YF_{Rj,Ei}) are known because standard-samples are specifically prepared for system efficiency calibration from known radioactive sources and quantities, as well as from published decay-yield data. The standard-sample counting time (t_{stnd}) is known because the detection-system application software and electronics keep track of it. The standard-sample sample-specific escaped-fraction (EscF_{Ei,stnd}) and its smooth fitted function [EscF(Eᵢ)_{Stnd}] are computed by the steps described in the discussion surrounding Equations [16] through [21c]. The fitted function [EscF(Eᵢ)_{Stnd}] often replaces the individual points (EscF_{Ei,stnd}) from Equation [23], resulting in Equation [24a]:

$${DetF}_{Ei , smplFr} = \frac{{C}_{Ei , stnd}}{{M}_{stnd} * {SpA}_{Rj , stnd} * {YF}_{Rj , Ei} * {EscF ( {E}_{i} )}_{Stnd} * {t}_{stnd}} \qquad [ 24 a ]$$

A sample-free detected-fraction calibration (DetF_{Ei,smplFr}) is computed for each characteristic spectral peak of interest (C_{Ei,stnd}), and all of these calibration points 1090 together resemble the outline of a curve. Commonly, these calibration points are fitted to one or more smooth functions that, when combined together, is called the ‘calibration curve’ [DetF(Eᵢ)_{smplFr}] 1092, and covers the entire usable energy-detection range of the detection system:

$$\frac{{C}_{Ei , stnd}}{{M}_{stnd} * {SpA}_{Rj , stnd} * {YF}_{Rj , Ei} * {EscF ( {E}_{i} )}_{Stnd} * {t}_{stnd}} \to {DetF ( {E}_{i} )}_{smplFr} \qquad [ 24 b ]$$

An operator may choose to use either the detected-fraction calibration points (DetF_{Ei,smplFr}) 1090 or calibration curve [DetF(Eᵢ)_{smplFr}] 1092, or both, and it is convenient to consider the calibration points and curve jointly as the sample-specific detected-fraction calibration 1088.

In summary, a point-like source beams through a standard-sample, the purpose of which is to determine the characteristic sample-specific escaped-fraction (EscF_{Ei,stnd}). Then, the peaks (C_{Ei,stnd}) from the standard-sample are used to determine the characteristic sample-free detected-fraction calibration (DetF_{Ei,smplFr}) for the standard-sample shape and position relative to the particular detection system. Whereas the beam peaks are used to determine the standard-sample sample-specific escaped-fraction (EscF_{Ei,stnd}), the standard-sample radioisotopes are used to determine the detection-system sample-specific detected-fraction (DetF_{Ei,smplFr}) 1090, which itself is usually fitted to obtain a function [DetF(Eᵢ)_{smplFr}] 1092, and both are referred to collectively as the sample-specific detected-fraction calibration values 1088. By completing the calibration of signal detection efficiency, the counting system is ready to count unknown-samples.

### Part 4. Beam-Assisted Specific-Activity Determination (FIG. 11)

Once the ambient background emission spectrum has been acquired (FIG. 2); the sample-free beam spectrum has been acquired (FIG. 9); and the sample-free detected-fraction calibration has been performed (FIG. 10), the counting system is ready to analyze homogenous unknown-samples (“unkn”). FIG. 11 illustrates a system 1100 for analyzing unknown-samples, i.e. for determining characteristic sample-specific escaped-fraction (EscF_{Ei,unkn}), photon-emitting radioisotope identities (Rⱼ) and specific-activity quantities (SpA_{Rj,unkn}). FIG. 11 illustrates a reference source located above a homogeneous unknown-sample 1106 that is filled to depth xᵤₙₖₙ 1122 in the same type of container cup 1104 and cap 1102, and placed in the same position relative to the detector, as were the empty sample-container apparatuses that were used to acquire both an ambient background emission spectrum 200 in FIG. 2 and a baseline characteristic beam spectrum 900 in FIG. 9. This is also the same type of container cup that held the standard-sample that was used to compute the counting system sample-free detected-fraction calibration in FIG. 10. Referring back to FIG. 11, just above the unknown-sample-container apparatus, there is the same radioactive reference source 960 that produced the baseline characteristic beam spectrum in FIG. 9, and from which was computed the sample-specific escaped-fraction of the standard-sample (EscF_{Ei,stnd}) and the sample-free detected-fraction calibration (DetF_{Ei,smplFr}) in FIG. 10. Referring back to FIG. 11, characteristic signals emanate (dashed lines, 1168) from the radioactive reference source 960 of which a fraction of them pass through the sample-container apparatus and the unknown-sample 1106 contained therein. Those signals within the solid angle subtended by the detector act somewhat like a beam through a “slab” of thickness xᵤₙₖₙ 1122 of sample 1106. Some of the beam is attenuated in the sample-container apparatus materials (cap 1102 and wall 1104) and in the unknown-sample 1106, but a fraction passes through the unknown-sample un-attenuated (dashed lines 1168). The reference source characteristic beam-transmitted-fraction through the unknown-sample (BmTrnsF_{Ei,unkn}) is used to determine the sample-specific escaped-fraction (EscF_{Ei,unkn}) from the unknown-sample.

If the beam reference source 960 is “hot” enough, then some operators may choose to count the radioactive reference source and the radioactive unknown-sample simultaneously for a relatively short time, after which they will count just the unknown-sample by itself for a relatively long time, in order to avoid contaminating any characteristic sample spectral peaks by characteristic reference-source spectral peaks. But in this particular description, the radioactive reference source 960 and the radioactive unknown-sample 1106 are assumed to be counted simultaneously and for the same amount of counting time (t_{bm,unkn}=tᵤₙₖₙ).

The signal detection, processing, preservation, and presentation subsystem 120 acquires at least three spectral components into a single composite gross spectrum. Among the spectral components are the ambient background emission spectrum; the sample-attenuated reference-source emission spectrum that acts like a beam through the unknown-sample; and the self-attenuated unknown-sample emission spectrum. (The gross composite spectrum is not shown in FIG. 11.) Subsystem 120 also normalizes a characteristic ambient background emission spectrum 200 to the unknown-sample counting time (tᵤₙₖₙ), and then subtracts out that normalized characteristic ambient background emission spectrum from the composite gross spectrum to produce a net composite spectrum 1172 that is still comprised of at least two spectral components; i.e. the attenuated reference-source-emission spectrum (dotted-line 1172), and the self-attenuated, unknown-sample-emission spectrum (solid-line 1172). The resulting total spectral-peak counts (C_{Ei,Tot}) is a composite of the unknown-sample attenuated-beam counts (C_{Ei,AttnBm}), the unknown-sample counts (C_{Ei,unkn}), and possibly other counts, e.g. induced-fluorescence counts or system-effects counts that are not addressed here because they are not needed to teach the disclosure.

C_{Ei,Tot}=C_{Ei,AttnBm,unkn}+C_{Ei,unkn}+ . . . [25]

The counting system 1100 is composed of a subsystem 1140 that is used to acquire the net composite characteristic emission spectrum 1172.

A commercial or user-developed spectral-peak-processing subsystem 1178 performs three main computing functions. The first computing function is to determine which spectral beam peaks are useful for computing the characteristic transmittance of the beam through the unknown-sample (BmTrnsF_{Ei,unkn}), and which characteristic peaks from the unknown-sample are useful for identifying and quantitating the signal emitters inside (SpA_{Rj,unkn}). In the net composite spectrum 1172, the sample attenuated beam peaks (C_{Ei,AttnBm,unkn}) that fall between the unknown-sample peaks (C_{Ei,unkn}) can be used directly to compute the characteristic beam-transmitted-fraction (BmTrnsF_{Ei,unkn}). In FIG. 11, six useful singlet characteristic beam peaks 1184 are identified, i.e. beam peaks 4, 5, 7, 8, 9 and 13. That means that eight beam peaks out of the original 14 beam peaks (964 in FIG. 9) form multiplet peaks that would require de-convolution before use, but that discussion isn't necessary for purposes of this disclosure. Below the solid spectral line of the composite spectrum 1172 are shown the nine identifying numbers of the useful unknown-sample singlet peaks. De-convolution could free up more unknown-sample peaks, but that discussion isn't necessary, for the purposes of this disclosure.

The second computing function is to use the useful unknown-sample-attenuated beam peaks (C_{Ei,AttnBm,unkn}) numbered 4, 5, 7, 8, 9 and 13 in the composite spectrum 1172, compared to their corresponding sample-free baseline beam peaks (C_{Ei,Bm,smplFr}) also numbered 4, 5, 7, 8, 9 and 13 in the composite spectrum 964 acquired in Part-2 and illustrated in FIG. 9, to compute as a function of energy the sample-specific escaped-fraction for the unknown-sample composition (EscF_{Ei,unkn}) 1182 in FIG. 11. This is a multi-step process.

The first step is to normalize the sample-free baseline beam-peak counting time (t_{bm,smplFr}) to the unknown-sample counting time (t_{bm,unkn}). Count-time normalization is often accomplished by turning each counting into a count rate, as in Equations [17a] and [17b].

$$\begin{matrix}{CR}_{Ei , SmplFrBm} = \frac{{C}_{Ei , SmplFrBm}}{{t}_{SmplFrBm}} & [ 26 a ] \\ {CR}_{Ei , AttnBm , unkn} = \frac{{C}_{Ei , AttnBm , unkn}}{{t}_{AttnBm , unkn}} & [ 26 b ]\end{matrix}$$

The second step is to compute the beam-transmitted-fraction through the unknown-sample (BmTrnsF_{Ei,unkn}) using the count rates of the characteristic beam pairs.

$${BmTrnsF}_{Ei , unkn} = {e}^{- μ \cdot d} = \frac{{CR}_{Ei , AttnBm , unkn}}{{CR}_{Ei , SmplFrBm}} = ( \frac{{C}_{Ei , AttnBm , unkn}}{{C}_{Ei , SmplFrBm}} ) ( \frac{{t}_{SmplFrBm}}{{t}_{AttnBm , unkn}} ) \qquad [ 27 ]$$

where CR_{Ei,SmplFrBm} is the characteristic count rate of the beam photons after passing through an empty sample-container apparatus; CR_{Ei,AttnBm,unkn} is the characteristic count rate of the beam photons after passing through the sample-container apparatus and the unknown-sample; and although it is not needed for the computation, e is the base of all natural logarithms, μ is the characteristic sample-specific linear-attenuation coefficient (or “μ_{Ei,unkn}”), and dᵤₙₖₙ 1122 is the thickness of the unknown-sample in the direction of the detector. The thicker the unknown-sample 1106, the greater is the beam attenuation and the smaller is the beam-transmitted-fraction (BmTrnsF_{Ei,unkn}). The unknown-sample thickness (dᵤₙₖₙ) can be measured, but it is only needed to ensure that it is approximately the same depth as the standard-sample that was used to perform the sample-free detected-fraction calibration in Part-3 and also to ensure that the geometry-fraction (GF) and the sample-free detected-fraction (DetF_{Ei,smplFr}) remain constant across the samples.

Assumption: d_{stnd}≅dᵤₙₖₙ [28]

The sample-specific characteristic linear-attenuation coefficient (μ_{Ei,unkn}) is computed by taking the natural logarithm of both sides of the equality in Equation [27].

ln(BmTrnsF_{Ei,unkn})=μ_{Ei,unkn}*dᵤₙₖₙ [28a]

$${μ}_{Ei , unkn} = \frac{- ln ( {BmTrnsF}_{Ei , unkn} )}{{d}_{unkn}} \qquad [ 28 b ]$$

The third step is to compute discrete values for the sample-specific escaped-fraction (EscF_{Ei,unkn}) 1184 for the homogenous unknown-sample 1006. Given a radioactive homogeneous unknown-sample of depth dᵤₙₖₙ, a characteristic photon production rate (ProdR_{Ei,unkn}), an un-attenuated characteristic photon sample-exit rate (ExitR_{Ei,unkn}), and integrating Equation [27], the sample-specific escaped-fraction (EscF_{Ei,unkn}) can be computed as shown in Equation [29a].

$${EscF}_{Ei , unkn} = \frac{{ExitR}_{Ei , unkn}}{{ProdR}_{Ei , unkn}} = \frac{1}{d} {\int }_{0}^{d} ( {e}^{- μ \cdot x} ) d x = \frac{1}{μ \cdot d} ( 1 - {e}^{- μ \cdot d} ) \qquad [ 29 a ]$$

Equation [29a] can be rewritten in terms of the beam-transmitted-fraction (BmTrnsF_{Ei,unkn}) by substituting BmTrnsF_{Ei,unkn} from Equation [27] for e inside the parentheses of Equation [29a], and by substituting −ln(BmTrnsF_{Ei,unkn}) from Equation [28a] for (−μ_{Ei,unkn}*dᵤₙₖₙ) into the denominator of Equation [29a], results in:

$${EscF}_{Ei , unkn} = \frac{{BmTrnsF}_{Ei , unkn} - 1}{ln ( {BmTrnsF}_{Ei , unkn} )} \qquad [ 29 b ]$$

The fourth step is to compute a smooth function (i.e. a “curve”) fitted to the beam-calculated sample-specific escaped-fraction points. The further apart the adjacent sample-specific escaped-fraction (EscF_{Ei,unkn}) solutions, the worse the statistics become. Thus, it is desired that the reference source beam spectrum produce as many singlet or easily de-convoluted spectral peaks as possible and that adjacent peaks spread relatively evenly and frequently across the entire energy range of the spectrum so that the interpolation between adjacent peaks is modest and allows for developing a useful, energy-dependent, sample-specific escaped-fraction fitted function [EscF(Eᵢ)ᵤₙₖₙ].

$$\frac{{BmTrnsF}_{Ei , unkn} - 1}{ln ( {BmTrnsF}_{Ei , unkn} )} \to {EscF ( {E}_{i} )}_{unkn} \qquad [ 29 c ]$$

But as FIG. 11 illustrates, one of the drawbacks of the reference-source beam-thru method for determining the discrete sample-specific escaped-fraction (EscF_{Ei,unkn}) is that the beam lines and the unknown-sample lines often “overlap” and interfere with other spectral peaks, e.g. induced-fluorescence peaks and system-effect peaks, making it difficult to find enough ‘clean’ beam lines to determine an accurate sample-specific escaped-fraction (EscF_{Ei,unkn}). The composite spectrum 1172 shows that only six of the 14 original beam lines are singlets, and yet the fitting still appears relatively smooth 1186 (dotted line in FIG. 11). Collectively, the discrete and fitted function values of the sample specific escaped fraction values together are shown in 1182.

The third computing function of the commercial or user-developed, spectral-peak-processing subsystem 1178 is to use the unknown-sample characteristic spectral peaks in combination with the fitted sample-specific escaped-fraction [EscF(Eᵢ)ᵤₙₖₙ] 1186 (dotted line in FIG. 11) and with the detection-system fitted sample-free detected-fraction calibration function [DetF(Eᵢ)_{smplFr}] 1000, to identify and quantify the radioisotopes in the unknown-sample. First, the count-balance Equation [15] is rewritten using the subscripts appropriate for the unknown-sample (“unkn”).

C_{Ei,unkn}=Mᵤₙₖₙ*SpA_{Rj,unkn}*YF_{Rj,Ei}*EscF(Eᵢ)ᵤₙₖₙ*DetF(Eᵢ)_{smplFr}*tᵤₙₖₙ [30]

The terms of Equation [30] are re-arranged to solve for the specific-activity quantities (SpA_{Rj,unkn}) 1192 in FIG. 11.

$${SpA}_{Rj , unkn} = \frac{{C}_{Ei , unkn}}{{M}_{unkn} * {DetF ( {E}_{i} )}_{smplFr} * {YF}_{Rj , Ei} * {EscF ( {E}_{i} )}_{unkn} * {t}_{unkn}} \qquad [ 31 ]$$

The number of ‘clean’ characteristic unknown-sample peak counts (C_{Ei,unkn}) is known because the detection system recorded them, and the spectrum analysis revealed them to be singlets or Subsystem 120 was able to de-convolute them. De-convolution, although undesirable because of the uncertainty it adds to the result, may be needed because, out of the approximately 20 unknown-sample radioisotope peaks (dark solid trace in the composite spectrum 1172), only nine peaks, by visual inspection, appear to be “singlets” (i.e. individual isolated peaks), which may not be enough peaks to identify all of the identifiable radioisotopes in the unknown-sample, necessitating de-convolution of “multiplets” (i.e. two or more overlapping peaks). The sample-free detected-fraction calibration function [DetF(Eᵢ)_{smplFr}] was computed during the beam-assisted sample-free detected-fraction calibration 1000 of FIG. 10. The mass of the unknown-sample (Mᵤₙₖₙ) is known because it was measured, possibly by the procedure described in the discussion of Equation [1]. The energy-specific (Eᵢ) radionuclide identity (Rⱼ) and yield-fractions (YF_{Rj,Ei}) are known because the unknown-sample characteristic spectral peaks are identified by spectrum-analysis software and mapped to published decay-yield data. The unknown-sample counting time (tᵤₙₖₙ) is known because the detection-system application software and electronics kept track of it and recorded it. The unknown-sample fitted sample-specific escaped-fraction function [EscF(Eᵢ)ᵤₙₖₙ] was computed by the steps described in the discussion surrounding Equations [25] through [29c].

### System (FIG. 12)

For the purpose of describing a common system 1200 of methods, apparatuses, and software used to identify and quantify radioisotopes in homogenous samples, FIG. 12 illustrates a convenient breakdown of the system 1200 into the various logical subsystems for summary. Prior to being able to report the identity and quantity of signal emitters in unknown-samples, first the system detection-efficiency must be calibrated 1000. Five subsystems are described that accomplish this task 1040, 900, 1078, 1082, and 1088. The net-composite-spectrum subsystem 1040 uses a signal-emitting reference source to beam through a compositionally known, signal-emitting standard-sample, and, after subtracting out the ambient background emission spectrum, thereby computes the net composite spectrum. The sample-free net-beam-spectrum subsystem 900 uses a signal-emitting reference source to produce a gross reference-source spectrum, and, after subtracting out the ambient background emission spectrum, thereby computes a sample-free net beam spectrum. The peak-processing subsystem 1078 identifies the usable attenuated-beam peaks from the net composite beam spectrum 1040 and compares them to their corresponding characteristic sample-free net composite beam peaks 900 to determine the sample-free escaped-fraction of the standard-sample. The peak-processing subsystem 1078 also identifies the usable standard-sample characteristic peaks to determine the counting-system sample-free detected-fraction calibration over the energy range of interest, and these values will be used by the sample-analysis system 1100 to identify and quantify signal emitters in homogenous unknown-samples. The sample-free escaped-fraction subsystem 1082 presents the results of the sample-free escaped-fraction computations. The sample-free detected-fraction subsystem 1082 presents the results of the sample-free detected-fraction calibration computations.

Once the counting system 1000 is calibrated, it can be used to perform sample analysis 1100. The unknown-sample-analysis system 1100 is comprised of five subsystems 1140, 900, 1178, 1182, and 1192. The net-composite-spectrum subsystem 1140 uses a signal-emitting reference source to beam through a signal-emitting unknown-sample, and after subtracting out the ambient background emission spectrum, thereby computes a net composite spectrum. The sample-free net-beam-spectrum subsystem 900 uses a signal-emitting reference source to acquire a sample-free gross reference-source spectrum, and after subtracting out the ambient background emission spectrum, thereby computes a sample-free net beam spectrum. The peak-processing subsystem 1178 identifies the usable attenuated-beam peaks from the net-composite-beam spectrum 1140 and compares them to their corresponding characteristic sample-free net composite beam peaks 900 to compute the sample-free escaped-fraction of the standard-sample. The peak-processing subsystem 1178 also identifies the usable unknown-sample characteristic peaks to identify and quantify the detectable signal emitters. The sample-free escaped-fraction subsystem 1182 presents the results of the sample-free escaped-fraction computations. The signal-emitter identification and quantification subsystem 1182 presents the results of the identified and quantified signal emitters discovered in the unknown-sample.

### Methodology (FIG. 13)

FIG. 13 illustrates the methodological steps 1300 used by many operators to identify and quantify signal emitters within homogenous unknown-samples.

The primary activity and result of Part-1, Step-1, 1310, is to acquire an ambient background emission spectrum.

Part-2 methodology 1320, is comprised of Steps-2 and -3. The primary activity and result of Step-2, 1322, is to count a signal-emitting reference source to obtain a sample-free gross beam spectrum. The primary activity and result of Step-3, 1324, is to normalize and subtract out the signal-emitting ambient background emission spectrum to obtain the sample-free net beam spectrum.

Part-3 methodology 1330 computes the sample-free detection-system calibration and is comprised of Steps-4 to -12, which are usually performed in sequence. The primary activity and result of Step-4, 1332, is to count a signal-emitting reference source that beams through a homogenous standard-sample, to obtain a gross composite spectrum that also contains an ambient background emission spectral component. The primary activity and result of Step-5, 1334, is to take the ambient background emission spectrum that was obtained in Step-1, 1310, and to normalize it to the counting time of the standard-sample gross spectrum obtained in Step-4, 1332, and then to subtract out the normalized ambient background emission spectrum from the gross composite spectrum, resulting in the net composite spectrum. The primary activity and result of Step-6, 1336, is to identify the characteristic reference-beam spectral peaks that are useful to compute sample-specific beam-transmitted-fraction points for the composition of the standard-sample characteristic emission spectrum. The primary activity and result of Step-7, 1338, is to compute, for each characteristic reference-beam spectral peak, the sample-specific beam-transmitted-fraction point for the composition of the standard-sample characteristic emission spectrum. The primary activity and result of Step-8, 1340, is to compute, for each characteristic beam-transmitted-fraction point, the corresponding sample-specific escaped-fraction point for the composition of the standard-sample characteristic emission spectrum. The primary activity and result of Step-9, 1342, is to compute, from the sample-specific escaped-fraction points, a smooth, sample-specific escaped-fraction curve or function, or patchwork of curves or functions, to cover the energy range of interest. The primary activity and result of Step-10, 1344, is to determine the standard-sample spectral peaks that are useful for determining the detection system sample-free detected-fraction calibration points. The primary activity and result of Step-11, 1346, is to compute, for each spectral peak in the standard-sample characteristic emission spectrum, a sample-specific detected-fraction calibration point. The primary activity and result of Step-12, 1348, is to compute, from the sample-specific detected-fraction calibration points, a smooth, sample-specific detected-fraction curve or function, or patchwork of curves or functions, to cover the energy range of interest.

The Part-4 methodology for unknown-sample analysis is comprised of a system 1360 of steps 13-20 that are usually performed in sequence. The primary activity and result of Step-13, 1362, is to count a signal-emitting reference source that beams through a homogenous unknown-sample, to obtain a gross composite spectrum that also contains an ambient background emission spectral component. The primary activity and result of Step-14, 1364, is to take the ambient background emission spectrum that was obtained in Step-1, 1310, and to normalize it to the counting time of the unknown-sample gross spectrum obtained in Step-11, 1362, and then to subtract out the normalized ambient background emission spectrum from the gross composite spectrum, resulting in the net composite spectrum. The primary activity and result of Step-15, 1366, is to determine the characteristic reference-beam spectral peaks that are useful for determining sample-specific beam-transmitted-fraction points for the composition of the unknown-sample characteristic-emission spectrum. The primary activity and result of Step-16, 1368, is to compute, for each characteristic reference-beam spectral peak, the sample-specific beam-transmitted-fraction point for the composition of the unknown-sample characteristic emission spectrum. The primary activity and result of Step-17, 1370, is to compute, for each characteristic beam-transmitted-fraction point, the corresponding sample-specific escaped-fraction point for the composition of the unknown-sample characteristic emission spectrum. The primary activity and result of Step-18, 1372, is to compute, from the sample-specific escaped-fraction points, a smooth, sample-specific escaped-fraction curve or function, or patchwork of curves or functions, to cover the energy range of interest. The primary activity and result of Step-19, 1374, is to identify the signal emitters responsible for the measured spectral peaks from the unknown-sample. The primary activity and result of Step-20, 1376, is to quantify the signal emitters within the unknown-sample, by using the inverse of the sample-specific detected-fraction calibration points 1346 or curve 1348 to correct up the characteristic peaks from the emission spectrum of the unknown-sample. The operator or established protocol usually decides whether it is to be the calibration points 1346 or the calibration curve 1348 used in the peak-correction computations for a given unknown-sample and emission spectrum.

### Beam-Thru Drawbacks

The conventional methods for quantitating signal emitters in homogenous samples are based on emitted characteristic signals but only work for cases where the unknown-sample composition is substantially the same as that of the standard-sample that was used to determine the sample-specific detected fraction calibration (DetF_{Ei,stnd}) for each detection system, sample shape and position. In many cases, however, unknown-samples have unknown composition. Conventional methods for computing sample self-attenuation are problematic; yet they must be performed in order to quantify signal emitters in many samples, especially unknown-samples whose composition differs from the standard-sample. To overcome sample compositional variations, one conventional method uses a reference source to beam through the sample thickness to compute sample transmittance, which allows computation of the sample-specific escaped-fraction (EscF_{Ei,smpl}). One drawback is the “overlapping” of the characteristic peak counts of the attenuated beam (C_{Ei,AttnBm}), the peak counts of beam-induced fluorescence (C_{Ei,BmIndFlrs}), and the peak counts of signals emitted from the sample itself (C_{Ei,smpl}). The beam source should have dense enough characteristic singlet peaks to minimize the uncertainty of the inter-peak interpolations, while not having so many peaks that they interfere with the characteristic peaks emitted from the sample itself. The sample peaks are needed to compute sample-free detected-fraction calibration (DetF_{Ei,smplFr}) in the case of standard-samples, or to compute specific activity quantitation (SpA_{Rj,unkn}) for unknown-samples.

A second drawback is that the point-like source of the beam is usually relatively “hot” in order to shorten counting times or to allow for increases in sample thickness but at the price of inducing fluorescence of the sample elements, which can further confuse the resulting combined spectrum and degrade the peak counts of signals emitted from the sample itself (C_{Ei,smpl}).

A third drawback is that the characteristic peak counts of the attenuated beam (C_{Ei,AttnBm}) and the peak counts of beam-induced fluorescence (C_{Ei,BmIndFlrs}) elevate the spectral noise, which also degrades the statistics of the peak counts of signals emitted from the sample itself (C_{Ei,smpl}), especially if the beam energy is just above the sample peak energy, which then ‘feels’ the “Compton continuum” of the beam peak and ‘tail’ of poor charge collection in some radiation detection systems.

A fourth drawback, among others, is that the characteristic beam-source peaks can cause peak-summing and peak-subtraction problems that further degrade the counting statistics and may also interfere with other peaks. At lower energies, the beam must have higher intensity in order to ‘pierce’ the sample and produce good enough statistics.

Using a point-like beam source allows for determining the sample-specific escaped-fraction (EscF_{Ei,stnd}) for homogeneous standard-samples (stnd) as long as the sample thickness (d_{stnd}) allows enough of the characteristic beam to pass through. Known methods for estimating, calculating, or measuring the sample-specific escaped-fraction (EscF_{Ei,smpl}) for every sample are either too complex, too uncertain, labor intensive, or involve beam-thru sources and associated drawbacks.

What is needed is a simpler way to directly measure the sample-specific escaped-fraction (EscF_{Ei,smpl}) for every characteristic peak (Eᵢ) in every sample, including standard-samples.

### SUMMARY

The present disclosure provides an apparatus for detecting radiation signals emitted from an unknown homogeneous sample. This apparatus comprises a sample-container apparatus that includes a plurality of sample-container apparatus configurations; each sample-container apparatus configuration enables measurement of the homogeneous sample via at least two different thicknesses; a detector system detects the radiation signals from different sample thicknesses; and a computer processes the detected signals and analyzes the sample composition by comparing radiation signals at different sample thicknesses by means of a sample analysis software program.

One of the sample-container apparatus configurations comprises a plurality of sample cups, each sample cup having a different size and shape from other sample cups, so the homogeneous sample assumes a different thickness when placed into each respective sample cup. The sample cups share at least one opening to allow the homogeneous sample to be transferred from one sample cup to the other.

One exemplary sample-container apparatus is comprised of two oppositely placed sample cups connected together at one or more of their shared openings in order to allow the homogeneous sample to be transferred from one sample cup to the other when the sample-container apparatus is flipped 180 degrees. The two oppositely placed sample cups have the ratio of their diameters equal to √2:1 so that the sample thickness ratio becomes 1:2 when the homogeneous sample is transferred from one sample cup to the other sample cup.

Another exemplary sample-container apparatus forms different sample thicknesses when the sample-container apparatus moves relative to the detector system. One example is a sample-container apparatus with a rectangular cross-section, where the short side and the long side of the rectangular sample cup form a ratio of n:m wherein n and m are integers such that n<m.

The present disclosure provides a method for characterizing radiation signals emitted from an unknown homogeneous sample. The method comprises providing a radiation signal detecting system comprising a plurality of detectors, a computer for analyzing the sample composition, and a sample-container apparatus, wherein the sample-container apparatus includes a plurality of sample cups, each sample cup has a different size from other sample cups, such that the homogeneous sample forms different thickness when placed in different sample cups; performing background signal detection for each empty sample cup and determining a background signal count rate for each empty sample cup; performing calibration signal detection by measuring a standard-sample sequentially in each sample cup and determining a standard signal count rate for each sample cup; subtracting the background signal count rate from standard-sample signals for each sample cup; performing the signal detection for the unknown homogeneous sample in each sample cup; subtracting the background signal count rate from the unknown homogeneous sample signals for each sample cup; measuring the characteristic signal count rates for the unknown-sample in each sample cup; verifying the characteristic signal count rates to be qualified data; and calculating the composition of the unknown homogeneous sample by comparing the characteristic signal count rates of the unknown-sample from different sample cups using a software model.

Another exemplary method consistent with the current disclosure comprises using a different sample cup; the sample cup provides different sample thicknesses when the sample cup moves to a different position relative to the detector system.

Signal detection for all sample cup positions is performed sequentially in one embodiment and simultaneously in another embodiment.

The present disclosure also provides a software product embedded in a computer readable medium for providing analysis in material spectra characterization, the software product comprising: program codes for reading the emitted signals from the homogeneous sample; program codes for subtracting a background signal; program codes for matching signals emitted from a different thickness of the homogeneous sample; program codes for operating on signal count rates of different thicknesses of the homogeneous sample; program codes for calibrating a standard sample signals; and program codes for quantization of the material spectra.

The software program further comprising program codes to calculate the sum and the difference of the homogeneous sample peak count rates at different thicknesses, and to operate on the sum and difference of the peak count rates to improve the statistics.

### BRIEF DESCRIPTION OF THE DRAWINGS

The present disclosure will be readily understood by reading the detailed description together with the accompanying drawings, wherein like reference numbers designate like structural elements, and in which:

FIG. 1 shows a common radiation detection system and sample setup, for the purpose of acquiring an emission spectrum from the sample (prior art);

FIG. 2 shows a common radiation detection system and empty sample-container apparatus setup, for the purpose of acquiring an ambient background emission spectrum (prior art);

FIG. 3 shows a common radiation detection system and standard-sample setup, for the purpose of determining the detection system signal-detection-efficiency calibration (prior art);

FIG. 4 shows a common radiation detection system and unknown-sample setup, for the purpose of identifying and quantifying the signal-emitting sources within the unknown-sample (prior art);

FIG. 5 shows the functional block form of a generalized signal-detection-efficiency calibration and sample-analysis system (prior art);

FIG. 6 describes a methodology for conducting sample analysis (prior art);

FIG. 7 is a graph that illustrates the relationship between sample-depth (d, in cm) and the fraction of 46-keV gamma-rays that escape the sample un-attenuated [EscF(d)_{46keV}] for two different sample compositions: a water sample and a generic soil sample (natural phenomena);

FIG. 8 is a graph that illustrates the relationship between the characteristic energy (Eᵢ) of emitted signals and the radiation under-reporting factor [RURF(Eᵢ)=EscF(Eᵢ)_{water}/EscF(Eᵢ)ₛₒᵢₗ] for a typical soil sample where the soil's particular sample self-attenuation factor is replaced by the self-attenuation factor of a water standard-sample, for sample-depths of 0.5 cm, 2 cm, and 10 cm (natural phenomena);

FIG. 9 shows a common radiation detection system, empty sample-container apparatus, and reference source setup, for the purpose of acquiring a sample-free reference source spectrum (prior art);

FIG. 10 shows a common radiation detection system, standard-sample, and reference-source setup, for the purpose of calibrating the signal detection efficiency of the detection system (prior art);

FIG. 11 shows a common radiation detection system, unknown-sample, and reference-source setup, for the purpose of identifying and quantifying the signal-emitting sources within the unknown-sample (prior art);

FIG. 12 shows the functional block form of a generalized signal-detection-efficiency calibration and sample-analysis system that uses an external reference source for beaming-thru a standard-sample (prior art);

FIG. 13 shows a general methodology for conducting sample analysis that uses an external reference source for beaming-thru an unknown-sample (prior art);

FIG. 14 shows two cup halves of a 1d:2d sample-container apparatus;

FIG. 15 shows a 1d:2d sample-container apparatus in two positions for counting;

FIG. 16 shows a 1d:2d sample-container apparatus in two positions for counting a sample, for the purpose of acquiring 1d and 2d emission spectra;

FIG. 17 graphs genuine experimental data comparing normalized 1d and 2d characteristic peaks from emission spectra of two different thicknesses of the same standard-sample as a function of energy, for the purpose of showing how sample self-attenuation varies with signal energy and sample thickness;

FIG. 18 shows the setup of a signal-detection system and an empty 1d:2d sample-container apparatus that is counted in two positions, for the purpose of acquiring 1d and 2d ambient background emission spectra;

FIG. 19 shows the setup of a signal-detection system and a standard-sample in a 1d:2d sample-container apparatus that is counted in two positions the purpose of calibrating the detection system signal-detection efficiency;

FIG. 20 shows the software flowchart to process 1d and 2d emission spectra from a standard-sample, for the purpose of computing the calibration of the signal-detection efficiency for the signal-detection system;

FIG. 21 shows the setup of a signal-detection system and an unknown-sample in a 1d:2d sample-container apparatus that is counted in two positions, for the purposes of identifying signal-emitting sources within the unknown-sample and computing the quantities of the identified signal emitters;

FIG. 22 shows the software flowchart to process 1d and 2d emission spectra from an unknown-sample, for the purposes of identifying signal-emitting sources within the unknown-sample and computing the quantities of the identified signal emitters;

FIG. 23 shows the functional block form of a 1d:2d signal-detection efficiency calibration and a 1d:2d sample-analysis system;

FIG. 24 shows a 1d:2d methodology for conducting sample analysis;

FIG. 25A shows a first orthogonal view of an ultraviolet-visible cuvette used in a way as an nd:md and sample-container apparatus;

FIG. 25B shows a second orthogonal view of an ultraviolet-visible cuvette used in a way as an nd:md sample-container apparatus;

FIG. 25C shows a third orthogonal view of an ultraviolet-visible cuvette used in a way as an nd:md sample-container apparatus;

FIG. 25D shows a fourth orthogonal view of an ultraviolet-visible cuvette used in a way as an nd:md sample-container apparatus;

FIG. 26 shows the setup of a signal-detection system and an empty nd:md sample-container apparatus that is counted in two positions, for the purpose of acquiring nd and md ambient background emission spectra;

FIG. 27 shows the setup of a signal-detection system and a standard-sample in an nd:md sample-container apparatus that is counted in two positions, for the purpose of calibrating the detection system signal-detection efficiency;

FIG. 28 shows the software flowchart to process nd and md emission spectra from a standard-sample, for the purpose of computing the calibration of the signal detection efficiency for the signal-detection system;

FIG. 29 shows genuine experimental data comparing normalized nd and md characteristic peaks from emission spectra from two different thicknesses of the same standard-sample as a function of energy, for the purpose of showing how sample self-attenuation varies with signal energy and sample thickness;

FIG. 30 compares genuine experimental results of nd:md methodology for the sample-specific escaped-fraction of an actual standard-sample versus theoretical computations of the sample-specific escaped-fraction of an actual standard-sample, based on the known elemental contents of the standard-sample itself;

FIG. 31 shows genuine experimental results of nd:md methodology for computing sample-free detected-fraction calibration of an actual signal-detection system;

FIG. 32 shows the setup of a signal-detection system and an unknown-sample in an nd:md sample-container apparatus that is counted in two positions, for the purposes of identifying signal-emitting sources within the unknown-sample and computing the quantities of the identified signal emitters;

FIG. 33 shows the software flowchart to process nd and md emission spectra from an unknown-sample, for the purposes of identifying signal-emitting sources within the unknown-sample and computing the quantities of the identified signal emitters;

FIG. 34 shows genuine experimental data comparing normalized nd and md characteristic peaks from emission spectra from two different thicknesses of the same unknown-sample as a function of energy, for the purpose of showing how sample self-attenuation varies with signal energy and sample thickness;

FIG. 35 compares genuine experimental results of nd:md methodology for a sample-specific escaped-fraction of a soil-based unknown-sample with that of a water-based standard-sample, for the purpose of demonstrating the difference between water- and soil-based sample self-attenuation;

FIG. 36 shows genuine experimental results for the quantitation of americium-241 (“Am-241”) in a soil sample using the nd:md methodology for quantitating signal emitters in unknown-samples, for the purpose of demonstrating the improvement in results using the nd:md methodology compared to one commonly used (i.e. ‘prior art’) methodology.

FIG. 37 shows the software flowchart to process nd and md emission spectra from a standard-sample, for the purpose of improving statistics of the computed sample-free detected-fraction calibration;

FIG. 38 shows the software flowchart to process nd and md emission spectra from an unknown-sample, for the purpose of improving statistics of the computed quantities of signal-emitting sources within the unknown-sample;

FIG. 39 shows an arrangement of three different thicknesses of a single sample, whereby each thickness is examined either by three separate detectors simultaneously, or by one detector that examines each different thickness of the sample in turn, for the purpose of improving the quality of the sample self-attenuation determination;

FIG. 40 shows an apparatus comprised of two pairs of detectors examining a single sample at two different thicknesses;

FIG. 41 shows an nd:md apparatus setup for measuring emission spectra from a non-cylindrical pipe of cross-section nd by md that contains a flowing signal-emitting sample;

FIG. 42 shows a system comprised of a multi-thickness sample-container apparatus, shield, and three detectors, for the purpose of simultaneously measuring emission spectra through three different thicknesses of the same sample, or by one detector measuring emission spectra through each discrete thickness in turn;

FIG. 43 illustrates a two-sided, wrap-around-type sample-container apparatus;

FIG. 44 illustrates a two-sided, well-type sample-container apparatus;

FIG. 45 illustrates an irregularly shaped sample-container apparatus counted through two different mean thicknesses relative to the placement of the detection system;

FIG. 46 shows a system of two rovers, each mounted with one detector, or one rover mounted with one detector that moves to two different positions with respect to the sample, for the purpose of measuring the emission spectra from at least two different thickness of the sample;

FIG. 47 shows a system of three detectors, each having its own collimator, and three extant shields whose sample length is defined as the distance from a particular detector to a particular shield; or one movable detector whose sample length is defined as the distance from the detector to each respective shield;

FIG. 48 shows an airplane flying over non-level terrain, using at least one signal detector to frequently determine the distance to the terrain, while simultaneously using at least one collimated detector to acquire the emission spectra from the intervening air- or other gas-sample;

FIG. 49 shows genuine experimental data of induced fluorescence spectral peaks emitted from the non-radioactive elements cerium (Ce), gadolinium (Gd), and hafnium (Hf);

FIG. 50 shows one particular arrangement of four detectors (or one detector in four different positions); a sample; and an exciter beam, for the purpose of measuring the sample emission spectrum through four different sample thicknesses; and

FIG. 51 shows one implementation of a multi-energy beam system for inducing peak signal fluorescence at different depths of the sample.

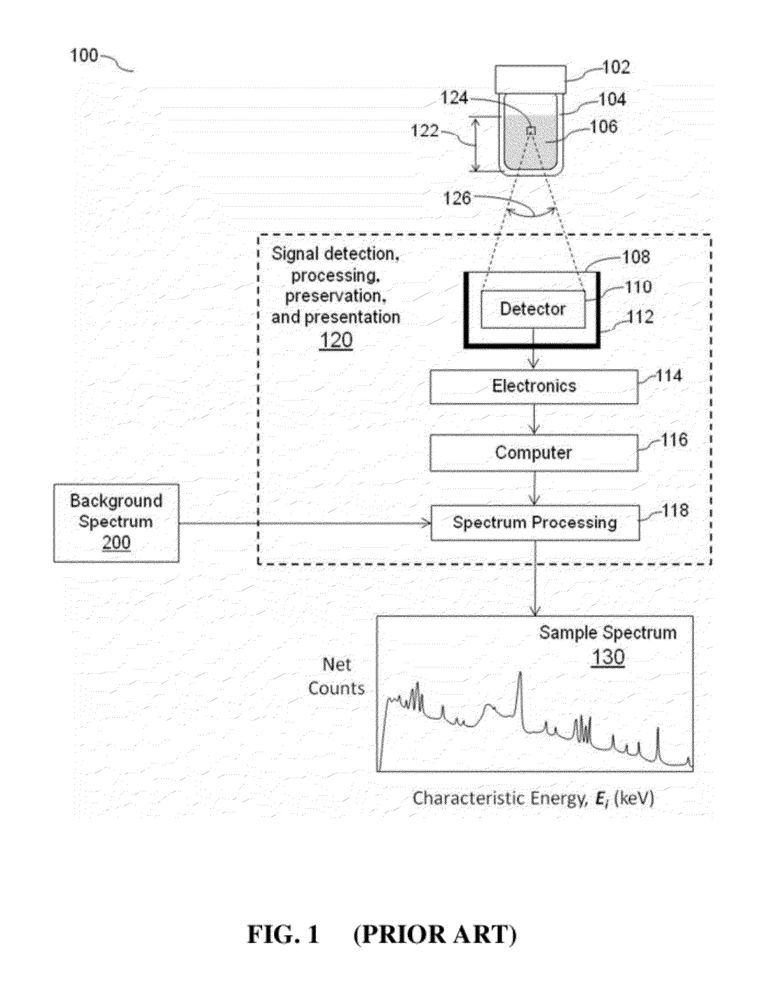

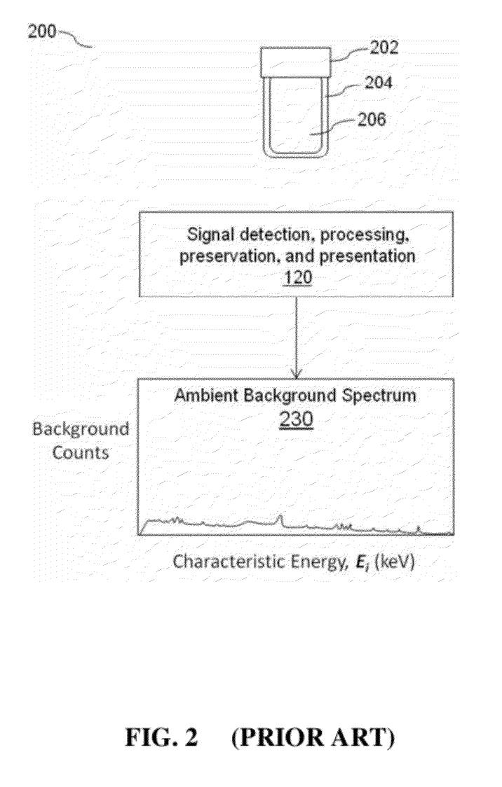

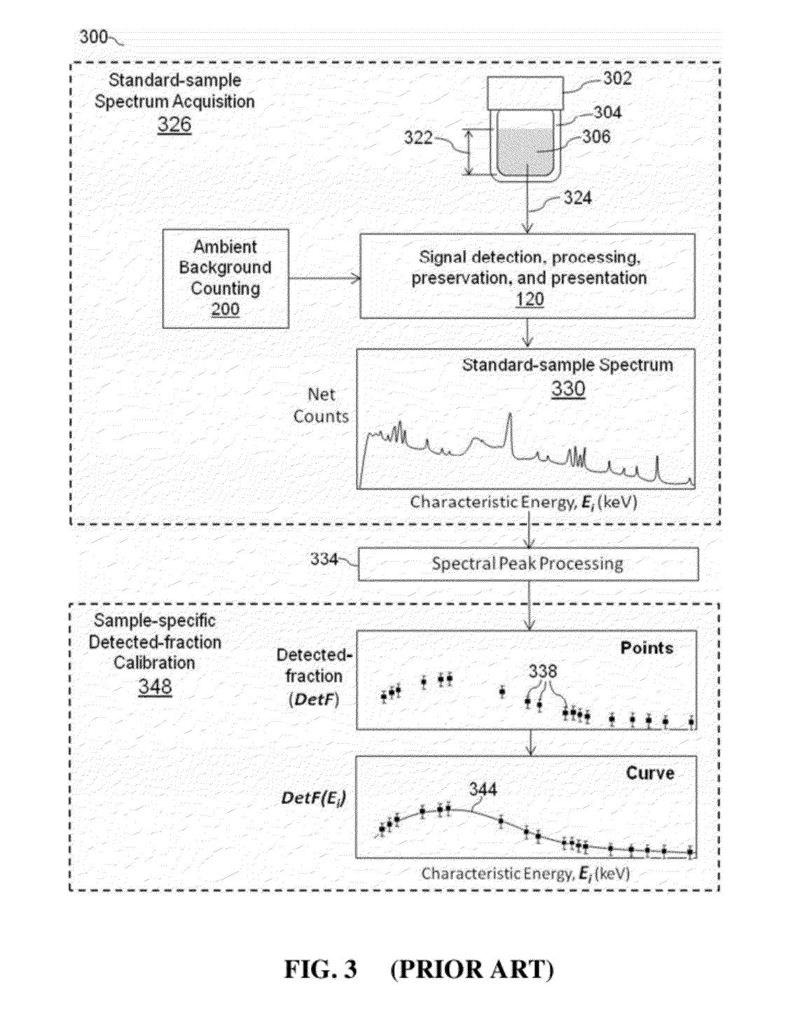

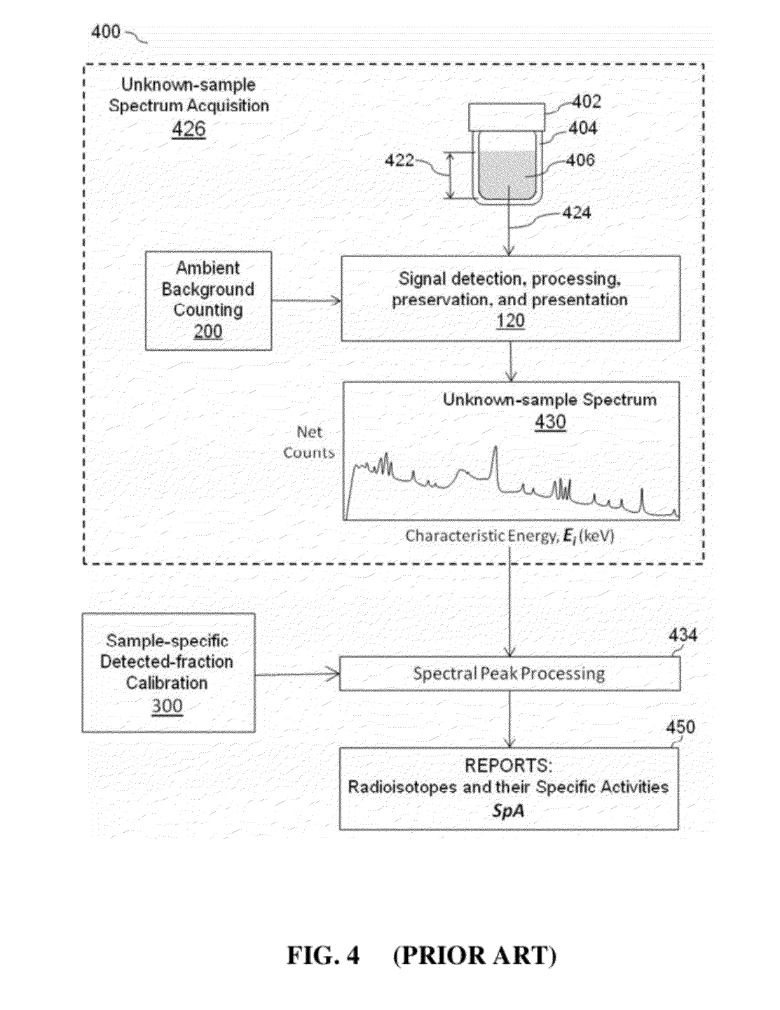

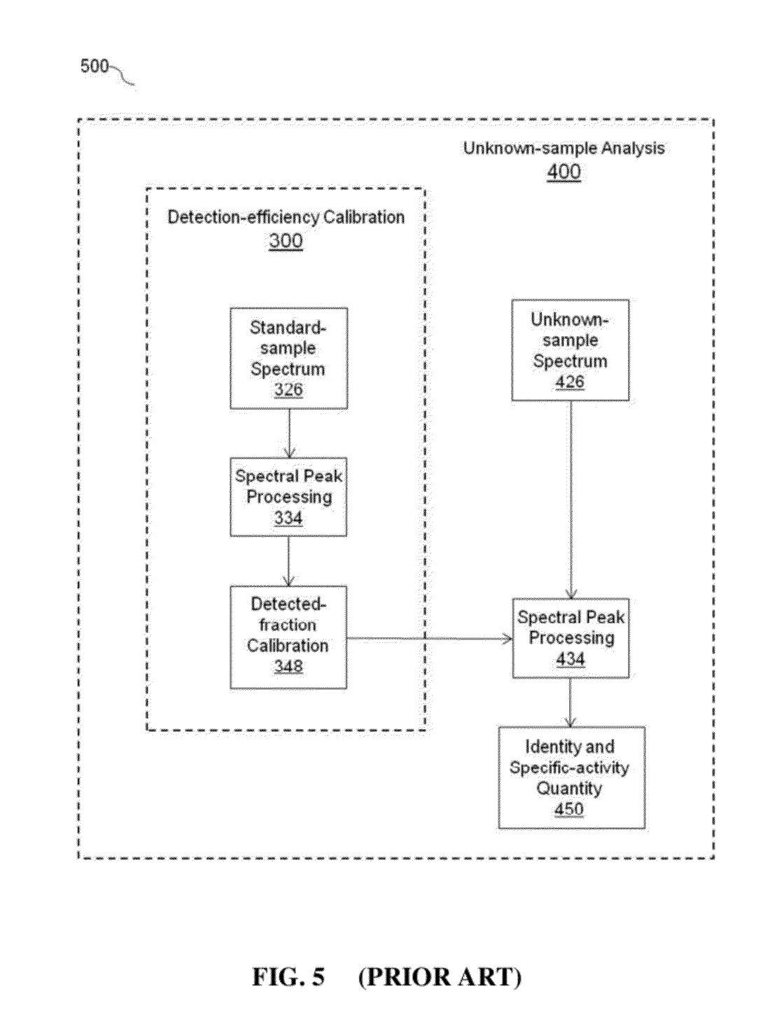

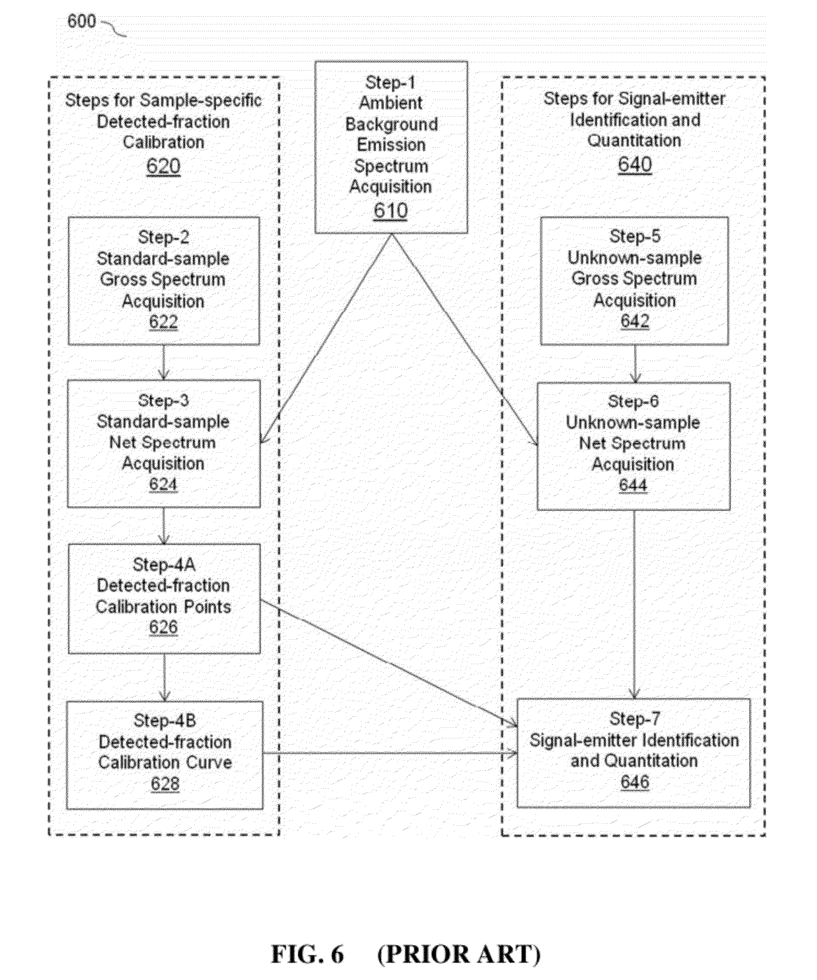

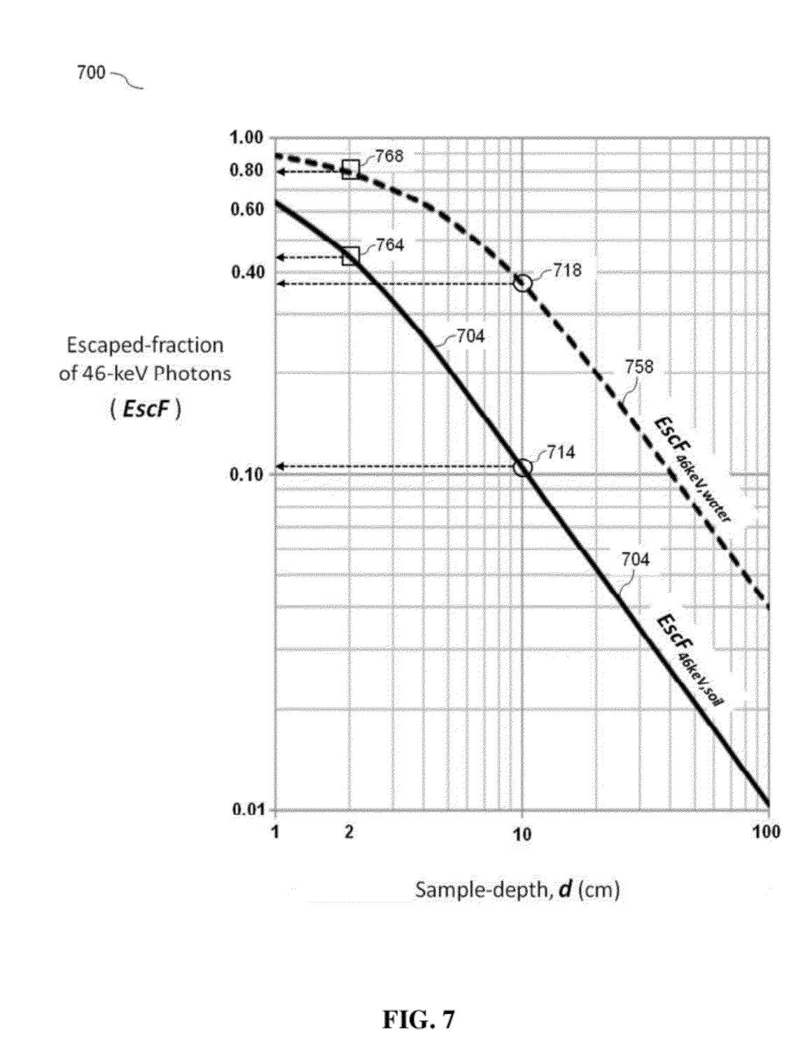

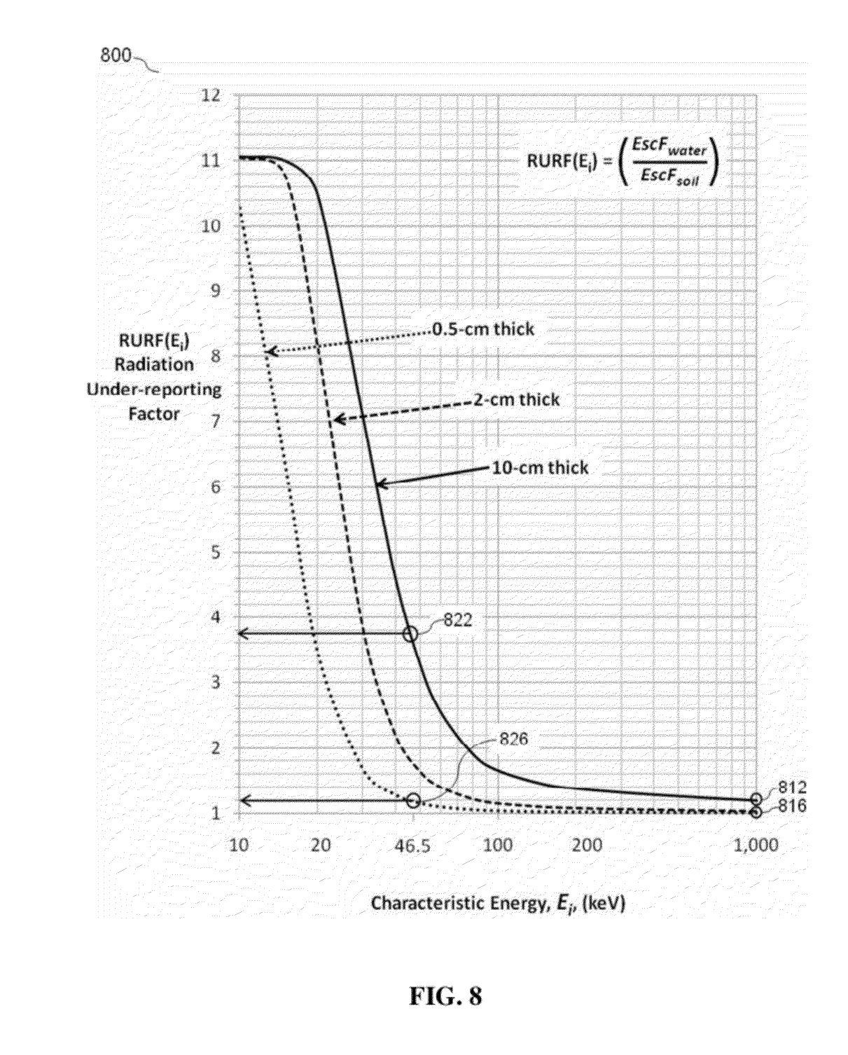

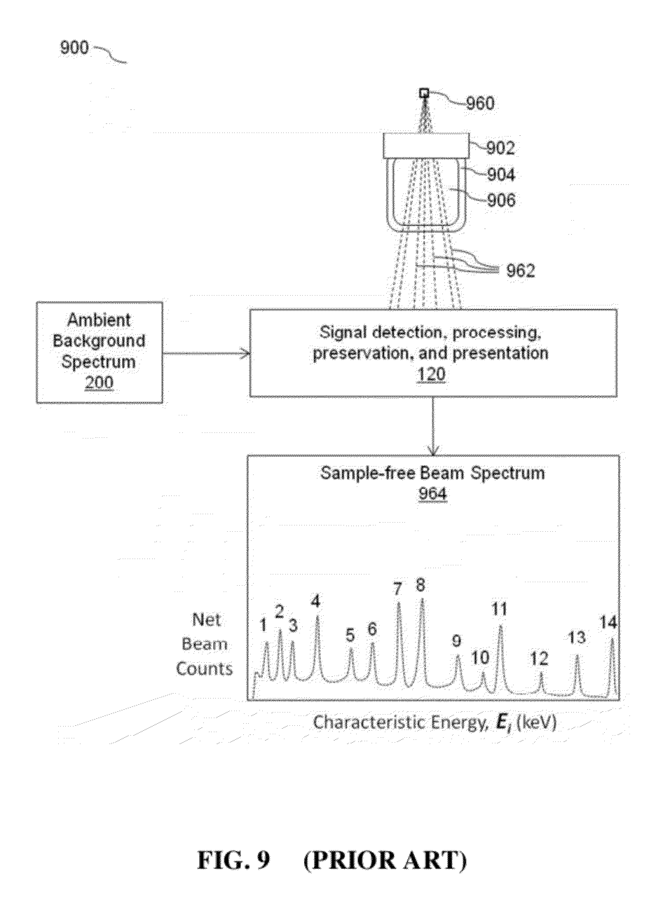

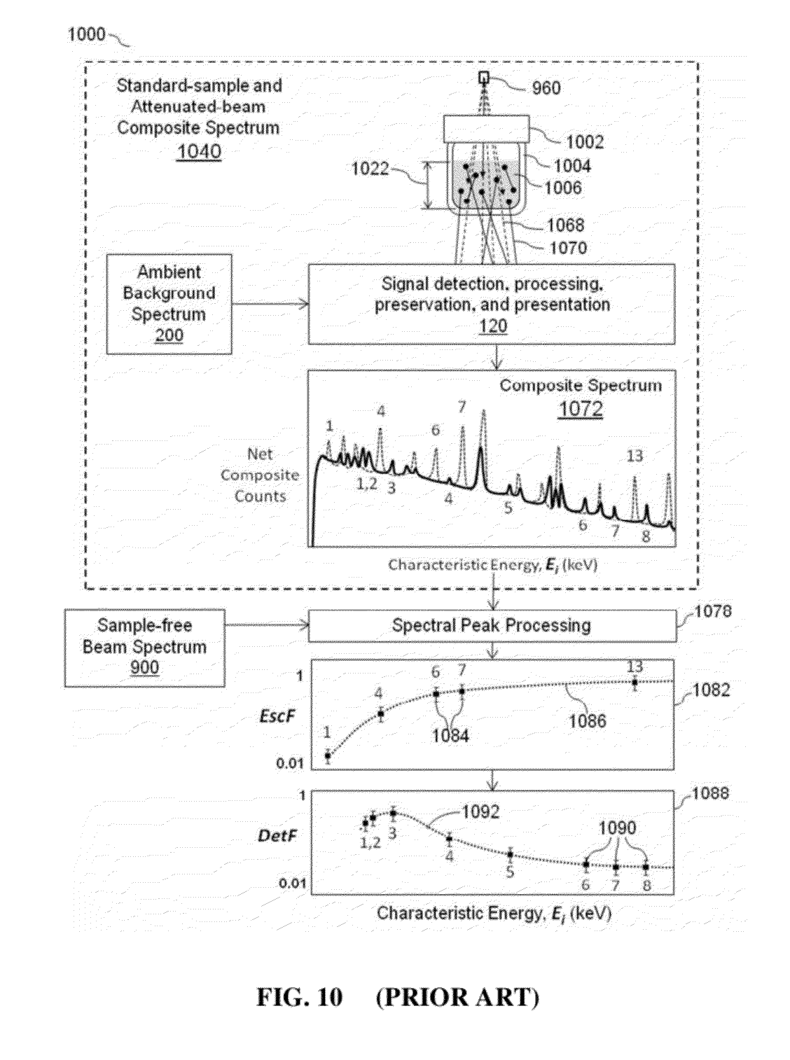

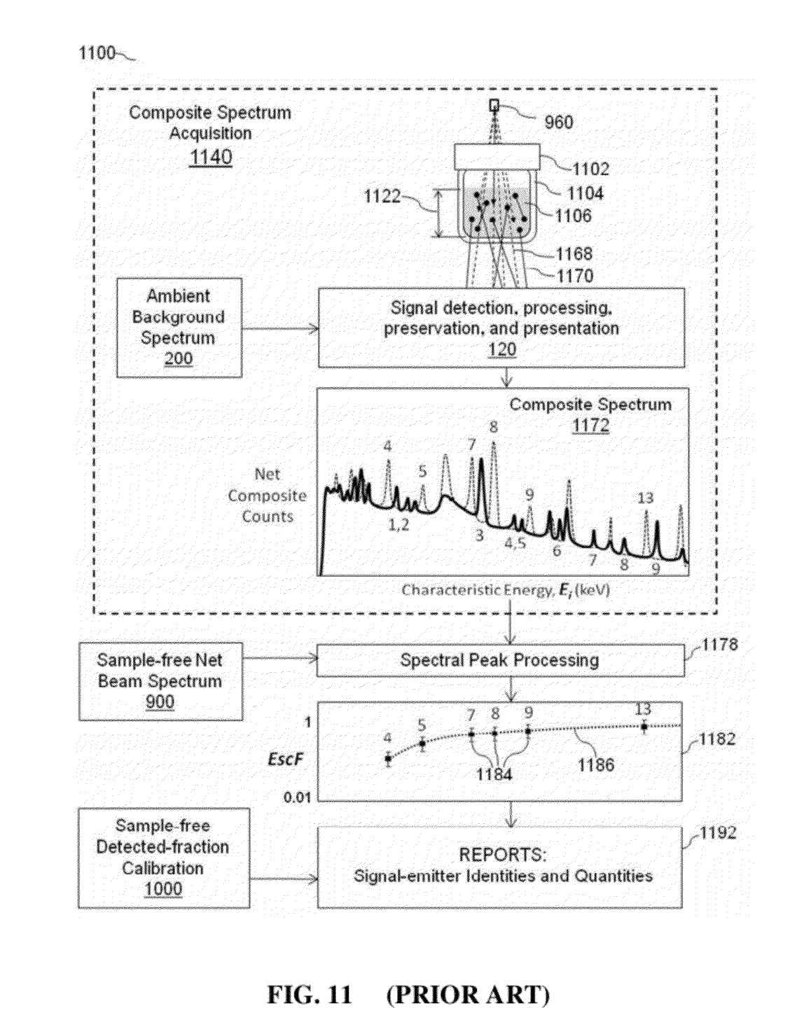

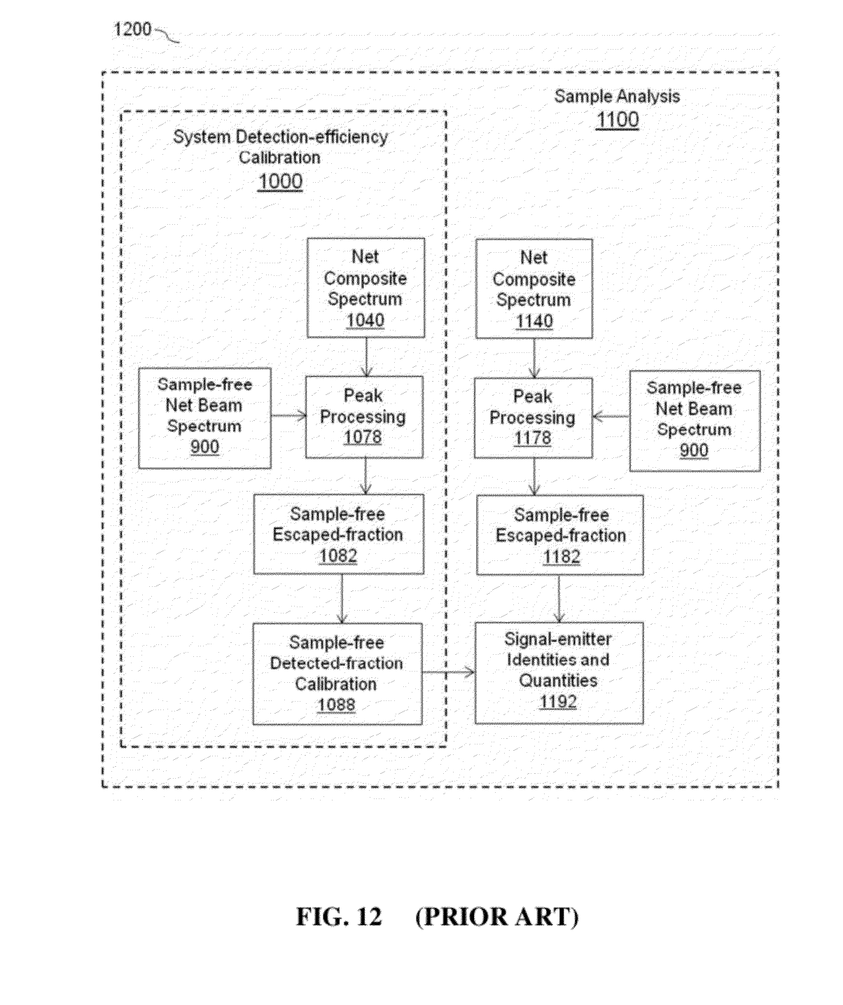

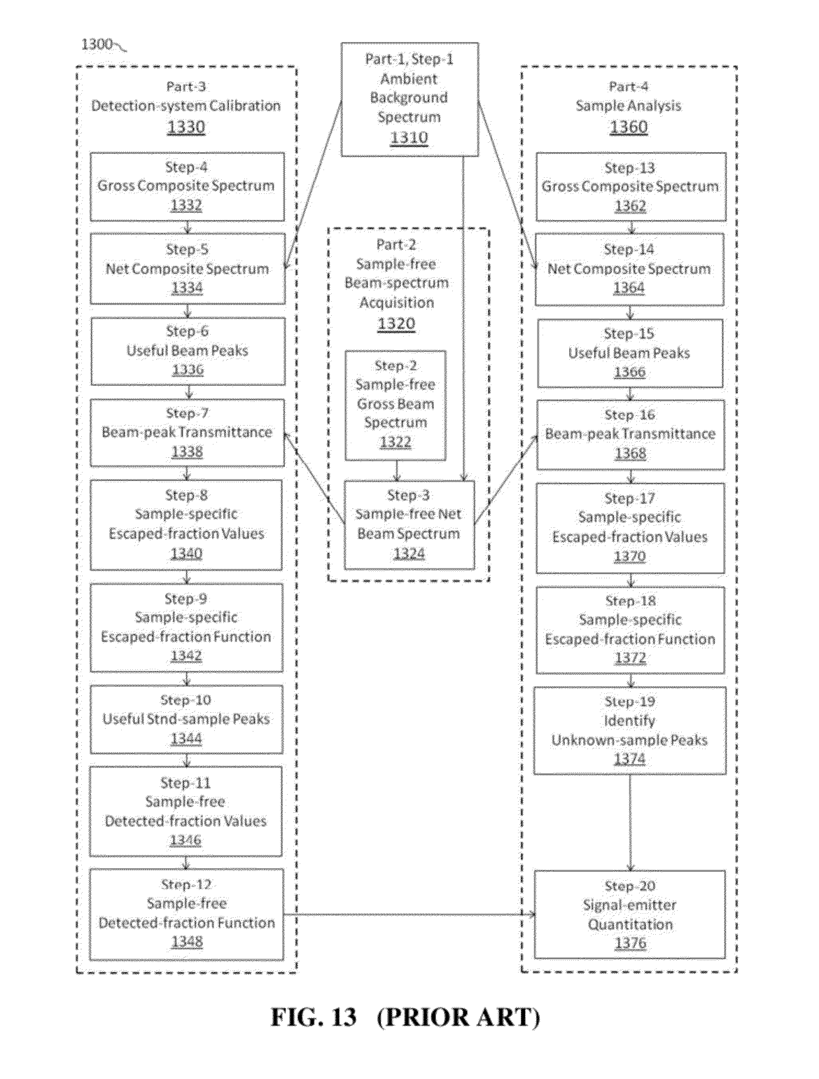

### DETAILED DESCRIPTION

### Important Terms in this Disclosure

Attenuation.

A fraction of the signals emitted within the sample volume are said to undergo “sample self-attenuation” prior to exiting the sample. Thus, “attenuation” and “self-attenuation” refer to the same process of attenuation, but sample self-attenuation is more specific to the volume location of the signal emission. Characteristic signal attenuation and characteristic signal transmittance are related, such that the attenuated-fraction (AttnF_{Ei,smpl}) and un-attenuated “escaped-fraction” (EscF_{Ei,smpl}) of sample-emitted characteristic signals sum to unity (AttnF_{Ei,smpl}+EscF_{Ei,smpl}=1).

Characteristic Signal.

Characteristic signals have an emission energy that can be used to identify their signal-emitting source. Detectable gamma-ray and x-ray photons often follow nuclear decay, and they are just two types of characteristic signal.

Counting System.

Synonymous with Detection system.

Counts, Count Rates, and Lines.

Refers to characteristic peaks that make up an emission spectrum.

Depth (of the Sample).

Refers to the thickness of a sample in the detector direction.

Detection System.

Consists of the sample-container apparatus (if there be one), detector, vacuum system (if there be one), pulse-shaping electronics, computer control, software, and any other part or subsystem that helps the detection system collect, shape, remember, or present emitted signals.

Detected-Fraction Calibration.

In the literature, the sample-specific and sample-free detected-fraction calibration terms are often collectively referred to as the “detection-efficiency calibration”, “counting-efficiency calibration”, “energy-efficiency calibration”, or simply the “efficiency calibration”, among others.

Escaped-Fraction.

The complement of the Attenuated-fraction, the sum of which equals one, i.e. AttnF_{Ei,smpl}+EscF_{Ei,smpl}=1.

Multiplet (Peaks).

A set of overlapping peaks in a spectrum containing multiple characteristic peaks so close in characteristic energy in relation to each other that the resolving fidelity of the detector is unable to resolve them into individual singlet peaks (i.e. a series of non-overlapping characteristic peaks). See also Singlet (peak).

Operator.

An operator is a general title of a person that might operate or implement the apparatuses, methods, software, and systems of this disclosure. An operator, depending on the particular activity described in this disclosure, might also be known as a technician, spectroscopist, spectrometrist, or scientist, among other related and appropriate titles.

Quantitate.

To compute or calculate a quantity. Synonymous with “quantify”.

Radioisotope.

Synonymous with Radionuclide. See also Signal emitter.

Sample.

Any homogenous substance that has volume. To be considered as a “sample” in this disclosure, the substance must contain at least one signal emitter. In this disclosure, samples are primarily referred to as “standard-sample”, “unknown-sample”, or simply “sample” when discussing samples in general. Standard-samples have at least some of their contents known and are used to calibrate the characteristic signal-detection efficiency of a detection system (See also Counting system).

Signal Emitter.

Any entity that emits characteristic signals. Signal emitting entities include radioisotopes; nonradioactive isotopes; and excited elements and molecules, etc.

Singlet (Peak).

One non-overlapped, statistically significant characteristic peak. If there are other characteristic peaks in a given spectrum, then they will not overlap a singlet. Overlapping characteristic peaks are called multiplets. (See also Multiplet (peaks).)

Specific activity (SpA) is the disintegration rate occurring in a unit of mass of sample and is commonly defined in units of curies per gram of sample (Ci/g). In this disclosure, specific activity generalizes to include the rate or quantity of total emission of any type of signal emitter.

I. “1d:2d” Sample Analysis

### Overview

1d:2d sample analysis applies apparatuses, methods, software, and systems that facilitate quantitation of signal emitters contained within a homogenous sample. Among the most important advantages enabled by 1d:2d are (1) a standardized detected-fraction calibration (DetF_{Ei,smplFr}) that is independent of any homogeneous sample composition; which leads to (2) a simpler, more reliable signal-emitter identification (Rⱼ) and specific-activity quantitation (SpA_{Rj,smpl}); (3) that only one well composed, homogenous standard is needed to calibrate the detection system for any other homogenous known or unknown-sample composition; and (4) by computing the sample self-attenuation for every spectral peak, independent of all other characteristic peaks, calibration and signal-emitter quantitation, are extended to lower-energy characteristic signals. 1d:2d sample apparatuses, methods, software, and systems can replace more complex and more uncertain prior-art apparatuses, methods, software, and systems; e.g. prior art that includes a multiplicity of compositional standards and peak-ratio calibration curves; complex stochastic numerical modeling (e.g. Monte Carlo methods); “guestimating” by the operator about sample self-attenuation; and beam-thru methods, among others.

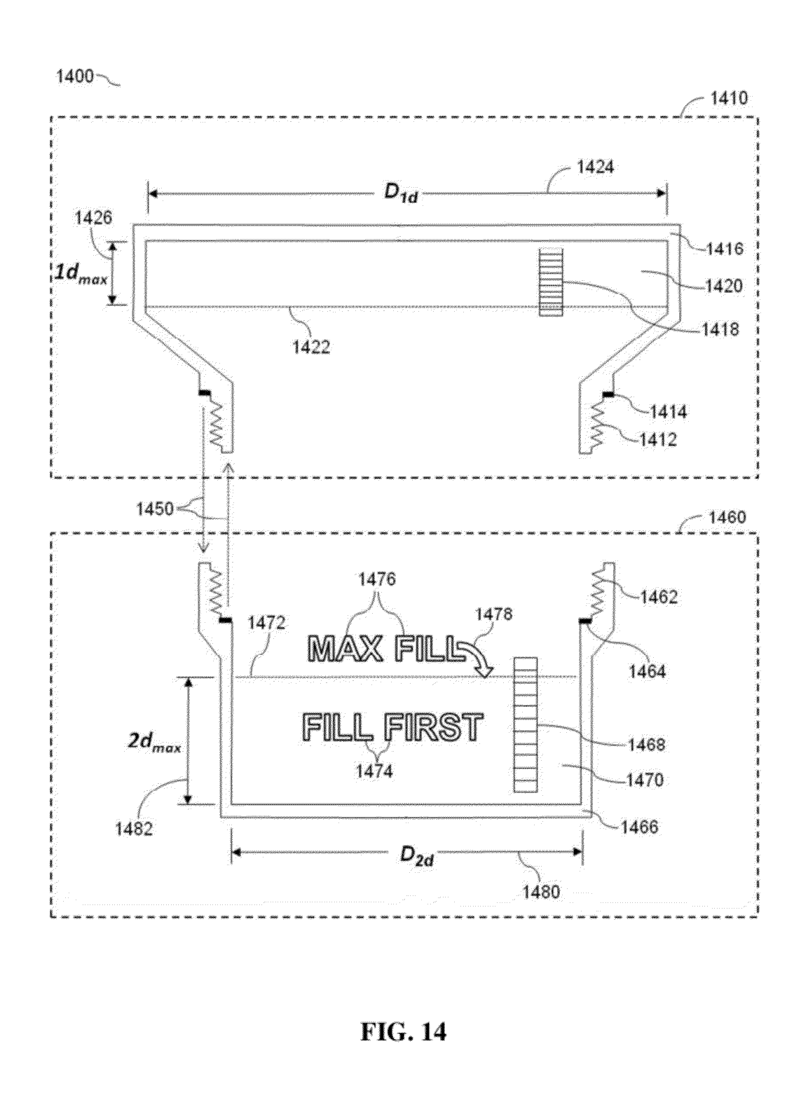

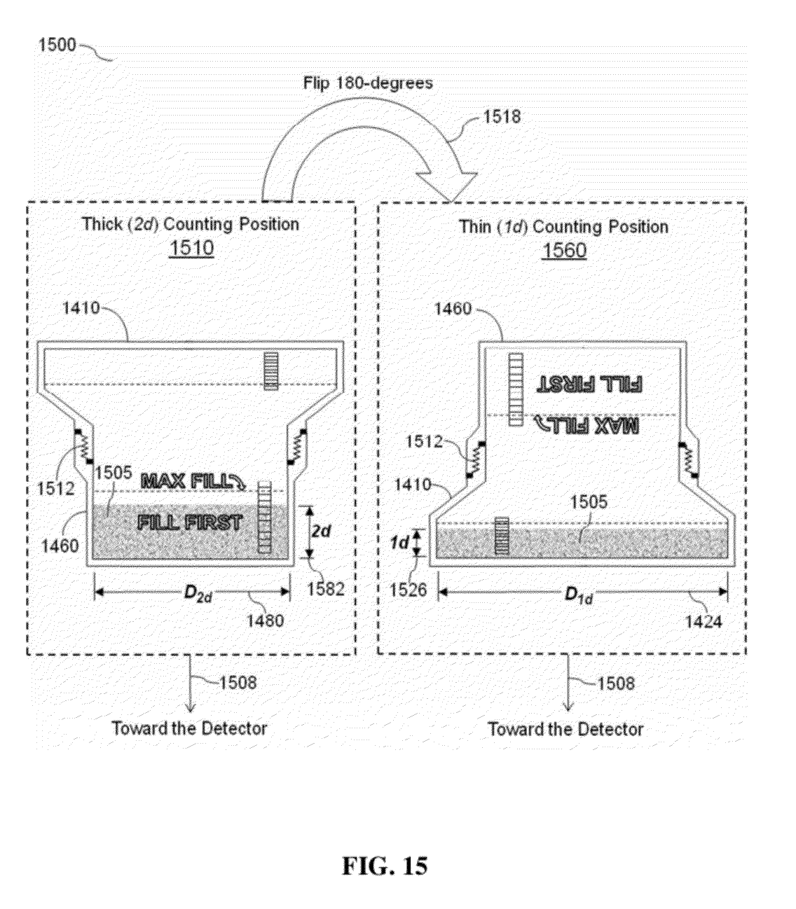

“1d:2d” Sample-Container Apparatus (FIGS. 14 and 15)

The present disclosure includes a sample-container apparatus that “shapes” the sample volume into at least two different physical thicknesses (called “1d” and “2d”)—also referred to as sample “depths”—when viewed in the same direction as the detector. According to one sample-container apparatus embodiment, FIG. 14 illustrates a sample-container apparatus 1400 comprised of two cups, i.e. a “top” cup 1410 and an “upright” cup 1460 that form a connectable pair 1450. The top cup is shown in the “upside-down” position (i.e. the opening of the top cup is face-down) 1410 with its large-diameter base (D_{1d}) 1424 that acts as a lid when the top cup 1410 is affixed to the upright cup 1460 by its screw-type rim 1412. The upright cup 1460 with its smaller-diameter base (D_{2d}) 1480 acts as the sample “holder” in the position shown, and it also has a screw-type rim 1462. The resulting sample-container apparatus 1400 can be described as two cups of different-diameter bases that join together into a connectable pair 1450 at their same-diameter open rims 1412 and 1462.

The narrow-diameter cup 1460 shows a screw-type rim 1462 which, when screwed securely to the wide-diameter cup 1410, seats snugly against optional opposing compression liners 1464 and 1414 to tightly seal the screw-type joints 1462 and 1412. To lessen the chance of leakage, the screw-type joints are shown in the middle of the container, so that the sample never “rests” against the joint, especially if the sample is a liquid. Only briefly will the sample even touch the joint when the sample-container apparatus is flipped 180 degrees (i.e. from one counting position to the other), and the sample volume shifts to the other side of the container to then fill the opposite cup, which, in this embodiment, would be the wide-diameter cup 1410. Other types of joints are possible, such as “slide-into”, “twist-into”, or “snap-into” joints, to name a few, and all of these variations of joints, whatever their configuration, are within the disclosure. The salient point is that a tight seal is achieved.

The narrow-diameter cup 1460 is comprised of a container wall 1466 that is made of material whose composition is inert with respect to the sample material to be placed into the cup. A space 1470 sufficient to hold a sample volume is present and should be filled no deeper than a maximum sample-depth (2dₘₐₓ) 1482 indicated by an optional visible maximum sample-fill line 1472. In the sample-container apparatus embodiment illustrated in FIG. 14, optional visible “MAX FILL” symbols 1476 and an optional visible arrow 1478 that points the symbols “MAX FILL” to the optional maximum-fill line 1472 provide visible cues to the operator to limit the sample volume placed into the cup 1460. Limiting the sample volume to the maximum depth indicated by the MAX FILL line 1472 ensures that the sample will not make prolonged contact with the optional compression liners 1464 and 1414 or rim joints 1462 and 1412 when the sample is at rest on a level surface. This reduces the opportunity for sample leakage, especially if the sample is liquid. The narrow-diameter cup 1460 also shows optional visible markings “FILL FIRST” 1474 on the side of the container to indicate that the small-diameter cup 1460 should be filled first because doing so results in a thicker sample which makes for easier reading of the optional maximum-fill line 1472 and the corresponding optional sample-depth scale 1468.

The wide-diameter cup 1410 also shows a screw-type rim 1412 which, when screwed securely to the narrow-diameter cup 1460, seats snugly against optional opposing compression liners 1414 and 1464 to tightly seal the screw-type joints 1412 and 1462. The wide-diameter cup 1410 is comprised of a container wall 1416 that is made of material whose composition is inert with respect to the sample material to be placed into the cup. A space 1420 sufficient to hold a sample volume is present and should be filled no deeper than a maximum sample-depth (1dₘₐₓ) 1426 indicated by an optional visible maximum sample-fill line 1422 and optional sample-depth scale 1418.

The narrow diameter 1480 of the cup 1460 forces the sample into a shape whose thickness is greater 1482 following the rule that, for a given volume of sample, the smaller the diameter of a cylindrical space, the thicker the cylinder length 1482 must be. In contrast, the wide-diameter 1424 of the cup 1410 allows the sample to “spread out” into a more shallow thickness 1426.

For a given sample volume (VOLₛₘₚₗ) and mass (Mₛₘₚₗ), the diameter of a cylindrical sample-container apparatus determines the thickness d of the sample. The larger the diameter, the more spread out i.e. “thinner” the sample becomes, as illustrated in FIG. 14. The diameters of the two cups that join to form a double-cup, cylindrical, sample-container apparatus 1400 can be designed for any desired ratio of the double-thickness dimensions, e.g. the sample-container apparatus embodiment illustrated in FIG. 14 shows a “thick” sample dimension (2dₘₐₓ) 1482 that is twice the thickness of the “thin” sample dimension (1dₘₐₓ) 1426. The relationship between the two thicknesses and their respective cylindrical diameters are described by Equations [32a]-[32f].

Initial condition: 2d=2*1d [32a]

Mass equivalence: M_{smpl,2d}=M_{smpl,1d} [32b]

Volume equivalence: VOL_{smpl,2d}=VOL_{smpl,1d} [32c]

### Volume Equation:

$$2 d * \frac{π \cdot {( {D}_{2 d} )}^{2}}{4} = 1 d * \frac{π \cdot {( {D}_{1 d} )}^{2}}{4} \qquad [ 32 d ]$$

### Substituting and Canceling Terms:

$${D}_{2 d} = \frac{{D}_{1 d}}{\sqrt{2}} \qquad [ 32 e ]$$

Diameter Relationship: D_{1d}=\sqrt{2}*D_{2d} [32f]

FIG. 15, 1500 illustrates two cups 1410 and 1460 joined together at 1512 to make an enclosed single-sample-container apparatus that is shown in two different positions 1510 and 1560 toward the signal detector 1508. The sample-container apparatus in the “thick” (2d) counting position 1510 shows the volume sample 1505 filling the cylindrical volume defined by the small-diameter (D_{2d}) 1480 and “thick” depth (2d) 1582. By flipping the sample-container apparatus 180-degrees 1518, the volume sample 1505 falls into the cylindrical volume defined by the large diameter (D_{1d}) 1424 and “thin” depth (1d) 1526. Notice that the illustrated sample volume 1505 does not quite fill the entire space allowed for the sample, i.e. the sample volume does not reach the MAX FILL line. Thus, the fill depth 2d is <2dₘₐₓ. The only requirement specified by Equation [32a] for this particular sample-container apparatus embodiment is that the two sample-depths, i.e. 1d and 2d, be in the ratio of 1:2.

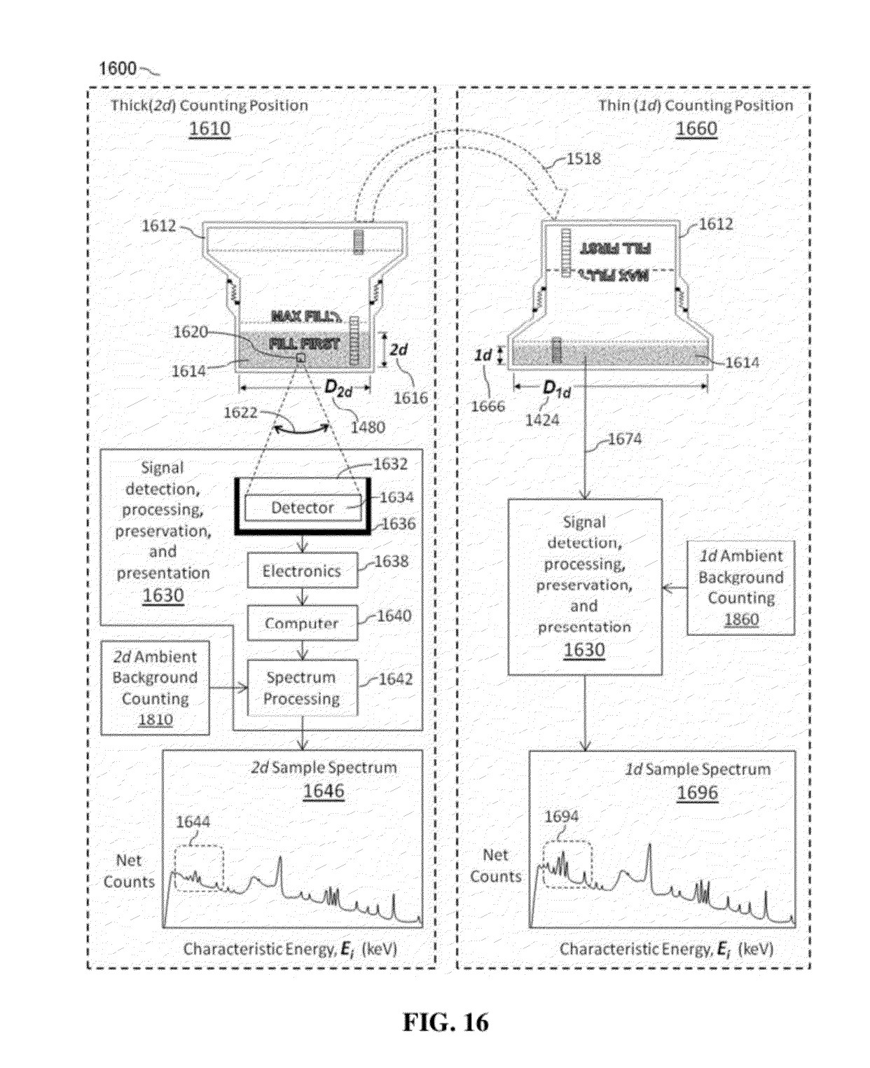

### A Typical 1d:2d Detection System Setup (FIG. 16)

FIG. 16 illustrates a 1d:2d counting-system setup 1600 for two different countings of the same sample, where the orientation of the sample-container apparatus is different (i.e. flipped 180 degrees) for each counting, and where the sample is poured into two different (i.e. 1d and 2d) depths 1616 and 1666 within the same sample-container apparatus.

Beginning the description of 1600 with the thick (2d) counting position 1610, the narrow-diameter-base (D_{2d}) 1480 forms the sample 1614 into a cylinder of thickness 2d 1616. A sample mass (Mₛₘₚₗ) may be computed by Equation [33a], where the mass of an empty sample-container apparatus (M_{cntnr}), is subtracted from the combined mass of the sample-container apparatus and the sample (M_{cntnr+smpl}):

Mₛₘₚₗ=M_{cntnr+smpl}−M_{cntnr} [33a]

The signal-emission rate from a specific signal emitter (Rⱼ) in a unit of sample mass is commonly reported as ‘specific activity’ (SpA_{Rj,smpl}). Energy-specific (Eᵢ) signals are called characteristic (Eᵢ) signals, which act like the lines of a signal emitter ‘fingerprint’ in the emission spectra. A specific signal emitter (Rⱼ) may emit several characteristic (Eᵢ) signals, and each has a probability of emission called “yield-fraction” (YF_{Rj,Ei}). When a characteristic signal is emitted from a small volume-of-sample 1620 within the entire sample 1614, such signal must pass through some portion of the sample to escape the sample 1614. There is a probability that the emitted characteristic signal is attenuated as it passes through, and interacts with, the surrounding sample 1614. The fraction of characteristic signals that are attenuated within the sample can be called the “sample-specific attenuated-fraction” (AttnF_{Ei,smpl,2d}). The other fraction, i.e. the fraction that escapes the sample undiminished in energy, can be called the “sample-specific escaped-fraction” (EscF_{Ei,smpl,2d}). The attenuated-fraction and escaped-fraction terms sum to unity:

AttnF_{Ei,smpl,2d}+EscF_{Ei,smpl,2d}=1 [33b]

To correct for that fraction of characteristic signals that are attenuated in the sample 1614, a “sample-specific attenuation-corrected factor” (AttnCF_{Ei,smpl}) is defined:

$${AttnCF}_{Ei , smpl , 2 d} = \frac{1}{{EscF}_{Ei , smpl , 2 d}} = {( {EscF}_{Ei , smpl , 2 d} )}^{- 1} = \frac{1}{1 - {AttnF}_{Ei , smpl , 2 d}} \qquad [ 34 c ]$$

For those characteristic signals that escape the sample, only a fraction are headed in a direction to intercept the detector; this fraction is called the “geometry-fraction” (GF), which is defined by the solid angle 1622 subtended by the sensitive volume of the detector 1634.

Before reaching the detector, such sample-escaped characteristic signals within the solid angle 1622 must pass through attenuating materials that include the sample-container apparatus wall 1612; any air or gas between the container wall 1612 and the detector 1634; the detector window 1632 (if there be one); and the detector ‘dead layer’ (not shown), and then be fully absorbed in the detector 1634 itself. Each of these materials has a probability for attenuating and absorbing characteristic signals. The fraction of characteristic signals that escape the sample to register in the detection system as full-energy counts (C_{Ei,smpl,2d}) is called the “captured-fraction, (CapF_{Ei})”. If a detector window 1632 is present, then often a sturdy casing 1636 is also provided to vacuum-seal the detector 1634.

The geometry fraction (GF) and the captured-fraction (CapF_{Ei}) are treated as a grouped term called the “sample-free (smplFr) detected-fraction” (DetF_{Ei,smplFr}):

DetF_{Ei,smplFr}=(GF*CapF_{Ei}) [33d]

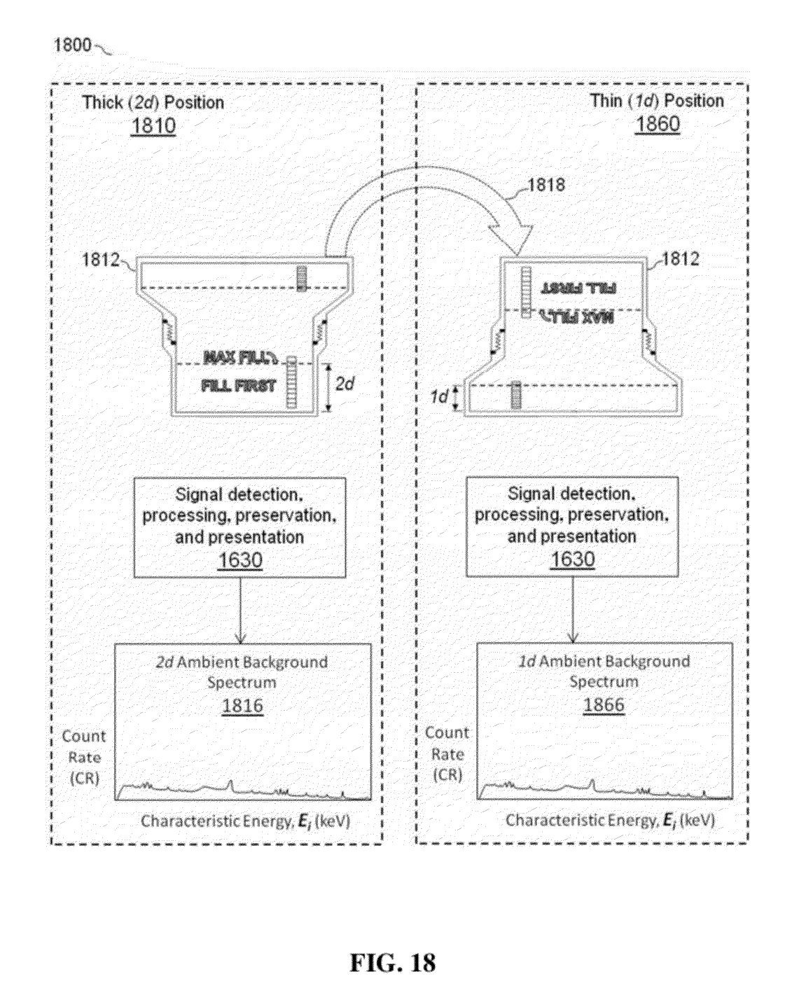

Barring other loss mechanisms, characteristic photons that fully absorb and register in the detector produce electrical pulses that are passed along to associated pulse-shaping electronics 1638. The shaped pulses are commonly passed to a computer 1640 that has spectrum-analysis software installed 1642. The pulses are stored and they accumulate as long as the detection system continues counting them. It is convenient to describe the signal detection, processing, preservation, and presentation parts of the detection system as a subsystem 1630. Over time, enough sample-derived signals and non-sample ambient-background-derived signals, taken together, produce a “gross spectrum” (not shown). The gross spectrum is the raw data resulting from the counting of a sample 1614 before the non-sample ambient background signals are subtracted out. The spectrum-processing software 1642 allows for removing most of these non-sample ambient background counts by calling in and normalizing an ambient background emission spectrum 1810 (in FIG. 18) to the sample counting time (t_{smpl,2d}), and then, by subtracting-out that normalized background spectrum from the gross characteristic spectrum, to yield the net 2d sample spectrum 1646, which is comprised of many peaks riding on top of background noise, and which is different from the non-sample ambient background signals 1810.

The number of counts (C_{Ei,smpl}) in a spectral peak is partly computed by the length of counting time (tₛₘₚₗ). The sample counting time (tₛₘₚₗ) may be shorter than the length of time as measured by a typical wristwatch (t_{wristwatch}) because sample counting time (tₛₘₚₗ) rejects those short ‘snippets’ of time taken by the detection system ‘dead time’ (t_{dead}), ‘rise time’ (tᵣᵢₛₑ), ‘pileup’ (tₚᵢₗₑᵤₚ), and possibly other phenomena (tₒₜₕₑᵣ) that limit the actual length of time that the detection system is available (tₛₘₚₗ) to register peak counts (C_{Ei,smpl}):

tₛₘₚₗ=(t_{wristwatch})−(t_{dead}+tᵣᵢₛₑ+tₚᵢₗₑᵤₚ+tₒₜₕₑᵣ) [33e]

Once the 2d sample spectrum 1630 is obtained, the sample-container apparatus is flipped 180 degrees 1518 so that the sample 1614 falls into the cylindrical volume defined by the large diameter (D_{1d}) 1424 and thin depth (1d) 1666. The sample in its thin (1d) counting position 1660 is counted again. Those characteristic signals that escape the thin (1d) sample and head toward the detector 1674, and are fully absorbed and registered in the signal detection, processing, preservation, and presentation subsystem 1630, produce, along with the ambient background signals, a gross spectrum (not shown). The ambient background signals 1860 in FIG. 18 are subtracted from the gross spectrum, leaving a net 1d sample spectrum 1696. By visually comparing the thick and thin net sample spectra 1646 and 1696 in FIG. 16, there is a significant difference in the characteristic peak heights, especially at the low-energy portion of the two spectra 1644 and 1694: the shorter and highly attenuated low-energy peaks 1644 from the thick sample-depth 1616, and the taller and lesser-attenuated low-energy peaks 1694 from the thin sample-depth 1666. The highly attenuated reduced peaks of the thick sample counting 1610 are expected because, at low energy, more of the characteristic photons are attenuated by the thicker sample.

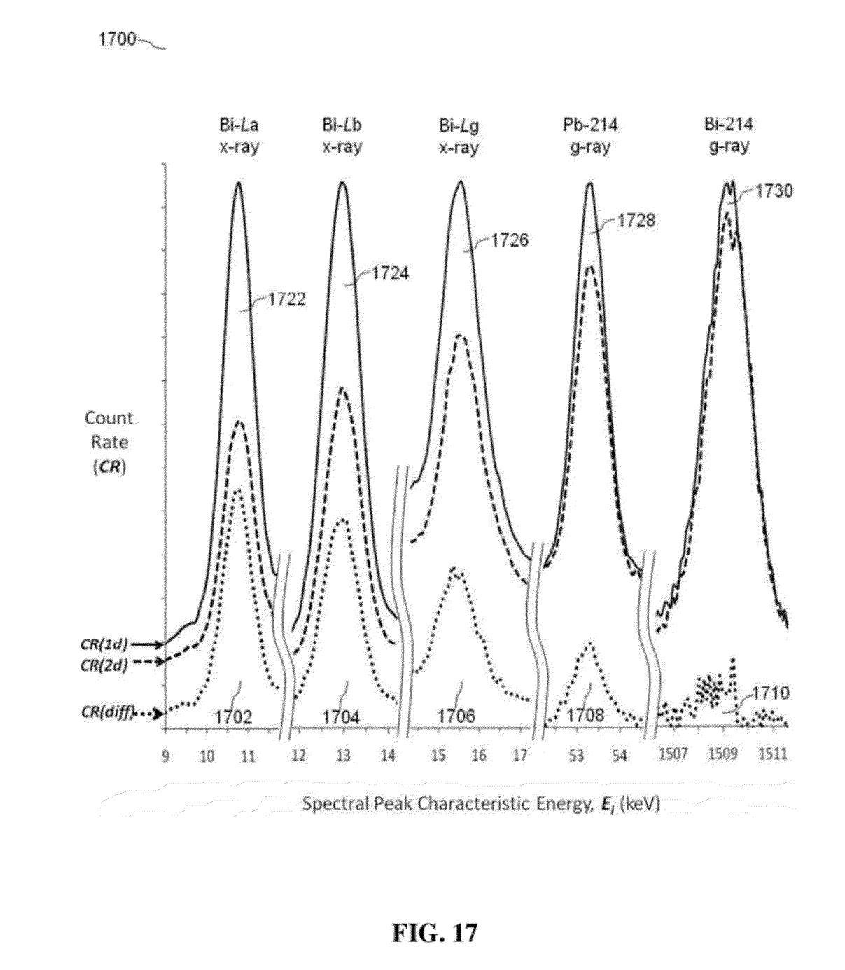

### Comparing 1d and 2d Spectral Peak Counts (FIG. 17)

To compare the thick- and thin-produced spectra, their sample counting times (t_{smpl,1d} and t_{smpl,2d}) must be normalized. Count-time normalization is usually accomplished by dividing the characteristic peak counts (C_{Ei,smpl}) by the associated sample counting time (tₛₘₚₗ) to yield a count rate (CR_{Ei,stnd}).

$$\begin{matrix}{CR}_{Ei , smpl , 1 d} = \frac{{c}_{Ei , smpl , 1 d}}{{t}_{smpl , 1 d}} & [ 33 f ] \\ {CR}_{Ei , smpl , 2 d} = \frac{{c}_{Ei , smpl , 2 d}}{{t}_{smpl , 2 d}} & [ 33 g ]\end{matrix}$$

Count rates can be compared directly. Referring now to FIG. 17, graph 1700 shows genuine experimental data from a sample (smpl) of aqueous radium-226 (“Ra-226”) that was poured into a two-thickness sample-container apparatus like that shown in FIGS. 14-16. In graph 1700, five characteristic spectral peaks are shown. The spectral peaks are primarily composed of Bi—La x-rays 1722 at 10.5 keV, Bi-Lb x-rays 1724 at 13 keV, Bi-Lg x-rays 1726 at 15.5 keV, Pb-214 g-rays 1728 at 53 keV, and Bi-214 g-rays 1730 at 1509 keV. Three characteristic spectral traces are shown in FIG. 17 (upper solid-line, middle dashed-line, and lower dotted-line). The upper solid-line spectral trace is the characteristic (Eᵢ) count rate (CR_{Ei,smpl,1d}) from the thin (1d) counting position 1660 in FIG. 16. The middle dashed-line spectral trace is the characteristic count rate (CR_{Ei,smpl,2d}) from the thick (2d) counting position 1610 in FIG. 16. At high signal emission energy, signals escape the thin and thick samples fairly easily, and the thin and thick peak count rates nearly equal each other 1730. As the peak energy decreases, the thick (2d) sample self-attenuates faster than does the thin (1d) sample. Relative to the thin spectrum count rate (CR_{Ei,smpl,1d}), the thick-spectrum count rate (CR_{Ei,smpl,2d}) shows a rapidly degenerating peak height with decreasing characteristic energy (Eᵢ) because the thicker sample self-attenuates more characteristic signals. The lower dotted-line spectral trace is the difference spectrum (diff) between the thin and thick spectral count rates for each respective characteristic signal energy, as follows.

CR_{Ei,smpl,diff}=CR_{Ei,smpl,1d}−CR_{Ei,smpl,2d} [34]

Thus, three partial spectral traces are shown: an upper thin spectrum (CR_{Ei,smpl,1d}), a middle thick spectrum (CR_{Ei,smpl,2d}), and the lower difference spectrum (CR_{Ei,smpl,diff}). FIG. 17 shows that, as the characteristic energy increases, the difference spectrum diminishes. At 10.5 keV, the difference peak 1702 is quite large; at 13 keV, the difference peak 1704 is smaller; at 15.5 keV, the difference peak 1706 is smaller still; at 53 keV, the difference peak 1708 is even smaller, and at the high characteristic energy of 1509 keV, the difference peak 1710 is smallest yet, but still observable. Although the difference peaks shown in FIG. 17 are all less than their associated thick-sample peaks, such may not always be the case and partly depends on the severity of the sample self-attenuation.

One benefit of plotting the difference spectrum is that it shows the operator which characteristic peaks require sample self-attenuation correction. If there is a noticeable difference peak, then both the thick and thin peaks should be corrected for sample self-attenuation. The difference spectrum in FIG. 17 shows that the four low-energy peaks 1702, 1704, 1706, and 1708 do require sample self-attenuation corrections, whereas loss of counts due to sample self-attenuation in the high-energy peak 1710 could probably be ignored if the peak doesn't represent the greatest component of uncertainty in the final sample results. If samples are thin, then high-energy peaks may not require sample self-attenuation correction. However, if the samples are thick, then even the highest-energy peaks may show a significant difference in the peak count rate (CR_{Ei,stnd,diff}) and should therefore be corrected for sample self-attenuation. The 1d:2d methodology is used to make possible such corrections to the thin and thick sample self-attenuations at all characteristic signal energies.

The count rates for each energy-peak pair (or n-tuple of characteristic peaks from n-tuple different sample-depths, should three or more be counted), and other related terms, are shown in the following count-rate balance equations:

CR_{Ei,smpl,1d}=Mₛₘₚₗ*SpA_{Rj,smpl}*YF_{Rj,Ei}*EscF_{Ei,smpl,1d}*DetF_{Ei,smplFr,1d} [35a]

CR_{Ei,smpl,2d}=Mₛₘₚₗ*SpA_{Rj,smpl}*YF_{Rj,Ei}*EscF_{Ei,smpl,2d}*DetF_{Ei,smplFr,2d} [35b]

If a detection-system calibration is being performed, then the sample-free detected-fraction calibration terms (DetF_{Ei,smplFr,1d} and DetF_{Ei,smplFr,2d}) are computed using a standard-sample (stnd) of known signal-emitter identity and quantity, as follows:

$$\begin{matrix}{DetF}_{Ei , smplFr , 1 d} = \frac{{CR}_{Ei , stnd , 1 d}}{{M}_{stnd} * {SpA}_{Rj , stnd} * {YF}_{Rj , Ei} * {EscF}_{Ei , stnd , 1 d}} & [ 36 a ] \\ {DetF}_{Ei , smplFr , 2 d} = \frac{{CR}_{Ei , stnd , 2 d}}{{M}_{stnd} * {SpA}_{Rj , stnd} * {YF}_{Rj , Ei} * {EscF}_{Ei , stnd , 2 d}} & [ 36 b ]\end{matrix}$$

But if the sample-free detection-system calibration has already been performed and the values are known, then the operator is interested in using the detection system to analyze homogenous unknown-samples (unkn) containing signal-emitting content, and specifically to compute the specific-activity quantities of any detectable signal emitters in the sample (e.g. gamma-rays and x-rays emitted from radioisotopes), as follows:

$$\begin{matrix}{SpA}_{Rj , unkn} = \frac{{CR}_{Ei , unkn , 1 d}}{{M}_{unkn} * {YF}_{Rj , Ei} * {EscF}_{Ei , unkn , 1 d} * {DetF}_{Ei , smplFr , 1 d}} & [ 37 a ] \\ {SpA}_{Rj , unkn} = \frac{{CR}_{Ei , unkn , 2 d}}{{M}_{unkn} * {YF}_{Rj , Ei} * {EscF}_{Ei , unkn , 2 d} * {DetF}_{Ei , smplFr , 2 d}} & [ 37 b ]\end{matrix}$$

To improve the accuracy in computing the sample-free detected-fraction calibration and the specific-activity quantities in unknown-samples, the sample-specific escaped-fraction terms EscF_{Ei,smpl,1d} and EscF_{Ei,smpl,2d} should be computed. Solving for the fraction of characteristic signals attenuated within a homogeneous sample is one of the key methodological aspects of this disclosure. The approach is to take the ratio of the spectral peaks through two or more different thicknesses of a sample and to then apply the following method. The ratio of the two count-rate balance Equations [35a] and [35b] is:

$$\frac{{CR}_{Ei , smpl , 1 d}}{{CR}_{Ei , smpl , 2 d}} = \frac{{M}_{smpl} * {SpA}_{Rj , smpl} * {YF}_{Rj , Ei} * {EscF}_{Ei , smpl , 1 d} * {DetF}_{Ei , smplFr , 1 d}}{{M}_{smpl} * {SpA}_{Rj , smpl} * {YF}_{Rj , Ei} * {EscF}_{Ei , smpl , 2 d} * {DetF}_{Ei , smplFr , 2 d}} \qquad [ 38 a ]$$

Cancelling the equal terms in Equation [38a] leaves one equation in four unknowns:

$$\frac{{CR}_{Ei , smpl , 1 d}}{{CR}_{Ei , smpl , 2 d}} = \frac{{EscF}_{Ei , smpl , 1 d} * {DetF}_{Ei , smplFr , 1 d}}{{EscF}_{Ei , smpl , 2 d} * {DetF}_{Ei , smplFr , 2 d}} \qquad [ 38 b ]$$

Although the values of the two sample-free detected-fraction calibration terms (DetF_{Ei,smplFr,1d} and DetF_{Ei,smplFr,2d}) are yet unknown, it is adduced that they are nearly equal in value for the sample positions relative to the setup of the detection-system shown in FIG. 16, as indicated by the nearly equal count rates of the high-energy thick and thin spectral peaks observed in FIG. 17, which shows, for genuine experimental data from a sample containing “Ra-226” and its daughter radioisotopes, that, as the characteristic signal energy increases, the thick and thin peak count rates approach equality (as E, increases, CR_{Ei,smpl,2d} CR_{Ei,smpl,1d}) because sample self-attenuation decreases with increasing characteristic energy. Thus, the virtual matching of high-energy peak pair count rates indicates that the two sample-free detected-fraction calibration terms must nearly result in the same value. In all cases, the calibration standard should be a low-Z material, e.g. an organic liquid, water, or weak acid, in order to minimize the role of sample self-attenuation at high energy. Thus, if at high characteristic signal energy,

as: Eᵢ→High [39a]

then: EscF_{Ei,smpl,2d}→EscF_{Ei,smpl,1d}→1 [39b]

and if: CR_{Ei,smpl,2d}→CR_{Ei,smpl,1d} [39c]

then:

$$\frac{{DetF}_{Ei , smplFr , 1 d}}{{DetF}_{Ei , smplFr , 2 d}} \to 1 \qquad [ 39 d ]$$

therefore, set:

$$\frac{{DetF}_{Ei , smplFr , 1 d}}{{DetF}_{Ei , smplFr , 2 d}} = 1 \qquad [ 39 e ]$$

so that: DetF_{Ei,smplFr,1d}=DetF_{Ei,smplFr,2d}=DetF_{Ei,smplFr} [39f]

and from Equations [36a] and [36b]:

$${DetF}_{Ei , smplFr} = \frac{{CR}_{Ei , smpl , 1 d}}{{M}_{smpl} * {SpA}_{Rj , smpl} * {Y}_{Rj , Ei} * {EscF}_{Ei , smpl , 1 d}} = \frac{{CR}_{Ei , smpl , 2 d}}{{M}_{smpl} * {SpA}_{Rj , smpl} * {Y}_{Rj , Ei} * {EscF}_{Ei , smpl , 2 d}} \qquad [ 39 g ]$$

which allows cancelling the two sample-free detected-fraction calibration terms in Equation [38b] to arrive at:

$$\frac{{CR}_{Ei , smpl , 1 d}}{{CR}_{Ei , smpl , 2 d}} = \frac{{EscF}_{Ei , smpl , 1 d}}{{EscF}_{Ei , smpl , 2 d}} \qquad [ 40 ]$$

Equation [40] is one equation with two unknowns (EscF_{Ei,smpl,1d} and EscF_{Ei,smpl,2d}), which is now being redefined using a single common term in order to solve Equation [40]. This term is the energy-dependent “linear attenuation coefficient” (μ_{Ei,smpl}), which has the same value for both thick and thin samples of the same material. Given that the thicknesses, 1d and 2d, as seen by the detector, are defined as 2d=2*1d, the two sample-specific escaped-fraction terms can be defined as shown in Equations [41a] and [41b].

$$\begin{matrix}{EscF}_{Ei , smpl , 1 d} = \frac{1}{1 d} {\int }_{0}^{1 d} ( {e}^{- μ x} ) d x = \frac{1}{μ \cdot 1 d} ( 1 - {e}^{- μ \cdot 1 d} ) & [ 41 a ] \\ {EscF}_{Ei , smpl , 2 d} = \frac{1}{2 d} {\int }_{0}^{2 d} ( {e}^{- μ x} ) d x = \frac{1}{μ \cdot 2 d} ( 1 - {e}^{- μ \cdot 2 d} ) & [ 41 b ]\end{matrix}$$

Equations [41a] and [41b] can be simplified by substituting a beam-transmitted-fraction term (BmTrnsF_{Ei,smpl,1d}) for e^{-μ·1d} and rearranging terms as shown in Equations [42a] and [42b]:

$$\begin{matrix}{EscF}_{Ei , smpl , 1 d} = \frac{{BmTrnsF}_{Ei , smpl , 1 d} - 1}{ln ( {BmTrnsF}_{Ei , smpl , 1 d} )} & [ 42 a ] \\ {EscF}_{Ei , smpl , 2 d} = \frac{{( {BmTrnsF}_{Ei , smpl , 1 d} )}^{2} - 1}{2 \cdot ln ( {BmTrnsF}_{Ei , smpl , 1 d} )} & [ 42 b ]\end{matrix}$$

Substituting Equations [42a] and [42b] into Equation [40] and rearranging terms to isolate and solve for transmission of a beam through a sample of thickness 1d, BmTrnsF_{Ei,smpl,1d}, yields:

$${BmTrnsF}_{Ei , smpl , 1 d} = 2 \cdot \frac{{CR}_{Ei , smpl , 2 d}}{{CR}_{Ei , smpl , 1 d}} - 1 \qquad [ 43 ]$$

The sample-specific escaped-fraction terms (EscF_{Ei,smpl,1d} and EscF_{Ei,smpl,2d}) are now solved using Equations [42a] and [42b].

Although not required to be known to quantify the signal emitters of interest, there may nonetheless be an interest to know the sample energy-specific linear attenuation (μ_{Ei,smpl}).

$${μ}_{Ei , smpl} = \frac{- ln ( {BmTrnsF}_{Ei , smpl , 1 d} )}{1 d} \qquad [ 44 ]$$

If the sample were a standard-sample (stnd) of known signal emitter identities (Rⱼ) and specific-activity quantities (SpA_{Rj,stnd}), then Equation [39g] can be used to compute the sample-free detected-fraction calibration term (DetF_{Ei,smplFr}).

But if the sample were an unknown-sample (unkn), and the sample-free detected-fraction calibration had already been successfully performed, then the specific-activity quantities (SpA_{R j,unkn}) would be computed using either or both of Equations [37a] and [37b].

One of the key methodological aspects of the 1d:2d sample analysis is being able to compute the fraction of the characteristic signals that are attenuated within any homogeneous sample using sample-container apparatuses, like those illustrated in FIGS. 14-16, which ‘shape’ the sample into two or more different thicknesses, with respect to the detector direction.

### Analyzing Unknowns

One embodiment of the 1d:2d methodology for analyzing a homogenous sample containing unknown signal emitters (hereinafter referred to as an “unknown-sample”) is comprised of three major parts. The first part is to acquire ambient background emission spectra—one ambient background emission spectrum for each position and orientation where the sample-container apparatus is placed in relation to the detector. The second part is to perform a sample-specific detected-fraction calibration (DetF_{Ei,smpl}) of the signal-detection system. The third part is to analyze such unknown-samples to identify and quantify their signal-emitting sources. In addition to these three main steps are other supporting steps, e.g. escape-peak corrections and peak summing-in and summing-out corrections, among others.

Part 1. “1d:2d” Ambient Background Counting (FIG. 18)

Sample counting produces a gross characteristic spectrum that usually contains signals from sources external to the sample as a component. Consequently, ambient background counting is performed to compute the signal count rate of the characteristic ambient background signal, so that it can be normalized to, and then subtracted out of, the gross characteristic sample spectrum, which then leaves only a net characteristic spectrum attributable to the signal emitters in the sample. FIG. 18 shows a background counting-system setup 1800 that is used to obtain the ambient background emission spectrum. Ambient background signals can come from the sample-container apparatus materials, detection system materials; cosmic rays; the natural radioactive decay series in the ground beneath the detector and in the air as radioactive radon and its ‘daughters’; and possibly other non-sample sources.

In the system embodiment shown 1800, two ambient background counting positions 1810 and 1860 are shown. For this discussion, the empty 1d:2d sample-container apparatus 1812 is first counted in the thick (2d) position 1810. Then the empty 1d:2d sample-container apparatus 1812 is flipped 180-degrees 1818 to the thin (1d) position 1860 for the second ambient background counting. The size, shape, position, and orientation of the empty 1d:2d sample-container apparatus, with respect to the detector, should be the same as those planned for sample-container apparatuses holding standard-samples that are used to calibrate the counting system, as well as for sample-container apparatuses holding unknown-samples that are to be measured and analyzed by the counting system. Because ambient background count rates are usually low, the times allotted for ambient background countings (t_{bkgd,1d} and t_{bkgd,2d}) are usually quite lengthy. These background non-sample counts should be removed from future sample spectra.

It can be argued that only one ambient background counting of the detection system and empty sample-container apparatus is necessary, i.e. changing the orientation of the sample-container apparatus has a negligible effect. If the ambient background countings of each of the sample-container apparatus orientations does not significantly differ, then the operator may decide that future ambient background countings need only be made using a single sample-container apparatus orientation. Subsystem 1630 detects characteristic signals, processes them, preserves them, and presents them as ambient background emission spectra 1816 and 1866. To ensure that ambient background signal emission environment is not significantly changing, ambient characteristic background spectra are taken periodically, perhaps once every week or month, depending on many circumstances usually judged by the experience of the operator or by established protocol.

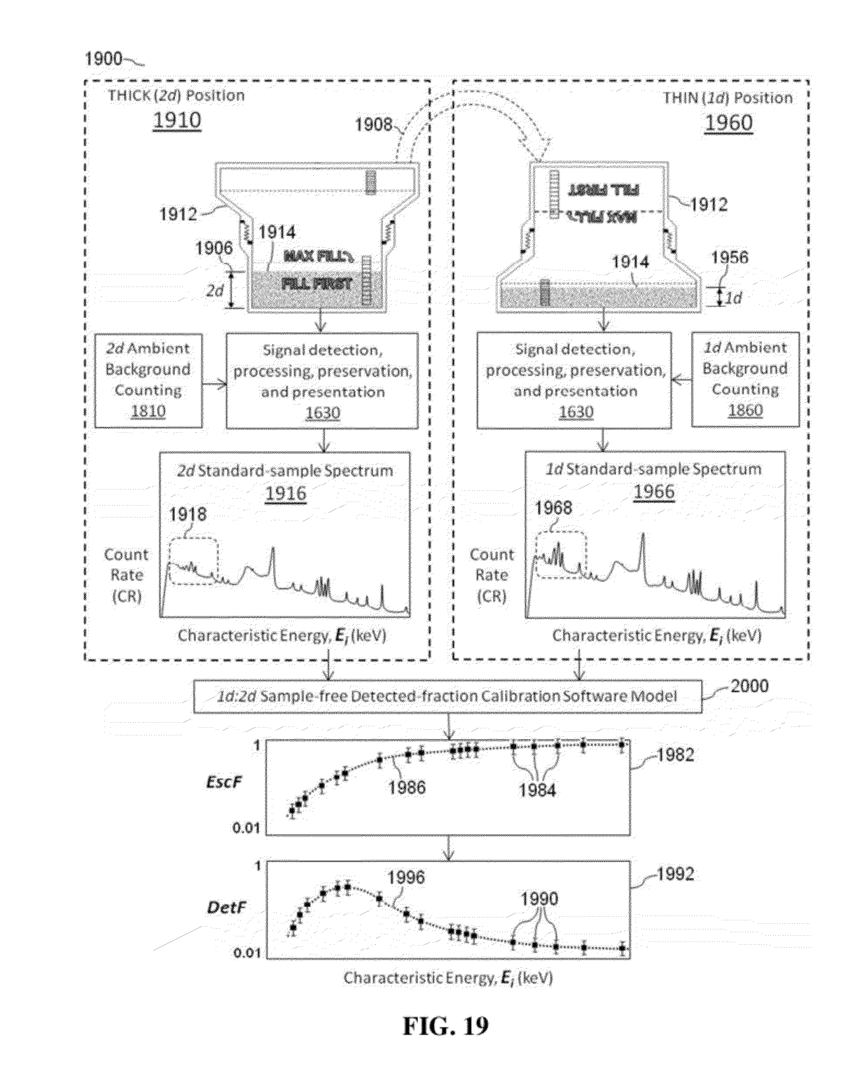

Part 2. “1d:2d” Signal Detection-Efficiency Calibration (FIG. 19)

Before signal-detection systems are used to quantify signal emitters in unknown-samples, they usually first require a signal detection-efficiency calibration of some kind. FIG. 19 illustrates one such system 1900 for calibrating signal detection-efficiency. The signal detection-efficiency calibration requires counting a compositionally well known standard-sample (stnd) in both the thick (2d) 1910 and thin (1d) 1960 counting positions, where the standard-sample is placed in the same type of sample-container apparatus as was used to calculate the ambient background emission spectra 1816 and 1866 (in FIG. 18), and in the same position and orientation relative to the detector.

A standard-sample mass (M_{stnd}), may be computed by Equation [45], where the mass of an empty sample-container apparatus (M_{cntr}) is subtracted from the combined mass of the sample-container apparatus and the standard-sample (M_{cntr+stnd}):

M_{stnd}=M_{cntr+stnd}−M_{cntr} [45]

It is presumed for this particular discussion that the standard-sample 1914 is first placed into the 2d 1906 cup of the cylindrical 1d:2d sample-container apparatus 1912. (Note: in the alternative, the operator could have just as easily placed the standard-sample into the 1d 1956 cup instead and proceeded accordingly.) Then the sample-container apparatus is sealed securely and placed into the thick (2d) position 1910 for counting, and counting then commences. Characteristic signals that escape the thick (2d) standard-sample 1914 and that register, along with the ambient background signals, in the signal detection, processing, preservation, and presentation subsystem 1630, produce a “thick” gross composite spectrum (not shown).

Once the “thick” gross composite spectrum is obtained, then the sample-container apparatus 1912 is flipped 180-degrees 1908 into the thin sample-container apparatus position 1960 which ‘shapes’ the sample 1914 into a wider-diameter cylinder of thinner depth (1d) 1956. Characteristic signals that escape the thin (1d) standard-sample 1914, and that register, along with the ambient background signals, in subsystem 1630, produce a “thin” gross composite spectrum (not shown).

To subtract-out the ambient background emission spectra 1810 and 1860 from their corresponding “thick” and “thin” gross composite spectra (not shown), it is convenient to first normalize the counting times of the ambient background emission spectra (t_{bkgd,1d} and t_{bkgd,2d}) to the counting times of their corresponding “thick” and “thin” gross standard-sample spectra (t_{stnd,1d} and t_{stnd,2d}). Count-time normalization is usually accomplished by dividing the characteristic peak counts by the counting times to yield a count rate. Count rates are normalized as counts/unit-time, so that they can be compared directly. The characteristic thick (2d) position and thin (1d) position ambient background counts (BC_{Ei,1d} and BC_{Ei,2d}) are normalized to their respective ambient background count rates (BCR_{Ei,1d} and BCR_{Ei,2d}), as follows:

$$\begin{matrix}{BCR}_{Ei , 1 d} = \frac{{BC}_{Ei , 1 d}}{{t}_{bkgd , 1 d}} & [ 46 a ] \\ {BCR}_{Ei , 2 d} = \frac{{BC}_{Ei , 2 d}}{{t}_{bkgd , 2 d}} & [ 46 b ]\end{matrix}$$

The characteristic thick (2d) position and thin (1d) position gross standard-sample counts (GC_{Ei,stnd,1d} and GC_{Ei,stnd,2d}) are normalized to their respective gross standard-sample count rates (GCR_{Ei,stnd,1d} and GCR_{Ei,stnd,2d}), as follows:

$$\begin{matrix}{GCR}_{Ei , stnd , 1 d} = \frac{{GC}_{Ei , stnd , 1 d}}{{t}_{stnd , 1 d}} & [ 47 a ] \\ {GCR}_{Ei , stnd , 2 d} = \frac{{GC}_{Ei , stnd , d}}{{t}_{stnd , 2 d}} & [ 47 b ]\end{matrix}$$

The ambient background signal count rates 1810 and 1860 are subtracted out from their corresponding standard-sample gross spectra (not shown) leaving the corresponding net standard-sample spectra 1916 and 1966. This can be summarized, as follows:

CR_{Ei,stnd,1d}=GCR_{Ei,stnd,1d}−BCR_{Ei,1d} [48a]

CR_{Ei,stnd,2d}=GCR_{Ei,stnd,2d}−BCR_{Ei,2d} [48b]

By comparing the net 1d and 2d standard-sample spectra 1916 and 1966 in FIG. 19, one notices a significant difference between the peak heights at the low-energy portion of the thick (2d) and thin (1d) spectra 1918 and 1968. The highly attenuated peaks of the thick (2d) standard-sample counting 1910 are anticipated because, at low energy, more of the characteristic signals are attenuated within the thick “shape” of the standard-sample, relative to the thin “shape” of the standard-sample.

FIG. 17 shows a graph 1700 of genuine experimental data in which a “Ra-226” standard sample was placed into a 1d:2d two-thickness sample-container apparatus and counted in two positions 1916 and 1966 in the manner of FIG. 19. FIG. 17 shows that, at low-energy, the characteristic signal attenuates faster in the thick (2d) standard-sample position [represented by the dashed line, ‘CR(2d)’] than in the thin (1d) standard-sample position [represented by the solid line, ‘CR(1d)’].

FIG. 19 shows the 1d:2d Sample-free Detected-fraction Calibration Software Model 2000 that reads input of the thick and thin spectral peak data and computes, for each useful thick and thin characteristic spectral-peak pair, the discrete characteristic sample-specific escaped-fraction values (EscF_{Ei,stnd,1d} and EscF_{Ei,stnd,2d}) and then computes the corresponding discrete characteristic sample-free detected-fraction calibration values (DetF_{Ei,smplFr}) 1990. Only one set of values for the discrete sample-specific escaped-fraction values is illustrated in FIG. 19, because, by looking at Equation [39g], which is rewritten here for convenience as Equation [48c], it is seen that, although both expressions compute the sample-free detected-fraction calibration term (DetF_{Ei,smplFr}), only one is needed, and the logical choice is the expression that leads to better statistics for DetF_{Ei,smplFr}.

$${DetF}_{Ei , smplFr} = \frac{{CR}_{Ei , stnd , 1 d}}{{M}_{stnd} * {SpA}_{Rj , stnd} * {Y}_{Rj , Ei} * {EscF}_{Ei , stnd , 1 d}} = \frac{{CR}_{Ei , stnd , 2 d}}{{M}_{stnd} * {SpA}_{Rj , stnd} * {Y}_{Rj , Ei} * {EscF}_{Ei , stnd , 2 d}} \qquad [ 48 c ]$$

All of the discrete sample-specific escaped-fraction values 1984, taken together, resemble the outline of a curve that spans the energy range of interest (represented by the dotted line 1986). Commonly, a function is fitted to these discrete values 1984 to cover the entire usable energy-detection range of the detection system. The discrete values 1984 and all of the possible fitted values 1986 of the sample-specific escaped fraction are illustrated together 1982.

All of the discrete, computed sample-free detected-fraction calibration values (DetF_{Ei,smplFr}) 1990, taken together, resemble the outline of a curve that spans the energy range of interest (represented by the dotted line 1996). Commonly one or more functions are fitted to these discrete values 1990 to cover the entire usable energy-detection range of the detection system. The discrete values 1990 and all of the possible fitted values 1996 of the sample-free detected-fraction calibration are illustrated together 1992.

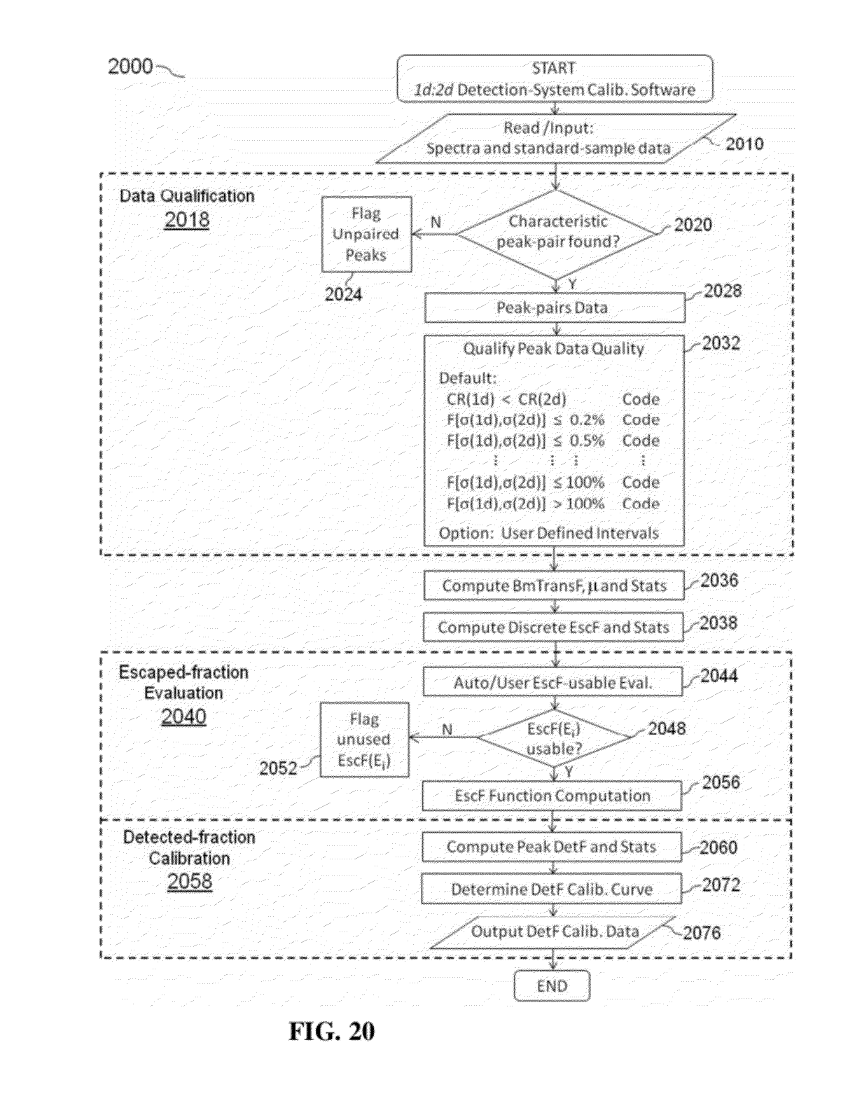

### 1d:2d Sample-Free Detection-System Calibration Software Model (FIG. 20)

FIG. 20 depicts a flowchart of the 1d:2d Sample-free Detected-fraction Calibration Software Model (hereinafter, the “1d:2d Calib. S/W Model”) 2000, which reads as input 2010 (a) the primary 1d and 2d spectral data, which includes the 1d and 2d characteristic-peak net count rates (CR_{Ei,stnd,1d} and CR_{Ei,stnd,2d}); and (b) the primary standard-sample data, which includes the signal-emitting identities, e.g. radioisotopes (Rⱼ), their specific-activity quantities (SpA_{Rj,stnd}), and sample volume (Vol_{stnd}) or sample mass (M_{stnd}); and (c) the signal-emitter signal yield-fraction data (YF_{Rj,Ei}).

The Data Qualification Software Module 2018 in FIG. 20 identifies those characteristic 1d and 2d peak pairs useful for computing associated values of sample-specific beam-transmitted-fraction values (BmTrnsF_{Ei,stnd,1d} and BmTrnsF_{Ei,stnd,2d}) and associated standard-sample linear attenuation coefficient (μ_{Ei,stnd}) values. The Data Qualification Software Module 2018 is comprised of the following software ‘submodules’ 2020, 2024, 2028, and 2032.

A software module 2020 checks for un-paired thick (2d) and thin (1d) characteristic spectral peaks. Those peaks not having a characteristic peak pair are ‘flagged’ 2024 for an optional review by an operator. Another software module 2028 pairs the thick (2d) and thin (1d) characteristic peaks.

Another software module 2032 qualifies the data quality for each characteristic peak pair by (i) identifying those peak pairs in which the thin (1d) sample peak count rate is less than the thick (2d) sample count rate (CR_{Ei,stnd,1d}<CR_{Ei,stnd,2d}); and applying a default or user-defined statistical interval; and (ii) identifying such peak pairs that have combined statistics, f(σ_{Ei,stnd,1d},σ_{Ei,stnd,2d}), within the default or user-defined statistical interval, and then applying a default or user-defined quality code (“Code” in FIG. 20) to such peak pairs.

For each characteristic peak pair, software module 2036 then computes the sample-specific beam-transmitted-fraction (BmTrnsF_{Ei,stnd,1d}) and the sample-specific linear attenuation coefficient (μ_{Ei,stnd}). The count rates for each characteristic-peak pair (or n-tuple of characteristic peaks from n-tuple different sample-depths, should three or more such depths be counted), and other related terms, are shown in the count-rate balance Equations [49a] and [49b].

CR_{Ei,stnd,1d}=M_{stnd}*SpA_{Rj,stnd}*YF_{Rj,Ei}*EscF_{Ei,stnd,1d}*DetF_{Ei,smplFr,1d} [49a]

CR_{Ei,stnd,2d}=M_{stnd}*SpA_{Rj,stnd}*YF_{Rj,Ei}*EscF_{Ei,stnd,2d}*DetF_{Ei,smplFr,2d} [49b]

Equations [49a] and [49b] are two equations in four unknowns. The four unknowns are the two sample-specific escaped-fraction terms (EscF_{Ei,stnd,1d} and EscF_{Ei,stnd,2d}) and the two sample-free detected-fraction calibration terms (DetF_{Ei,smplFr,1d} and DetF_{Ei,smplFr,2d}). The known terms are the measured 1d and 2d count rates (CR_{Ei,stnd,1d} and CR_{Ei,stnd,2d}); the measured standard-sample mass (M_{stnd}); the reported signal emitters (Rⱼ) and their specific-activity quantities (SpA_{Rj,stnd}); and the widely published signal emitter characteristic (Eᵢ) emission yield fractions (YF_{Rj,Ei}).

To reduce the number of unknowns, the approach is to take the ratio of the 1d and 2d spectral peaks and their count-rate balance Equations [49b] and [49b], as follows:

$$\frac{{CR}_{Ei , stnd , 1 d}}{{CR}_{Ei , stnd , 2 d}} = \frac{{M}_{stnd} * {SpA}_{Rj , stnd} * {YF}_{Rj , Ei} * {EscF}_{Ei , stnd , 1 d} * {DetF}_{Ei , smplFr , 1 d}}{{M}_{stnd} * {SpA}_{Rj , stnd} * {YF}_{Rj , Ei} * {EscF}_{Ei , stnd , 2 d} * {DetF}_{Ei , smplFr , 2 d}} \qquad [ 50 a ]$$

Cancelling the equal terms in Equation [50a] leaves one equation in four unknowns:

$$\frac{{CR}_{Ei , stnd , 1 d}}{{CR}_{Ei , stnd , 2 d}} = \frac{{EscF}_{Ei , stnd , 1 d} * {DetF}_{Ei , smplFr , 1 d}}{{EscF}_{Ei , stnd , 2 d} * {DetF}_{Ei , smplFr , 2 d}} \qquad [ 50 b ]$$

Although the values of the two sample-free detected-fraction calibration terms (DetF_{Ei,smplFr,1d} and DetF_{Ei,smplFr,2d}) are yet unknown, it is adduced that they are nearly equal in value for the standard-sample positions relative to the setup of the detection-system shown in FIG. 19 for the reasons described in the discussion of FIG. 17 and Equations [38a] to [40]. Thus, if at high characteristic signal energy,

as: Eᵢ→High [51a]

then: EscF_{Ei,stnd,2d}→EscF_{Ei,stnd,1d}→1 [51b]

and if: CR_{Ei,smpl,2d}→CR_{Ei,smpl,1d} [51c]

then:

$$\frac{{DetF}_{Ei , smplFr , 1 d}}{{DetF}_{Ei , smplFr , 2 d}} -> 1 \qquad [ 51 d ]$$

therefore, set:

$$\frac{{DetF}_{Ei , smplFr , 1 d}}{{DetF}_{Ei , smplFr , 2 d}} = 1 \qquad [ 51 e ]$$

so that: DetF_{Ei,smplFr,1d}=DetF_{Ei,smplFr,2d}=DetF_{Ei,smplFr} [51f]

and from Equations [49a] and [49b]:

$${DetF}_{Ei , smplFr} = \frac{{CR}_{Ei , stnd , 1 d}}{{M}_{stnd} * {SpA}_{Rj , stnd} * {Y}_{Rj , Ei} * {EscF}_{Ei , stnd , 1 d}} = \frac{{CR}_{Ei , stnd , 2 d}}{{M}_{stnd} * {SpA}_{Rj , stnd} * {Y}_{Rj , Ei} * {EscF}_{Ei , stnd , 2 d}} \qquad [ 51 g ]$$

which allows cancelling the two sample-free detected-fraction calibration terms in Equation [50b] to arrive at:

$$\frac{{CR}_{Ei , stnd , 1 d}}{{CR}_{Ei , stnd , 2 d}} = \frac{{EscF}_{Ei , stnd , 1 d}}{{EscF}_{Ei , stnd , 2 d}} \qquad [ 52 ]$$

Equation [52] is one equation with two unknowns (EscF_{Ei,stnd,1d} and EscF_{Ei,stnd,2d}), which is now being redefined using a single common term in order to solve Equation [52]. This term is the energy-dependent “linear attenuation coefficient” (μ_{Ei,stnd}), which has the same value for both thick and thin standard-samples of the same material. Given that the thicknesses, 1d and 2d, as seen by the detector, are defined as 2d=2*1d, the two sample-specific escaped-fraction terms can be defined as shown in Equations [53a] and [53b]:

$$\begin{matrix}{EscF}_{Ei , stnd , 1 d} = \frac{1}{d} {\int }_{0}^{1 d} ( {e}^{- μ x} ) d x = \frac{1}{μ \cdot 1 d} ( 1 - {e}^{- μ \cdot 1 d} ) & [ 53 a ] \\ {EscF}_{Ei , stnd , 2 d} = \frac{1}{2 d} {\int }_{0}^{2 d} ( {e}^{- μ x} ) d x = \frac{1}{μ \cdot 2 d} ( 1 - {e}^{- μ \cdot 2 d} ) & [ 53 b ]\end{matrix}$$

Equations [53a] and [53b] can be simplified by substituting a beam-transmitted-fraction term (BmTrnsF_{Ei,stnd,1d}) for e^{-μ·1d} and rearranging terms as shown in Equations [54a] and [54b]:

$$\begin{matrix}{EscF}_{Ei , stnd , 1 d} = \frac{{BmTrnsF}_{Ei , stnd , 1 d} - 1}{ln ( {BmTrnsF}_{Ei , stnd , 1 d} )} & [ 54 a ] \\ {EscF}_{Ei , stnd , 2 d} = \frac{{( {BmTrnsF}_{Ei , stnd , 1 d} )}^{2} - 1}{2 \cdot ln ( {BmTrnsF}_{Ei , stnd , 1 d} )} & [ 54 b ]\end{matrix}$$

Substituting Equations [54a] and [54b] into Equation [52] and rearranging terms to isolate and solve for transmission of a beam through the sample of thickness 1d, BmTrnsF_{Ei,stnd,1d}, yields:

$${BmTrnsF}_{Ei , stnd , 1 d} = 2 * \frac{{CR}_{Ei , stnd , 2 d}}{{CR}_{Ei , stnd , 1 d}} - 1 \qquad [ 55 ]$$

Although not required to be known to quantify the signal emitters of interest, there may nonetheless be an interest to know the standard-sample energy-specific linear attenuation coefficient (μ_{Ei,stnd}).

$${μ}_{Ei , stnd} = \frac{- ln ( {BmTrnsF}_{Ei , stnd , 1 d} )}{1 d} \qquad [ 56 ]$$

The mathematical laws of error analysis are computed as appropriate alongside the mathematical operations on the values of the terms comprising the count-rate balance Equations [49a] and [49b]. Thus, the terms will have the form v±Δv, where v represents the numerical value of a particular term in Equations [49a] and [49b], and +Δv is the uncertainty in v.

Another software module 2038 in the 1d:2d Calib. S/W Model computes each pair of sample-specific escaped-fraction terms (EscF_{Ei,stnd,1d} and EscF_{Ei,stnd,2d}) using Equations [54a] and [54b] and computes their associated uncertainties.

The Escaped-fraction Evaluation Software Module 2040 in FIG. 20 computes the fitted, sample-specific escaped-fraction functions [EscF(Eᵢ)_{stnd,1d}] and [(EscF(Eᵢ)_{stnd,2d}]. The Escaped-fraction Evaluation Software Module 2040 includes four software “submodules” 2044, 2048, 2052, and 2056.

Software module 2044 auto-deselects sample-specific escaped-fraction values and uncertainties that are “out of bounds” i.e. do not support the normal shape for a curve of signal-escape-versus-increasing-characteristic energy, which should asymptotically approach unity as signal energy increases, as illustrated by the dotted curve 1986 in FIG. 19. Software module 2044 optionally allows the operator to manually deselect individual abnormal sample-specific escaped-fraction values. Software module 2048 checks each sample-specific escaped-fraction value for “deselection”, and passes “deselected” values to be flagged as “unused” 2052 for an optional review by an operator. One default flag for sample-specific escaped-fraction values and their uncertainties is “usable”, and those not “deselected” remain “usable” and are passed to software module 2056 for computing the sample-specific escaped-fraction functions or interpolated curves for each standard-sample thickness counted.

The Detected-fraction Calibration Software Module 2058 includes three software “submodules” 2060, 2072, and 2076. Software module 2060 computes the sample-free detected-fraction calibration values (DetF_{Ei,smplFr}) using both expressions of Equation [51g], computes the associated uncertainties, and indicates which expression contained in Equation [51g] provides the better statistics. Software module 2072 computes a sample-free detected-fraction calibration function [DetF(Eᵢ)_{smplFr}] or interpolated curve. Software module 2076 aggregates all of the data acquired from each of the other software modules into user-selected or default formats, e.g. comma-separated-value (CSV) list, spreadsheet, computer screen, or other suitable output format.

Once signal-detection efficiency is calibrated, the detection system is ready to identify signal emitters, and then compute their quantities present in unknown-samples.

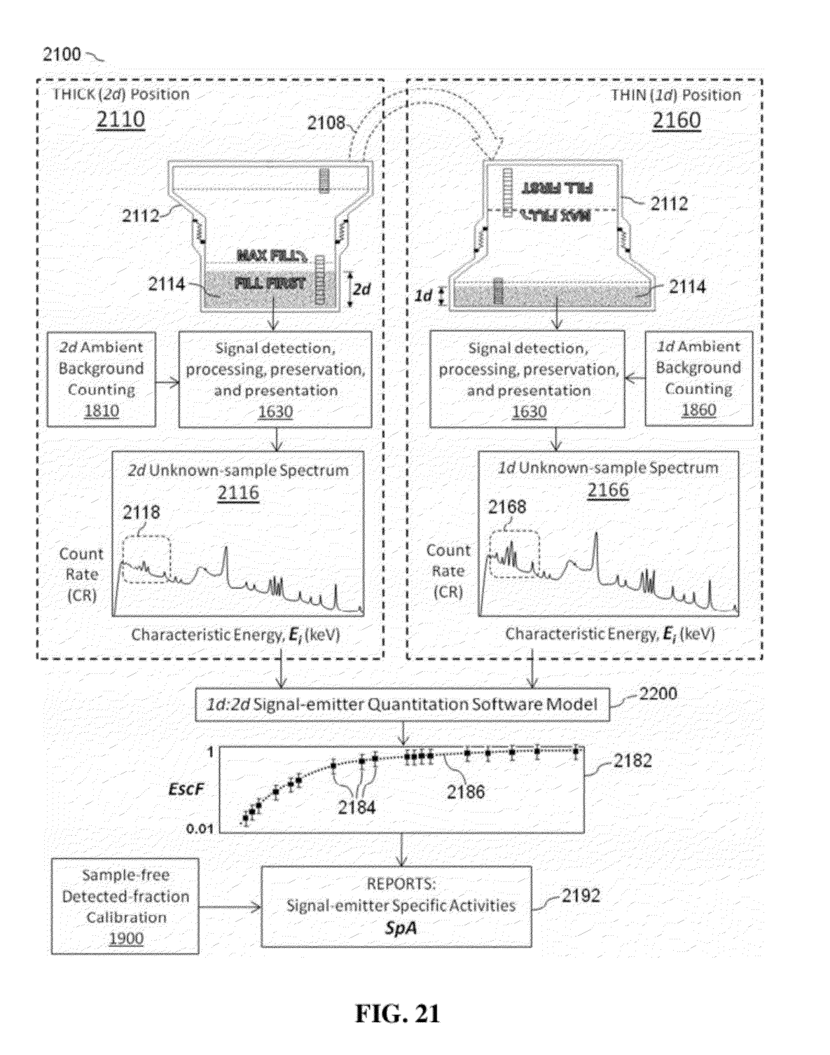

### Part 3. 1d:2d Signal-Emitter Quantitation (FIG. 21)

To quantify individual signal emitters in unknown-samples (unkn) of various composition, the fraction of characteristic (Eᵢ) signals that escape the unknown-sample is computed (EscF_{Ei,unkn}), and when combined with the sample-free detected-fraction calibration (DetF_{Ei,smplFr}), then allows computation of signal emitter (Rⱼ) specific-activity quantities (SpA_{Rj,unkn}). FIG. 21 illustrates one such system 2100 for analyzing homogeneous samples of unknown signal-emitter specific-activity quantities (SpA_{Rj,unkn}).

It is presumed that the sample-free detected-fraction calibration (DetF_{Ei,smplFr}) has been performed, and thence the unknown-sample is placed in the same type of sample-container apparatus, and in the same position and orientation relative to the detection system as were the sample-container apparatuses that were used to acquire the ambient background emission spectra 1816 and 1866 (in FIG. 18) and the standard-sample emission spectra 1916 and 1966 (in FIG. 19).

An unknown-sample mass (Mᵤₙₖₙ), may be computed by Equation [57], where the mass of an empty sample-container apparatus (M_{cntr}) is subtracted from the combined mass of the sample-container apparatus and the unknown-sample (M_{cntr+unkn}):

Mᵤₙₖₙ=M_{cntr+unkn}−M_{cntr} [57]

It is presumed for this particular discussion that the unknown-sample 2114 is first placed into the 2d cup of the cylindrical 1d:2d sample-container apparatus 2112. (Note: in the alternative, the operator could have placed the unknown-sample into the 1d cup instead and proceeded accordingly.) Then the sample-container apparatus is sealed securely and placed into the thick (2d) position 2110 for counting, and counting then commences. Characteristic signals that escape the thick (2d) unknown-sample 2114 and that register, along with the ambient background signals, in the signal detection, processing, preservation, and presentation subsystem 1630, produce a “thick” gross composite spectrum (not shown).

Once the “thick” gross composite spectrum is obtained, then the sample-container apparatus 2112 is flipped 180-degrees 2108 into the thin (1d) position 2160 which ‘shapes’ the sample 2114 into a wider-diameter cylinder of thinner depth (1d). Characteristic signals that escape the thin (1d) unknown-sample 2114, and that register, along with the ambient background signals, in subsystem 1630, produce a “thin” gross composite spectrum (not shown).

To subtract-out the ambient background emission spectra 1810 and 1860 (in FIG. 18) from their corresponding “thick” and “thin” gross composite spectra (not shown), it is convenient to first normalize the counting times of the ambient background emission spectra (t_{bkgd,1d} and t_{bkgd,2d}) to the counting times of their corresponding “thick” and “thin” gross unknown-sample spectra (t_{unkn,1d} and t_{unkn,2d}). Count-time normalization is usually accomplished by dividing the characteristic peak counts by the counting times to yield a count rate. Count rates are normalized as counts/unit-time, so that they can be compared directly. The characteristic thick (2d) position and thin (1d) position ambient background counts (BC_{Ei,1d} and BC_{Ei,2d}) are normalized to their respective ambient background count rates (BCR_{Ei,1d} and BCR_{Ei,2d}), as follows:

$$\begin{matrix}{BCR}_{Ei , 1 d} = \frac{{BC}_{Ei , 1 d}}{{t}_{bkgd , 1 d}} & [ 58 a ] \\ {BCR}_{Ei , 2 d} = \frac{{BC}_{Ei , 2 d}}{{t}_{bkgd , 2 d}} & [ 58 b ]\end{matrix}$$

The characteristic thick (2d) position and thin (1d) position gross unknown-sample counts (GC_{Ei,unkn,1d} and GC_{Ei,unkn,2d}) are normalized to their respective gross unknown-sample count rates (GCR_{Ei,unkn,1d} and GCR_{Ei,unkn,2d}), as follows:

$$\begin{matrix}{GCR}_{Ei , unkn , 1 d} = \frac{{GC}_{Ei , unkn , 1 d}}{{t}_{unkn , 1 d}} & [ 59 a ] \\ {GCR}_{Ei , unkn , 2 d} = \frac{{GC}_{Ei , unkn , 2 d}}{{t}_{unkn , 2 d}} & [ 59 b ]\end{matrix}$$

Count rates can be compared directly. The ambient background signal count rates 1810 and 1860 are subtracted out from their corresponding “thick” and “thin” unknown-sample gross spectra (not shown) leaving the corresponding net unknown-sample spectra 2116 and 2166. This can be summarized, as follows:

CR_{Ei,unkn,1d}=GCR_{Ei,unkn,1d}−BCR_{Ei,1d} [60a]

CR_{Ei,unkn,2d}=GCR_{Ei,unkn,2d}−BCR_{Ei,2d} [60b]

By comparing the net 1d and 2d unknown-sample spectra 2116 and 2166 in FIG. 21, one notices a significant difference between the peak heights at the low-energy portion of the thick (2d) and thin (1d) spectra 2118 and 2168. The highly attenuated peaks of the thick (2d) unknown-sample counting 2110 are anticipated because, at low energy, more of the characteristic signals are attenuated within the thick “shape” of the unknown-sample, relative to the thin “shape” of the unknown-sample.

FIG. 21 shows the 1d:2d Signal Emitter Quantitation Software Model 2200 that reads input of the thick and thin spectral peak data and computes, for each useful thick and thin characteristic spectral-peak pair, the discrete characteristic sample-specific escaped-fraction values (EscF_{Ei,unkn,1d and} EscF_{Ei,unkn,2d}, but only one set of discrete values is shown 2184); interpolated or fitted sample-specific escaped-fraction functions [EscF(Eᵢ)_{unkn,1d} and EscF(Eᵢ)_{unkn,2d}, but only one is shown as the dotted-line 2186]; and signal-emitter identities (Rⱼ) and corresponding specific-activity quantities (SpA_{Rj,unkn}) 2192.

All of the discrete sample-specific escaped-fraction values 2184, taken together, resemble the outline of a curve that spans the energy range of interest (represented by the dotted line 2186). Commonly, a function is fitted to these discrete values 2184 to cover the entire usable energy-detection range of the detection system. The discrete values 2184 and all of the possible fitted values 2186 of the sample-specific escaped fraction are illustrated together 2182.

The specific-activity quantities (SpAₙᵤₙₖₙ) within the unknown-sample 2114 are computed from either Equations [61a] or [61b], whichever provides better statistics to the values of the specific-activity quantities, where the subsystem 1900 (in FIG. 19) computes the fitted sample-free detected-fraction calibration function [DetF(Eᵢ)_{smplFr}].

$$\begin{matrix}{SpA}_{Rj , unkn} = \frac{{CR}_{Ei , unkn , 1 d}}{{M}_{unkn} * {YF}_{Rj , Ei} * {EscF ( {E}_{i} )}_{unkn , 1 d} * {DetF ( {E}_{i} )}_{smplFr}} & [ 61 a ] \\ {SpA}_{Rj , unkn} = \frac{{CR}_{Ei , unkn , 2 d}}{{M}_{unkn} * {YF}_{Rj , Ei} * {EscF ( {E}_{i} )}_{unkn , 2 d} * {DetF ( {E}_{i} )}_{smplFr}} & [ 61 b ]\end{matrix}$$

Subsystem 2192 aggregates all of the processed data into user-selected or default formats, e.g. comma-separated-value (CSV) list, spreadsheet, computer screen, or other suitable output format.

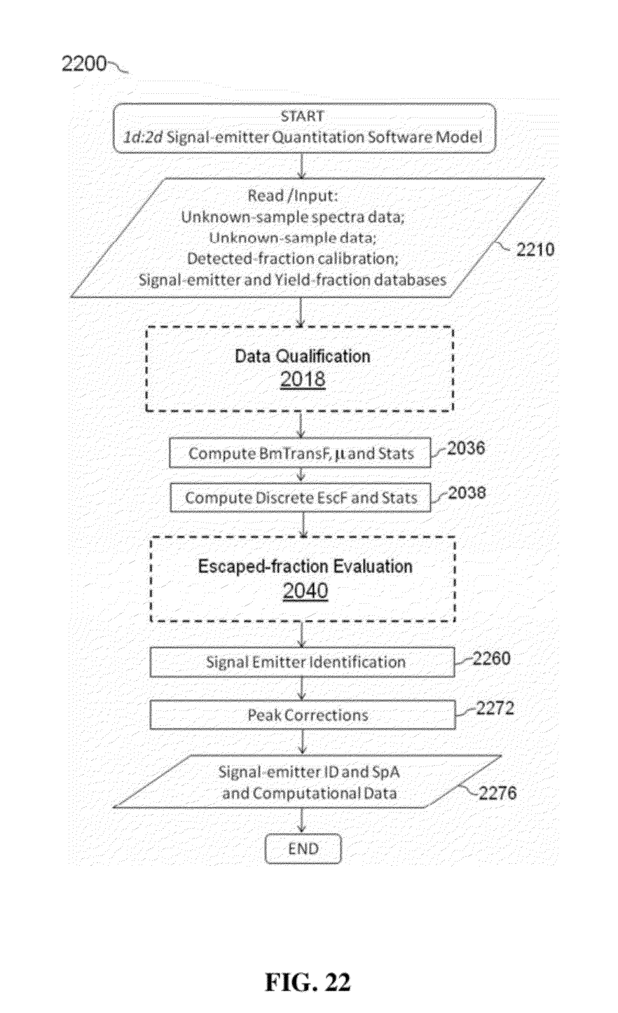

### 1d:2d Software Model for Signal-Emitter Quantitation (FIG. 22)

FIG. 22 depicts a flowchart of the 1d:2d Signal Emitter Quantitation Software Model (hereinafter, the “1d:2d Quantitation. S/W Model”) 2200, which reads as input 2210 (a) the primary unknown-sample 1d and 2d spectral data, which includes the 1d and 2d characteristic-peak net count rates (CR_{Ei,unkn,1d} and CR_{Ei,unkn,2d}); (b) unknown-sample data, e.g. the unknown-sample mass (Mᵤₙₖₙ); (c) the interpolated or fitted sample-free detected-fraction calibration function [DetF(Eᵢ)_{smplFr}]; and (d) signal-emitter (Rⱼ) and yield-fraction (YF_{Rj,Ei}) databases.

The Data Qualification Software Module 2018 (1) checks for un-paired thick and thin characteristic spectral peaks; (2) ‘flags’ those peaks not having a characteristic peak pair, for optional review by an operator; (3) pairs the thick and thin characteristic peaks; (4) qualifies the data into particular statistical intervals, and, for each characteristic peak pair, (5) identifies those pairs in which the thin unknown-sample peak count rate is less than the thick unknown-sample peak count rate (CR_{Ei,unkn,1d}<CR_{Ei,unkn,2d}), (6) applies a default or user-defined quality code (“Code”); and (7) identifies those peak pairs that have a combined statistics f(σ_{Ei,unkn,1d},σ_{Ei,unkn,2d}) within a default or user-defined statistical range. Software module 2018 is detailed in FIG. 20 and its surrounding text.

The Data Qualification Software Module 2018 (in FIG. 20) identifies those characteristic 1d and 2d peak pairs useful for computing associated values of sample-specific beam-transmitted-fraction values (BmTrnsF_{Ei,unkn,1d} and BmTrnsF_{Ei,unkn,2d}) and associated unknown-sample linear attenuation coefficient (μ_{Ei,unkn}) values.

For each characteristic peak pair, software module 2036 then computes the sample-specific beam-transmitted-fraction values (BmTrnsF_{Ei,unkn,1d} and BmTrnsF_{Ei,unkn,2d}) and the sample-specific linear attenuation coefficient (μ_{Ei,unkn}) values. The count rates for each characteristic-peak pair (or n-tuple of characteristic peaks from n-tuple different sample-depths, should three or more such depths be counted), and other related terms, are shown in the count-rate balance Equations [61c] and [61d].

CR_{Ei,unkn,1d}=Mᵤₙₖₙ*SpA_{Rj,unkn}*YF_{Rj,Ei}*EscF_{Ei,unkn,1d}*DetF(Eᵢ)_{smplFr} [61c]

CR_{Ei,unkn,2d}=Mᵤₙₖₙ*SpA_{Rj,unkn}*YF_{Rj,Ei}*EscF_{Ei,unkn,2d}*DetF(Eᵢ)_{smplFr} [61d]

Equations [61a] and [61b] are two equations in four unknowns. The four unknowns are the two sample-specific escaped-fraction terms (EscF_{Ei,unkn,1d} and EscF_{Ei,unkn,2d}); the signal emitters (Rⱼ) and their specific-activity quantities (SpA_{Rj,unkn}); and the associated characteristic (Eᵢ) yield-fractions (YF_{Rj,Ei}). The four known terms are the acquired 1d and 2d net unknown-sample peak count rates (CR_{Ei,unkn,1d} and CR_{Ei,unkn,2d}); the measured unknown-sample mass (Mᵤₙₖₙ); and the computed discrete sample-free detected-fraction calibrated values (DetF_{Ei,smplFr}) or the interpolated or fitted sample-free detected-fraction calibration function [DetF(Eᵢ)_{smplFr}].

To reduce the number of unknowns, the approach is to take the ratio of the 1d and 2d spectral peaks and their count-rate balance Equations [61c] and [61d], as follows:

$$\frac{{CR}_{Ei , unkn , 1 d}}{{CR}_{Ei , unkn , 2 d}} = \frac{{M}_{unkn} * {SpA}_{Rj , unkn} * {YF}_{Rj , Ei} * {EscF}_{Ei , unkn , 1 d} * {DetF ( {E}_{i} )}_{smplFr}}{{M}_{unkn} * {SpA}_{Rj , unkn} * {YF}_{Rj , Ei} * {EscF}_{Ei , unkn , 2 d} * {DetF ( {E}_{i} )}_{smplFr}} \qquad [ 62 a ]$$

Cancelling the equal terms in Equation [62a] leaves one equation in two unknowns, as follows:

$$\frac{{CR}_{Ei , unkn , 1 d}}{{CR}_{Ei , unkn , 2 d}} = \frac{{EscF}_{Ei , unkn , 1 d}}{{EscF}_{Ei , unkn , 2 d}} \qquad [ 62 b ]$$

Equation [62b] is one equation with two unknowns (EscF_{Ei,unkn,1d} and EscF_{Ei,unkn,2d}), which is now being redefined using a single common term in order to solve Equation [62b]. This term is the unknown-sample energy-dependent “linear attenuation coefficient” (μ_{Ei,unkn}), which has the same value for both thick and thin unknown-samples of the same material. Given that the thicknesses, 1d and 2d, as seen by the detector, are defined as 2d=2*1d, the two sample-specific escaped-fraction terms can be defined, as follows:

$$\begin{matrix}{EscF}_{Ei , unkn , 1 d} = \frac{1}{d} {\int }_{0}^{1 d} ( {e}^{- μ x} d x ) = \frac{1}{μ \cdot 1 d} ( 1 - {e}^{- μ \cdot 1 d} ) & [ 63 a ] \\ {EscF}_{Ei , unkn , 2 d} = \frac{1}{2 d} {\int }_{0}^{2 d} ( {e}^{- μ x} d x ) = \frac{1}{μ \cdot 2 d} ( 1 - {e}^{- μ \cdot 2 d} ) & [ 63 b ]\end{matrix}$$

Equations [63a] and [63b] can be simplified by substituting a beam-transmitted-fraction term (BmTrnsF_{Ei,unkn,1d}) for e^{-μ·1d} and rearranging terms as follows:

$$\begin{matrix}{EscF}_{Ei , unkn , 1 d} = \frac{{BmTrnsF}_{Ei , unkn , 1 d} - 1}{ln ( {BmTrnsF}_{Ei , unkn , 1 d} )} & [ 64 a ] \\ {EscF}_{Ei , unkn , 2 d} = \frac{{( {BmTrnsF}_{Ei , unknn , 1 d} )}^{2} - 1}{2 \cdot ln ( {BmTrnsF}_{Ei , unkn , 1 d} )} & [ 64 b ]\end{matrix}$$

Substituting Equations [64a] and [64b] into Equation [62b], and rearranging terms to isolate and solve for transmission of a beam through the sample of thickness 1d, BmTrnsF_{Ei,unkn,1d}, yields:

$${BmTrnsF}_{Ei , unkn , 1 d} = 2 * \frac{{CR}_{Ei , unkn , 2 d}}{{CR}_{Ei , unkn , 1 d}} - 1 \qquad [ 65 ]$$

Although not required to be known to quantify the signal emitters of interest, there may nonetheless be an interest to know the unknown-sample energy-specific linear attenuation coefficient (μ_{Ei,unkn}).

$${μ}_{Ei , unkn} = \frac{- ln ( {BmTrnsF}_{Ei , unkn , 1 d} )}{1 d} \qquad [ 66 ]$$

The mathematical laws of error analysis are computed as appropriate alongside the mathematical operations on the values of the terms comprising the count-rate balance Equations [61c] and [61d]. Thus, the terms will have the form v±Δv, where v represents the numerical value of a particular term in Equations [61c] and [61d], and ±Δv is the uncertainty in v.

Another software module 2038 in the 1d:2d Quantitation S/W Model computes each pair of sample-specific escaped-fraction terms (EscF_{Ei,unkn,1d} and EscF_{Ei,unkn,2d}) using Equations [64a] and [64b] and computes their associated uncertainties.

The Escaped-fraction Evaluation Software Module 2040 in FIG. 20 carries out four main functions. First, software module 2040 auto-deselects sample-specific escaped-fraction values and uncertainties that are “out of bounds” i.e. do not support the normal shape for a curve of signal-escape-versus-increasing-characteristic energy, which should asymptotically approach unity as signal energy increases, as illustrated by the dotted curve 2186 (in FIG. 21). Software module 2040 optionally allows the operator to manually deselect individual abnormal sample-specific escaped-fraction values. There are likely to be many characteristic peak pairs having worse statistics, or they may be convoluted with multiple signal emitter peaks, or, for other reasons they are not used to compute the sample-specific escaped-fraction. Second, software module 2040 checks each sample-specific escaped-fraction value for “deselection”. Third, software module 2040 passes “deselected” values to be flagged as “unused” for an optional review by an operator. Fourth, software module 2040 computes the sample-specific escaped-fraction functions [EscF(Eᵢ)_{unkn,1d}] and [(EscF(Eᵢ)_{unkn,2d}] for each unknown-sample thickness counted, as follows:

$$\begin{matrix}{EscF}_{Ei , unkn , 1 d} = \frac{{BmTrnsF}_{Ei , unkn , 1 d} - 1}{ln ( {BmTrnsF}_{Ei , unkn , 1 d} )} -> {EscF ( {E}_{i} )}_{unkn , 1 d} & [ 67 a ] \\ {EscF}_{Ei , unkn , 2 d} = \frac{{( {BmTrnsF}_{Ei , unkn , 1 d} )}^{2} - 1}{2 \cdot ln ( {BmTrnsF}_{Ei , unkn , 1 d} )} -> {EscF ( {E}_{i} )}_{unkn , 2 d} & [ 67 b ]\end{matrix}$$

These fitted functions cover the entire energy range, as illustrated by the dotted line 2186 in FIG. 21.

Another software module 2260 searches databases for known signal emitters (Rⱼ) and their characteristic (Eᵢ) yield-fractions (YF_{Rj,Ei}) that match the spectral peaks arising from unknown-samples. Spectrum analysis is performed, and the signal emitters are identified (Rj) along with their yield-fractions (YF_{Rj,Ei}).

Another software module 2272 computes the specific-activity quantities (SpA_{Rj,unkn}) of the identified signal emitters and their associated uncertainties to solve for the signal-emitter specific-activity quantities (SpA_{Rj,unkn}), as follows:

$$\begin{matrix}{SpA}_{Rj , unkn} = \frac{{C}_{Ei , unkn , 1 d}}{{M}_{unkn} * {YF}_{Rj , Ei} * {EscF ( {E}_{i} )}_{unkn , 1 d} * {DetF ( {E}_{i} )}_{smplFr} * {t}_{unkn , 1 d}} & [ 68 a ] \\ {SpA}_{Rj , unkn} = \frac{{C}_{Ei , unkn , 2 d}}{{M}_{unkn} * {YF}_{Rj , Ei} * {EscF ( {E}_{i} )}_{unkn , 2 d} * {DetF ( {E}_{i} )}_{smplFR} * {t}_{unkn , 2 d}} & [ 68 b ]\end{matrix}$$

In some cases, operators choose to use the discrete values of the sample-specific escaped-fraction terms (EscF_{Ei,unkn,1d} and EscF_{Ei,unkn,2d}) in Equations [68a] and [68b] in place of the fitted sample-specific escaped-fraction functions [EscF(Eᵢ)_{unkn,1d}] and [EscF(Eᵢ)_{unkn,2d}].

Software module 2272 also ‘flags’ which of the two expressions for the specific-activity quantities in Equations [68a] and [68b] provides better statistics. For t_{unkn,1d}=t_{unkn,2d}, usually Equation [68a] provides better statistics, especially at low signal energies because the 1d unknown-sample thickness in the direction of the detector is thinner than the 2d unknown-sample thickness in the same direction, and more characteristic signals escape from the thinner 1d unknown-sample thickness to be detected.

Operators may have reason to improve the statistics associated with the thick (2d) spectral peaks by counting the unknown-sample longer (t_{unkn,2d}>t_{unkn,1d}), and, in such cases, the 2d-based expression in Equation [68b] may provide better statistics for the specific-activity quantities (SpA_{Rj,unkn}).

Software module 2276 aggregates all of the data acquired from each of the other software modules in the 1d:2d Quantitation Software Model 2200 into user-selected or default formats, e.g. comma-separated-value (CSV) list, spreadsheet, computer screen, or other suitable output format.

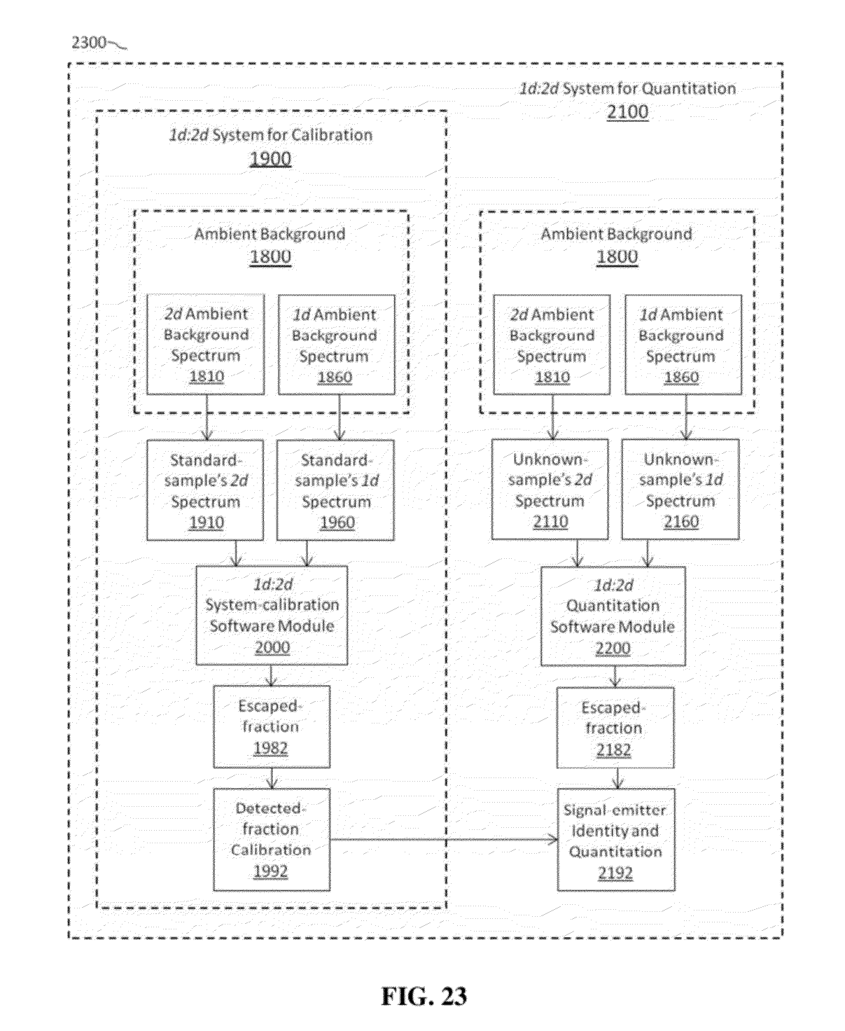

### 1d:2d System (FIG. 23)

FIG. 23 illustrates the three-part system hierarchy 2300 of apparatuses, methods, and software modules. The first part measures the ambient background signal-emitting environment 1800; the second part calibrates the signal-detection efficiency of a detection system 1900; and the third part identifies and quantifies signal emitters within a homogenous unknown-sample 2100. These three system parts are described in turn.

Ambient background signal emissions will be present as a component in the gross composite signal spectrum of a counted sample. A composite signal spectrum is comprised of ambient background signal emission and sample signal emission. In order to subtract out ambient background signals from the composite signal spectrum, two ambient signal background spectra are obtained: one ambient background emission spectrum with an empty sample-container apparatus (which is considered to be part of the detection system) in the thick (2d) position 1810 and one ambient background emission spectrum with the same empty sample-container apparatus in the thin (1d) position 1860.

Once the ambient background emission spectra have been computed 1800, the detection system setup 1900 is calibrated to compute its effectiveness to detect characteristic signals. A standard-sample is prepared and placed into the same type of sample-container apparatus that was used in the setup for acquiring the ambient background emission spectrum 1800. Such sample-container apparatus is placed in the same position and orientation, with respect to the detector, as that of the aforementioned sample-container apparatus.

The standard-sample is counted twice: once in the thick (2d) position and once in the thin (1d) position, in order to obtain two composite spectra, from which the corresponding thick (2d) and thin (1d) ambient background emission spectra are subtracted out, leaving two net spectra, one for the thick (2d) standard-sample 1910 and one for the thin (1d) standard-sample 1960.

The 1d:2d System Calibration Software Module 2000 computes the sample-specific escaped-fraction 1982 of un-attenuated signals from the thick (2d) and thin (1d) sample counting positions, and then computes the sample-free detected-fraction calibration 1992.

Once the detection system setup is calibrated to compute its effectiveness to detect characteristic signals 1900, the detection system then can be used to identify and quantify signal emitters in unknown-samples of homogenous composition 2100. An unknown-sample is prepared and placed into the same type of sample-container apparatus, which is then placed in the same position and orientation with respect to the detector, as that of the sample-container apparatus used in the setup for acquiring the ambient background emission spectrum 1800 and in the signal detection-efficiency calibration 1900.

The unknown-sample is counted twice: once in the thick (2d) position and once in the thin (1d) position, to obtain two composite spectra, from which the corresponding thick (2d) and thin (1d) ambient background emission spectra are subtracted out, leaving two net spectra: one for the thick (2d) unknown-sample 2110 and one for the thin (1d) unknown-sample 2160.

The 1d:2d Quantitation Software Module 2200 computes the sample-specific escaped-fractions 2182 of un-attenuated signals emitted from the thick (2d) and thin (1d) sample counting positions, and then computes the identities and specific-activity quantities of signal emitters in the unknown-sample 2192.

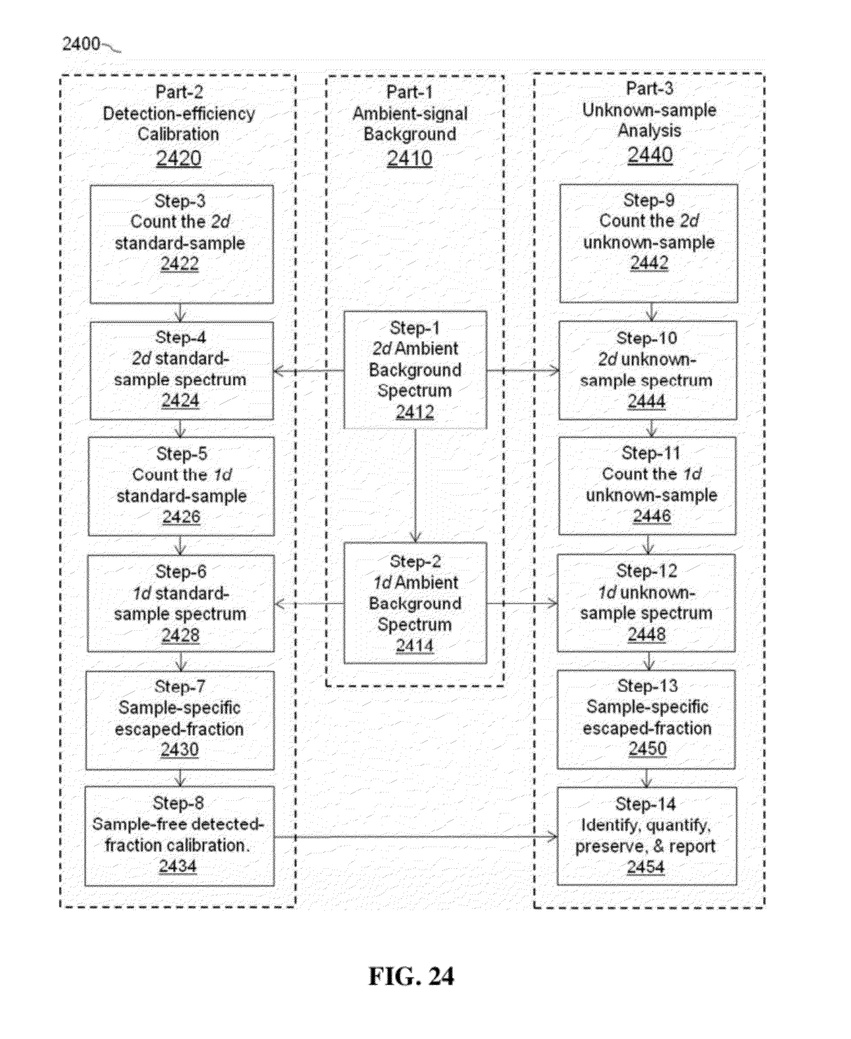

### 1d:2d Methodology (FIG. 24)

FIG. 24 illustrates a three-part hierarchy 2400 of methodologies. The first part measures the ambient background signal-emitting environment 2410, the second part calibrates the signal-detection efficiency of a detection system 2420, and the third part identifies and quantifies signal emitters within a homogenous unknown-sample 2440. These three methodological parts are described in turn.

The first part, acquiring the ambient background emission spectra 2410, consists of two major steps. In Step-1, 2412, a container apparatus is placed into the detection system in the thick (2d) position. Counting then begins and continues until the desired counting time (t_{bkgd,2d}) has elapsed. The resulting 2d ambient background emission spectrum is preserved and available to process later.

In Step-2, 2414, the sample-container apparatus is flipped 180 degrees and placed into the detection system in the thin (1d) position. Counting then begins and continues until the desired counting time (t_{bkgd,1d}) has elapsed. The resulting 1d ambient background emission spectrum is preserved and available to process later.

The second part, detection-efficiency calibration 2420, consists of six major steps i.e. Steps 3 through 8. Step-3, 2422, begins by placing a compositionally well known standard-sample into the two-thickness sample-container apparatus; sealing the two cups of the sample-container apparatus; placing the sample-container apparatus into the detection system e.g. in the thick (2d) position i.e. the same as was done when acquiring the 2d ambient background emission spectrum 2412, and then counting the standard-sample until the desired counting time (t_{stnd,2d}) has elapsed, by which time a gross composite spectrum will have been acquired, which includes the thick (2d) standard-sample spectral component and an ambient background emission spectral component.

Step-4, 2424, calls in the 2d ambient background emission spectrum 2412, normalizes it to, and then subtracts it out from, the 2d standard-sample composite spectrum, to yield the 2d net standard-sample spectrum.

In Step-5, 2426, the sample-container apparatus is flipped 180 degrees and the compositionally well known standard-sample is placed into the detection system in the thin (1d) position. Counting then begins and continues until the desired counting time (t_{stnd,1d}) has elapsed. The resulting 1d standard-sample emission spectrum includes an ambient background signal component.

Step-6, 2428, calls in the 1d ambient background emission spectrum 2414, normalizes it to, and then subtracts it out from, the 1d standard-sample composite spectrum, to yield the 1d net standard-sample spectrum.

Step-7, 2430, uses the 1d:2d Detected-fraction Calibration Software Model (FIG. 20) to compute discrete sample-specific beam-transmitted-fraction values through the thin (1d) thickness (BmTrnsF_{Ei,stnd,1d}), the discrete linear attenuation coefficient values (μ_{Ei,stnd}) for the standard-sample, and the discrete sample-specific escaped-fraction values (EscF_{Ei,stnd,1d} and EscF_{Ei,stnd,2d}). The operator has the option to manually deselect individual discrete sample-specific escaped-fraction values. Step-7 ends when the usable discrete sample-specific escaped-fraction values are interpolated or fitted to produce functions [EscF(Eᵢ)_{stnd,1d} and EscF(Eᵢ)_{stnd,2d}] covering the signal energy-range of interest.

Step-8, 2434, uses the 1d:2d Detected-fraction Calibration Software Model (FIG. 20) to compute the discrete sample-free detected-fraction calibration values (DetF_{Ei,smplFr}), and Step-8 ends when the usable sample-free detected-fraction values are interpolated or fitted to produce one or more smooth functions [DetF(Eᵢ)_{smplFr}] that cover the signal energy-range of interest.

The third part, unknown-sample analysis 2440, consists of six major steps i.e. Steps 9 through 14. Step-9, 2442, begins by placing an unknown-sample into the two-thickness sample-container apparatus; sealing the two cups of the sample-container apparatus; placing the sample-container apparatus into the detection system e.g. in the thick (2d) position i.e. the same as was done when acquiring the 2d ambient background emission spectrum 2412, and then counting the unknown-sample until the desired counting time (t_{unkn,2d}) has elapsed, by which time a gross composite spectrum will have been acquired, which includes the thick (2d) unknown-sample spectral component and an ambient background emission spectral component.

Step-10, 2444, calls in the 2d ambient background emission spectrum 2412, normalizes it to, and then subtracts it out from, the 2d unknown-sample composite spectrum, to yield the 2d net unknown-sample spectrum.

In Step-11, 2446, the sample-container apparatus is flipped 180 degrees and the unknown-sample is placed into the detection system in the thin (1d) position. Counting then begins and continues until the desired counting time (t_{unkn,1d}) has elapsed. The resulting 1d unknown-sample emission spectrum includes an ambient background signal component.

Step-12, 2448, calls in the 1d ambient background emission spectrum 2414, normalizes it to, and then subtracts it out from, the 1d unknown-sample composite spectrum, to yield the 1d net unknown-sample spectrum.

Step-13, 2450, uses the 1d:2d sample analysis software (FIG. 22) to compute discrete sample-specific beam-transmitted-fraction values through the thin (1d) thickness (BmTrnsF_{Ei,unkn,1d}), the discrete linear attenuation coefficient values (μ_{Ei,unkn}) for the unknown-sample, and the discrete sample-specific escaped-fraction values (EscF_{Ei,unkn,1d} and EscF_{Ei,unkn,2d}). The operator has the option to manually deselect individual discrete sample-specific escaped-fraction values. Step-13 ends when the usable discrete sample-specific escaped-fraction values are interpolated or fitted to produce functions [EscF(Eᵢ)_{unkn,1d} and EscF(Eᵢ)_{unkn,2d}] covering the signal energy-range of interest.

Step-14, 2454, uses the 1d:2d sample analysis software (FIG. 22) to call-in the discrete sample-free detected-fraction calibration values (DetF_{Ei,smplFr}) to help identify the signal emitters (Rⱼ) within the unknown-sample and then to compute the associated signal-emitter specific-activity quantities (SpA_{Rj,unkn}), and then to preserve and report the activities and results of the three-part hierarchy of methodologies 2400.

II. “nd:md” Sample Analysis

### Overview

Whereas 1d:2d sample analysis makes use of emission spectra acquired through at least two thicknesses of the same sample composition in the ratio of 1:2, nd:md sample analysis makes use of emission spectra acquired through at least two thicknesses of the same sample composition in the ratio of n:m, where, although such is not required to perform any of the analyses or computations, the unit of depth (“d”) is stated for the sake of convenience and simplicity to be one centimeter (1 cm). Examples of nd:md include, but are not limited to, 1d:2d (i.e. a special case of nd:md), 1d:3d, 1d:4d, 2d:3d, 3d:7d, and 0.412d:0.958d, where n and m are any positive numbers such that:

0<n<m [69]

The nd:md and sample analysis comprises apparatuses, methods, software, and systems; and is comprised of three main parts; (1) ambient background emission spectrum acquisition; (2) sample-free detected-fraction calibration (also called “detection-efficiency calibration” and “signal-detection-efficiency calibration”); and (3) unknown-sample analysis.

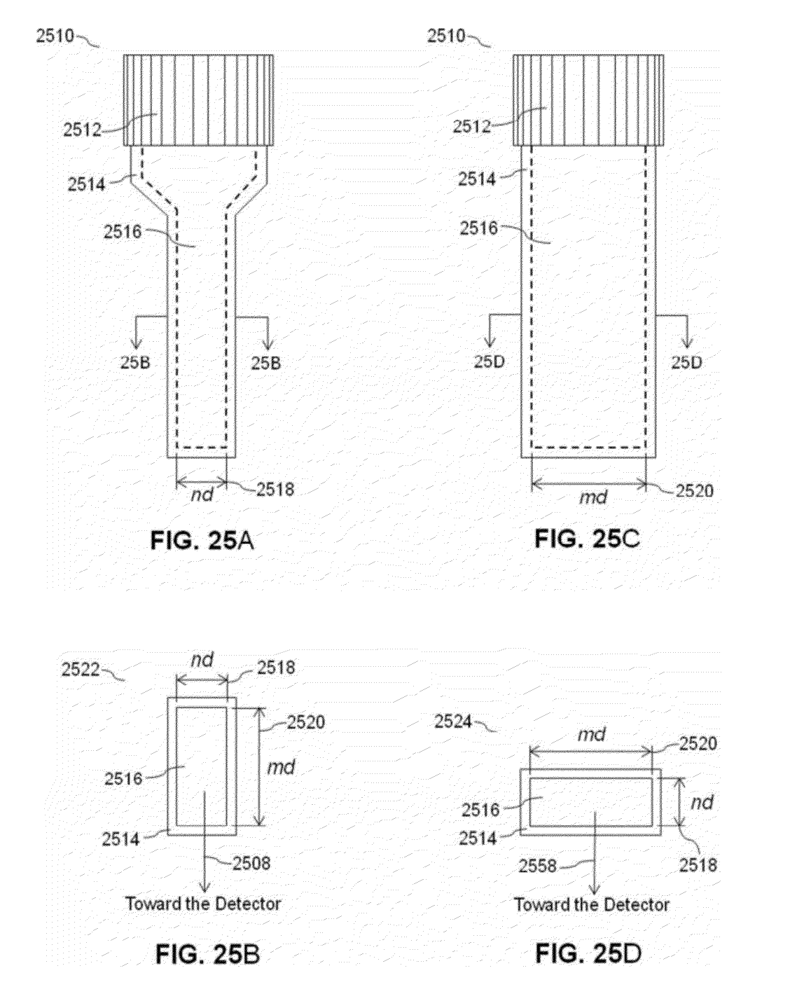

One Example of an “nd:md” Sample-Container Apparatus (FIGS. 25A-25D)

FIG. 25A illustrates the side view of the thin depth (nd 2518) of a sample-container apparatus 2510, where the sample space 2516 is empty. The sample-container apparatus 2510 is primarily comprised of a cap 2512, a wall 2514, and an empty sample space 2516.

FIG. 25B illustrates 2522 a top-down view of a cut-away of the sample-container apparatus shown in FIG. 25A. FIG. 25B illustrates the wall 2514, the empty sample space 2516, the thin depth (nd 2518) of the empty sample space 2516, and the thick depth (md 2520) of the empty sample space 2516. But only the thick depth (md 2520) is shown orthogonally toward the detector 2508.

FIG. 25C illustrates the same sample-container apparatus 2510 as shown in FIG. 25A, but where FIG. 25A has been rotated 90 degrees around a vertical axis through the center, giving a different orthogonal side view that shows the thick depth (md 2520) of the empty sample space 2516. The same cap 2512, cup wall 2514, and empty sample space 2516 are illustrated.

FIG. 25D illustrates 2524 a view from the top of a cut-away of the sample-container apparatus shown in FIG. 25B, and thus FIG. 25D is a 90-degree rotation of FIG. 25B. FIG. 25D illustrates the sample-container apparatus wall 2514 and both the thin depth (nd 2518) and thick depth (md 2520) of the empty sample space 2516. But only the thin depth (nd 2518) is shown orthogonally to the detector 2558.

As an example, the thin depth (nd 2518) of the particular sample-container apparatus illustrated in FIGS. 25A to 25D measures 0.412 cm, and the thick depth (md 2520) measures 0.958 cm. Thus, the thin:thick depth ratio of

$$n \text{:} m = \frac{0.412}{0.958} ≅ 0.43 \approx \frac{3}{7} ,$$

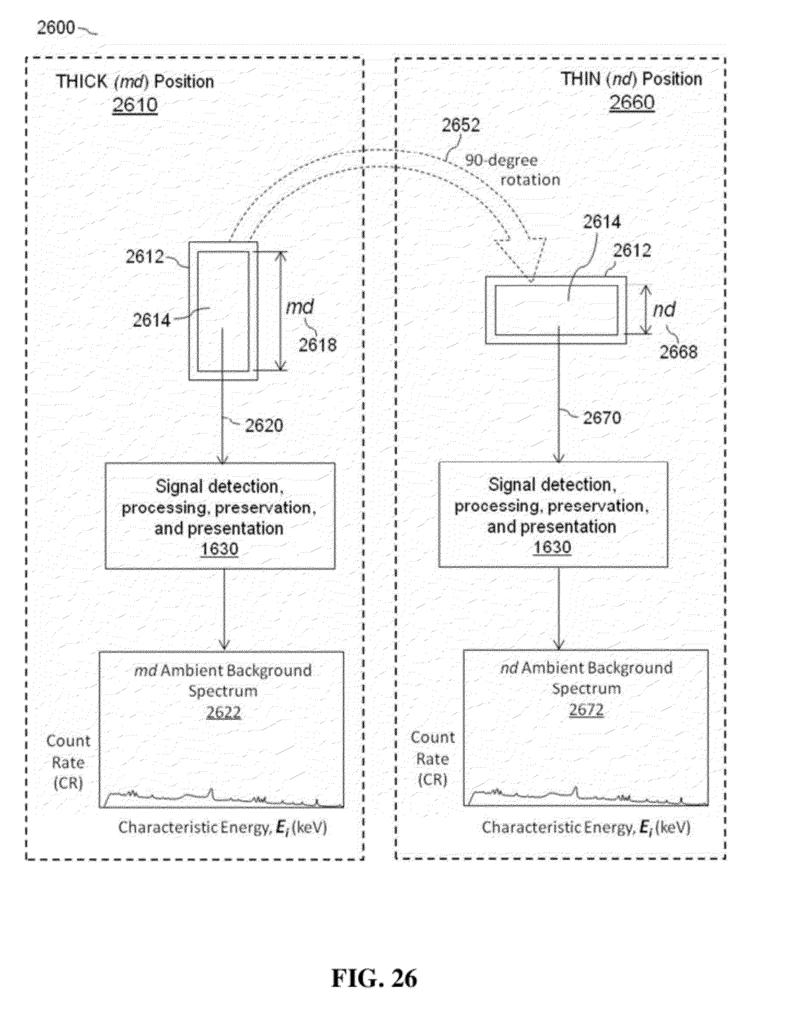

an integer ratio of about 3:7.
Part 1. “nd:md” Ambient Background Counting (FIG. 26)

FIG. 26 shows a detection system setup 2600 for acquiring nd 2618 and md 2668 ambient background emission spectra 2622 and 2672. For this discussion, it is presumed that the empty sample space 2614 of the nd:md sample-container apparatus 2612 is first counted in the thick (md) position 2610, in which the md sample-depth 2618 is in the direction 2620 of the signal detection, processing, preservation, and presentation subsystem 1630. After a length of counting time (t_{bkgd,md}) the counting is stopped and the empty sample space 2614 of the sample-container apparatus 2612 is rotated 90 degrees 2652 to the thin (nd) position 2660, such that the nd sample-depth 2668 is in the direction 2670 of subsystem 1630. After a length of counting time (t_{bkgd,nd}) the counting is stopped.

The size, shape, position, and orientation of the empty nd:md sample-container apparatus, with respect to the detector, should be the same as those planned for sample-container apparatuses holding standard-samples that are used to calibrate the detection system, as well as for sample-container apparatuses holding unknown-samples that are to be measured and analyzed by the detection system.

Subsystem 1630 detects, processes, preserves, and presents the nd and md ambient background emission spectra 2622 and 2672.

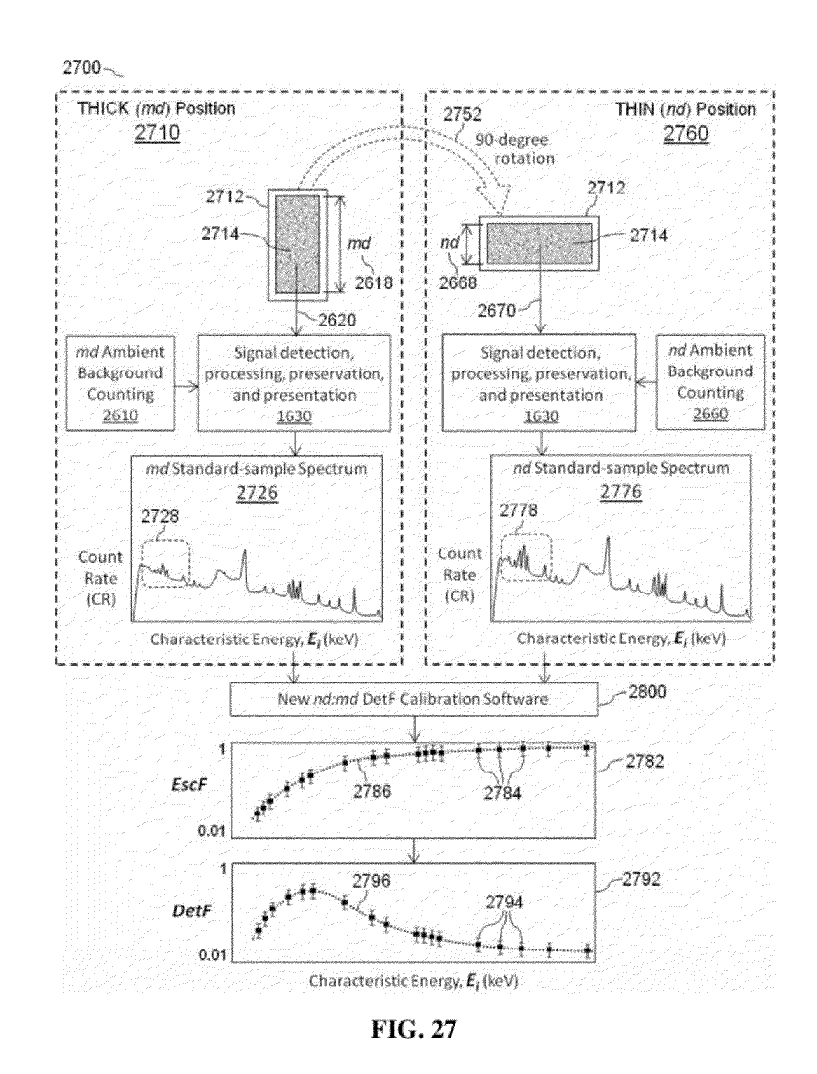

Part 2. “nd:md” Signal Detection-Efficiency Calibration (FIG. 27)

Before signal-detection systems are used to quantify signal emitters in unknown-samples, they usually first require a detection-efficiency calibration of some kind. FIG. 27 illustrates one such system 2700 for calibrating signal detection efficiency. The signal detection-efficiency calibration requires counting a compositionally well known standard-sample (stnd) 2714 in both the thick (2d) 2710 and thin (1d) 2760 counting positions, where the standard-sample 2714 is placed in the same type of sample-container apparatus 2712 as was used to calculate the ambient background emission spectra 2622 and 2672 (in FIG. 26), and in the same position and orientation relative to the detector.

A standard-sample mass (M_{stnd}), may be computed where the mass of an empty sample-container apparatus (M_{cntr}) is subtracted from the combined mass of the sample-container apparatus and the standard-sample (M_{cntr+stnd}), as follows:

M_{stnd}=M_{cntr+stnd}−M_{cntr} [70]

It is presumed for this particular discussion that the standard-sample 2714 is first counted in the thick (md) position 2710, in which the md sample-depth 2618 is in the direction 2620 of the signal detection, processing, preservation, and presentation subsystem 1630. After a length of counting time (t_{stnd,md}), the counting is stopped. Characteristic signals that escape the thick (md) 2618 standard-sample 2714 and that register, along with the ambient background signals, in subsystem 1630, produce a “thick” (md) gross composite spectrum (not shown).

Once the “thick” (md) gross composite spectrum is obtained, then the sample-container apparatus 2712 is rotated 2752 to the thin (nd) position 2760, such that the nd sample-depth 2668 is in the direction 2670 of subsystem 1630, where counting of the thin (nd) sample-depth begins. After a length of counting time (t_{stnd,nd}), the counting is stopped. Characteristic signals that escape the thin (nd) 2668 standard-sample 2714 and that register, along with the ambient background signals, in subsystem 1630, produce a “thin” (nd) gross composite spectrum (not shown).

To subtract-out the ambient background emission spectra 2610 and 2660 from their corresponding “thick” and “thin” gross composite spectra (not shown), it is convenient to first normalize the counting times of the ambient background emission spectra (t_{bkgd,nd} and t_{bkgd,md}) to the counting times of their corresponding “thick” and “thin” gross standard-sample spectra (t_{stnd,nd} and t_{stnd,md}). Count-time normalization is usually accomplished by dividing the characteristic peak counts by the counting time to yield a count rate. Count rates are normalized as counts/unit-time, so that they can be compared directly. The characteristic thick (md) position and thin (nd) position ambient background counts (BC_{Ei,nd} and BC_{Ei,md}) are normalized to their respective ambient background count rates (BCR_{Ei,nd} and BCR_{Ei,md}), as follows:

$$\begin{matrix}{BCR}_{Ei , nd} = \frac{{BC}_{Ei , nd}}{{t}_{bkgd , nd}} & [ 71 a ] \\ {BCR}_{Ei , md} = \frac{{BC}_{Ei , md}}{{t}_{bkgd , md}} & [ 71 b ]\end{matrix}$$

The characteristic thick (md) position and thin (nd) position gross standard-sample counts (GC_{Ei,stnd,nd} and GC_{Ei,stnd,md}) are normalized to their respective gross standard-sample count rates (GCR_{Ei,stnd,nd} and GCR_{Ei,stnd,md}), as follows:

$$\begin{matrix}{GCR}_{Ei , stnd , nd} = \frac{{GC}_{Ei , stnd , nd}}{{t}_{stnd , nd}} & [ 72 a ] \\ {GCR}_{Ei , stnd , md} = \frac{{GC}_{Ei , stnd , md}}{{t}_{stnd , md}} & [ 72 b ]\end{matrix}$$

The ambient background signal count rates 2610 and 2660 are then subtracted out from their corresponding standard-sample gross spectra (not shown), leaving the corresponding net standard-sample spectra 2726 and 2776. This can be summarized, as follows:

CR_{Ei,stnd,nd}=GCR_{Ei,stnd,nd}−BCR_{Ei,nd} [73a]

CR_{Ei,stnd,md}=GCR_{Ei,stnd,md}−BCR_{Ei,md} [73b]

By comparing the net md and nd standard-sample spectra 2726 and 2776 in FIG. 27, one notices a significant difference between the peak heights at the low-energy portion of the thick (md) and thin (nd) spectra 2728 and 2778. The highly attenuated peaks of the thick (md) standard-sample counting 2710 are anticipated because, at low energy, more of the characteristic signals are attenuated within the thick (md) “shape” of the standard-sample, relative to the thin (nd) “shape” of the standard-sample.

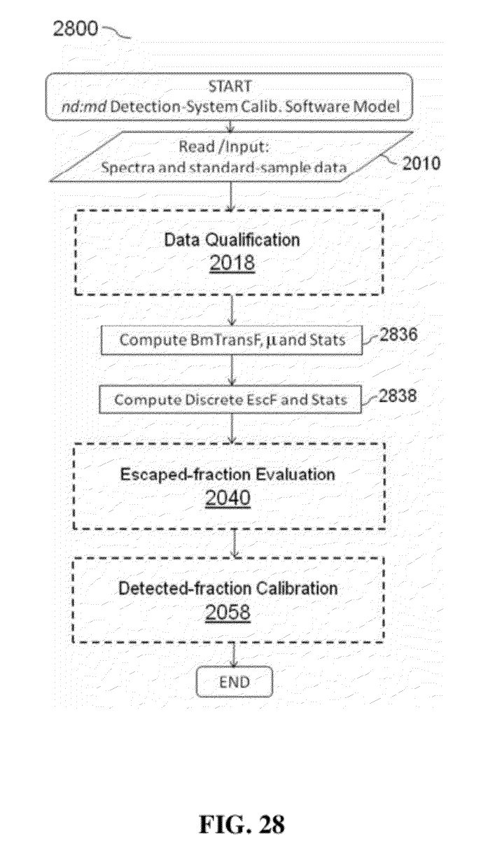

FIG. 28 shows the nd: md Detection System Calib. Software Model 2800 reads as input the thick and thin spectral peak data and computes, for each useful thick and thin characteristic spectral-peak pair, the discrete characteristic sample-specific escaped-fraction values (EscF_{Ei,stnd,nd} and EscF_{Ei,stnd,md}) and then computes the corresponding discrete characteristic sample-free detected-fraction calibration values (DetF_{Ei,smplFr}) 2794.

All of the discrete sample-specific escaped-fraction values 2784, taken together, resemble the outline of a curve that spans the energy range of interest (represented by the dotted line 2786). Commonly, a function is fitted to these discrete values 2784 to cover the entire usable energy-detection range of the detection system. The discrete values 2784 and all of the possible fitted values 2786 of the sample-specific escaped fraction are illustrated together 2782.

All of the discrete, computed sample-free detected-fraction calibration values (DetF_{Ei,smplFr}) 2794, taken together, resemble the outline of a curve that spans the energy range of interest (represented by the dotted line 2796). Commonly one or more functions are fitted to these discrete values 2794 to cover the entire usable energy-detection range of the detection system. The discrete values 2794 and all of the possible fitted values 2796 of the sample-free detected-fraction calibration are illustrated together 2792.

Subsystem 1630 detects, processes, preserves, and presents the nd and md standard-sample spectra 2726 and 2776.

### nd:md Software Model for Detection-System Calib. (FIG. 28)

FIG. 28 depicts a flowchart of the nd:md Sample-free Detected-fraction Calibration Software Model (hereinafter, the “nd:md Calib. S/W Model”) 2800, which reads as input 2010 (in FIG. 20) the nd and md spectral data, the standard-sample data, and the signal-emitter signal yield-fraction data (YF_{Rj,Ei}).

The Data Qualification Software Module 2018 in FIG. 20 identifies those characteristic nd and md peak pairs useful for computing associated values of sample-specific beam-transmitted-fraction values (BmTrnsF_{Ei,stnd,nd} and BmTrnsF_{Ei,stnd,md}) and associated standard-sample linear attenuation coefficient (μ_{Ei,stnd}) values.

For each characteristic peak pair, software module 2836 then computes the sample-specific beam-transmitted-fraction (BmTrnsF_{Ei,stnd,nd}) and the sample-specific linear attenuation coefficient (μ_{Ei,stnd}). The count rates for each characteristic-peak pair (or n-tuple of characteristic peaks from n-tuple different sample-depths, should three or more such depths be counted), and other related terms, are shown in the count-rate balance Equations [73c] and [73d].

CR_{Ei,stnd,nd}=M_{stnd}*SpA_{Rj,stnd}*YF_{Rj,Ei}*EscF_{Ei,stnd,nd}*DetF_{Ei,smplFr,nd} [73c]

CR_{Ei,stnd,md}=M_{stnd}*SpA_{Rj,stnd}*YF_{Rj,Ei}*EscF_{Ei,stnd,md}*DetF_{Ei,smplFr,md} [73d]

Equations [73a] and [73b] are two equations in four unknowns. The four unknowns are the two sample-specific escaped-fraction terms (EscF_{Ei,stnd,nd} and EscF_{Ei,stnd,md}); and the two sample-free detected-fraction calibration terms (DetF_{Ei,smplFr,nd} and DetF_{Ei,smplFr,md}). The known terms are the measured nd and md count rates (CR_{Ei,stnd,nd} and CR_{Ei,stnd,md}); the measured standard-sample mass (M_{stnd}); the reported signal emitter identities (Rⱼ) and their specific-activity quantities (SpA_{Rj,stnd}); and the widely published signal emitter characteristic (Eᵢ) emission yield-fractions (YF_{Rj,Ei}).

To reduce the number of unknowns, the approach is to take the ratio of the nd and md spectral peaks and their count-rate balance Equations [73c] and [73d] as follows:

$$\frac{{CR}_{Ei , stnd , nd}}{{CR}_{Ei , stnd , md}} = \frac{{M}_{stnd} * {SpA}_{Rj , stnd} * {YF}_{Rj , Ei} * {EscF}_{Ei , stnd , nd} * {DetF}_{Ei , smplFr , nd}}{{M}_{stnd} * {SpA}_{Rj , stnd} * {YF}_{Rj , Ei} * {EscF}_{Ei , stnd , md} * {DetF}_{Ei , smplFr , md}} \qquad [ 74 a ]$$

Cancelling the equal terms in Equation [74a] leaves one equation in four unknowns:

$$\frac{{CR}_{Ei , stnd , nd}}{{CR}_{Ei , stnd , md}} = \frac{{EscF}_{Ei , stnd , nd} * {DetF}_{Ei , smplFr , nd }}{{EscF}_{Ei , stnd , md} * {DetF}_{Ei , smplFr , md}} \qquad [ 74 b ]$$

Although the values of the two sample-free detected-fraction calibration terms (DetF_{Ei,smplFr,nd} and DetF_{Ei,smplFr,md}) are yet unknown, it is adduced that they are nearly equal in value for the standard-sample positions relative to the setup of the detection-system shown in FIG. 27 for the reasons described in the discussion of FIG. 17 and Equations [38a] to [40]. Thus, if at high characteristic signal energy,

as: Eᵢ→High [75a]

then: EscF_{Ei,stnd,md}→EscF_{Ei,stnd,nd}→1 [75b]

and if: CR_{Ei,smpl,nd}→CR_{Ei,smpl,md} [75c]

then:

$$\frac{{DetF}_{Ei , smplFr , nd}}{{DetF}_{Ei , smplFr , md}} -> 1 \qquad [ 75 d ]$$

therefore, set:

$$\frac{{DetF}_{Ei , smplFr , nd}}{{DetF}_{Ei , smplFr , md}} = 1 \qquad [ 75 e ]$$

then: DetF_{Ei,smplFr,nd}=DetF_{Ei,smplFr,md}=DetF_{Ei,smplFr} [75f]

and from Equations [73c] and [73d]:

$$\begin{matrix}{DetF}_{Ei , smplFr} = \frac{{CR}_{Ei , stnd , nd}}{{M}_{stnd} * {SpA}_{Rj , stnd} * {Y}_{Rj , Ei} * {EscF}_{Ei , stnd , nd}} \\ = \frac{{CR}_{Ei , stnd , md}}{{M}_{stnd} * {SpA}_{Rj , stnd} * {Y}_{Rj , Ei} * {EscF}_{Ei , stnd , md}}\end{matrix} \qquad [ 75 g ]$$

Replacing the two terms DetF_{Ei,smplFr,nd} and DetF_{Ei,smplFr,md} in Equation [74b] with the single DetF_{Ei,smplFr} term in Equation [75g] allows cancelling the two sample-free detected-fraction calibration terms in Equation [74b] to yield:

$$\frac{{CR}_{Ei , stnd , nd}}{{CR}_{Ei , stnd , md}} = \frac{{EscF}_{Ei , stnd , nd}}{{EscF}_{Ei , stnd , md}} \qquad [ 76 ]$$

To solve Equation [76], which is one equation with two unknowns (EscF_{Ei,stnd,nd and} EscF_{Ei,stnd,md}), the two sample-specific escaped-fractions are redefined in terms of the fraction of a characteristic beam that transmits through a unit of sample thickness (d), the unit defined as one centimeter (1 cm), which allows defining a beam-transmitted-fraction BmTrnsF_{Ei,stnd,1cm} through a single centimeter of the standard-sample.

In a preliminary step, two unknowns terms in Equation [76] (EscF_{Ei,stnd,nd} and EscF_{Ei,stnd,md}) are redefined using a single common term, the energy-dependent “linear attenuation coefficient” (μ_{Ei,stnd}), which has the same value for both thick and thin standard-samples of the same material at a given energy (Eᵢ). Following the reasoning in the discussion surrounding Equations [34a] through [37], the thick (md) and thin (nd) sample orientations yield, (where d=1 cm):

$$\begin{matrix}{EscF}_{Ei , stnd , n} = \frac{1}{n} {\int }_{0}^{n} {e}^{- μ \cdot x} d x = \frac{1}{μ \cdot n} ( 1 - {e}^{- μ \cdot n} ) & [ 77 a ] \\ {EscF}_{Ei , stnd , m} = \frac{1}{m} {\int }_{0}^{m} {e}^{- μ \cdot x} d x = \frac{1}{μ \cdot m} ( 1 - {e}^{- μ \cdot m} ) & [ 77 b ]\end{matrix}$$

Knowing that a beam through each of the sample-depths (n and m) attenuates according to:

BmTrnsF_{Ei,stnd,n}=e^{μ·n}=(e^{-μ})ⁿ=(BmTrnsF_{Ei,stnd,1cm})ⁿ [78a]

BmTrnsF_{Ei,stnd,m}=e^{-μ·m}=(e^{-μ})^{m}=(BmTrnsF_{Ei,stnd,1cm})^{m} [78b]

it follows that the linear attenuation per centimeter of thickness (cm⁻¹) of the standard-sample is:

μ_{Ei,stnd}=−ln(BmTrnsF_{Ei,stnd,1cm}) [79]

Equations [77a] and [77b] can be simplified by substituting the term for a beam through a single centimeter of standard-sample, BmTrnsF_{Ei,stnd,1cm}, which yields:

$$\begin{matrix}{EscF}_{Ei , stnd , n} = \frac{{( {BmTrnsF}_{Ei , stnd , 1 c m} )}^{n} - 1}{n \cdot ln ( {BmTrnsF}_{Ei , stnd , 1 c m} )} & [ 80 a ] \\ {EscF}_{Ei , stnd , m} = \frac{{( {BmTrnsF}_{Ei , stnd , 1 c m} )}^{m} - 1}{m \cdot ln ( {BmTrnsF}_{Ei , stnd , 1 c m} )} & [ 80 b ]\end{matrix}$$

Then substituting the right-side terms in Equations [80a] and [80b] into Equation [76], and reducing terms:

$$\frac{{CR}_{Ei , stnd , n}}{{CR}_{Ei , stnd , m}} = \frac{m}{n} * \frac{[ {( {BmTrnsF}_{Ei , stnd , 1 c m} )}^{n} - 1 ]}{[ {( {BmTrnsF}_{Ei , stnd , 1 c m} )}^{m} - 1 ]} \qquad [ 81 a ]$$

Equation [81a] rearranges to:

$$[ \frac{{CR}_{Ei , stnd , n}}{{CR}_{Ei , stnd , m}} ] {( {BmTrnsF}_{Ei , stnd , 1 c m} )}^{m} - [ \frac{m}{n} ] {( {BmTrnsF}_{Ei , stnd , 1 c m} )}^{n} + [ \frac{m}{n} - \frac{{CR}_{Ei , stnd , n}}{{CR}_{Ei , stnd , m}} ] = 0 \qquad [ 81 b ]$$

The only unknown in Equation [81b] is the beam-transmitted-fraction through a 1-cm “slab” of the standard-sample (BmTrnsF_{Ei,stnd,1cm}), which is easily solved numerically by computer.

Although not required to be known to quantify the signal emitters of interest, there may nonetheless be an interest to know the standard-sample energy-specific linear attenuation coefficient (μ_{Ei,stnd}). Once the value of BmTrnsF_{Ei,stnd,1cm} is known from Equation [81b], Equation [79] is used to compute the value of the linear attenuation coefficient (μ_{Ei,stnd}) for the standard-sample.

Another software module 2838 calls as inputs the count rates of the characteristic peak pairs and the corresponding characteristic values of BmTrnsF_{Ei,stnd,1cm}, and computes the associated sample-specific escaped-fraction values (EscF_{Ei,stnd,nd} and EscF_{Ei,stnd,md}) using Equations [80a] and [80b].

Only one set of values for the discrete sample-specific escaped-fraction values 2784 is illustrated in FIG. 27 (either EscF_{Ei,stnd,nd} or EscF_{Ei,stnd,md}), because, by looking at Equation [75g], it is seen that although both expressions determine the sample-free detected-fraction calibration term (DetF_{Ei,smplFr}), only one is needed, and the logical choice is the expression that leads to the better statistics for DetF_{Ei,smplFr}.

The Escaped-fraction Evaluation Software Module 2040 (in FIG. 20) evaluates and processes the useful discrete sample-specific escaped-fraction values and uncertainties for determining a sample-specific escaped-fraction function or interpolated curve, and computes the fitted, sample-specific escaped-fraction functions as follows:

EscF_{Ei,stnd,nd}→EscF(Eᵢ)_{stnd,nd} [82a]

EscF_{Ei,stnd,md}→EscF(Eᵢ)_{stnd,md} [82b]

Another software module 2058 computes the sample-free detected-fraction calibration (DetF_{Ei,smplFr}) using both expressions of Equation [75g]; computes the associated uncertainties; indicates which expression contained in Equation [75g] provides better statistics for the sample-free detected-fraction calibration; provides for computing a sample-free detected-fraction calibration function or interpolated curve to cover the entire energy region, as follows:

DetF_{Ei,smplFr,nd}→DetF(Eᵢ)_{smplFr,nd} [83]

DetF_{Ei,smplFr,md}→DetF(Eᵢ)_{smplFr,md} [84]

and aggregates all of the data acquired from each of the other software modules into user-selected or default formats, e.g. comma-separated-value (CSV) list, spreadsheet, computer screen, or other suitable output format.

The mathematical laws of error analysis are computed as appropriate alongside the mathematical operations on the values of the terms comprising the count rate balance Equations [73c] and [73d]; thus, the terms will have the form v±Δv, where v represents the numerical value of a particular term in Equations [73c] and [73d], and ±Δv is the uncertainty in v.

Once signal-detection efficiency is calibrated, the detection system is ready to detect, identify, and compute quantities of signal emitters in unknown-samples.

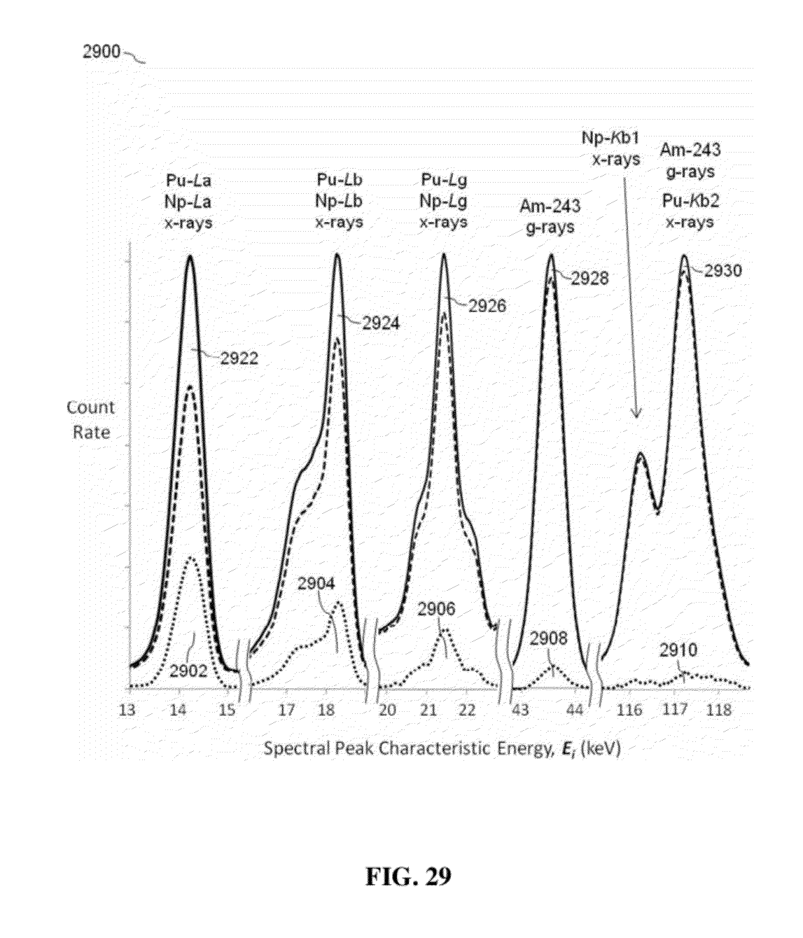

### Comparing nd and md Spectral Peak Count Rates (FIG. 29)

Count rates can be compared directly. FIG. 29 shows a graph 2900 of genuine experimental data from an actual prototype of an nd: md two-thickness detection-system calibration using about 1.3 milliliters (“mL”) of an aqueous americium-243 (“Am-243”) standard-sample (stnd) poured into a two-thickness sample-container apparatus (“cuvette”) like that shown in FIGS. 25A through 25D, 26 and 27, where md≈0.958 cm, and nd≈0.412 cm. Thus, the ratio of the thin:thick depths is about nd:md≈0.43≈3:7.

The cuvette forms the Am-243 standard-sample into two different depths (nd and md) with respect to the detection system when each upright side, in turn, faces the detector. In graph 2900, five characteristic spectral peaks are shown. The spectral peaks are primarily composed of plutonium (Pu) and neptunium (Np) L-shell x-rays (La, Lb, and Lg) at about 14 keV 2902, 18 keV 2904, and 21 keV 2906; americium-243 gamma-rays (g-rays) at about 43.5 keV 2908; and americium-243 g-rays and plutonium K-shell x-rays (Kb1 and Kb2) at about 117 keV 2910. Three characteristic spectral traces are shown in FIG. 29 (upper solid-line, middle dashed-line, and lower dotted-line). The upper solid-line spectral trace is the characteristic (Eᵢ) count rate (CR_{Ei,stnd,nd}) from the thin (nd) counting position like that shown in 2760 in FIG. 27. The middle dashed-line spectral trace is the characteristic count rate (CR_{Ei,stnd,md}) from the thick (md) counting position like 2710 in FIG. 27.

At the higher signal emission energy, signals escape the thin and thick sample fairly easily, and the thin and thick peak count rates nearly equal each other 2930. As the peak energy decreases, the thick (md) sample self-attenuates faster than does the thin (nd) sample. Relative to the thin spectrum count rate (CR_{Ei,stnd,nd}), the thick-spectrum count rate (CR_{Ei,stnd,md}) shows a rapidly degenerating peak height with decreasing characteristic energy (Eᵢ) because the thicker sample self-attenuates more characteristic signals. The lower dotted-line spectral trace is the difference spectrum (diff) between the thin and thick spectral count rates for each respective characteristic peak, as follows:

CR_{Ei,stnd,diff}=CR_{Ei,stnd,nd}−CR_{Ei,stnd,md} [85]

Thus, three spectral traces are partially shown: the thin (nd) spectral trace (CR_{Ei,stnd,nd}), represented by the uppermost, solid lines of all five peaks; the thick (md) spectral trace (CR_{Ei,stnd,md}), represented by the middle, dashed lines of all five peaks; and the difference (diff) spectral trace (CR_{Ei,stnd,diff}), represented by the lowest, dotted lines of all five peaks. FIG. 29 shows that, as the characteristic energy increases, the difference-spectrum diminishes. At 14 keV, the difference peak 2902 is quite large; at 18 keV, the difference peak 2904 is smaller; at 21 keV, the difference peak 2906 is smaller still; at 43.5 keV, the difference peak 2908 is even smaller; and at the intermediate characteristic energy of about 117 keV, the difference peak 2910 is smallest yet, but still observable. Although the difference peaks shown in FIG. 29 are all less than their associated thick-sample peaks, such may not always be the case and partly depends on the severity of the sample self-attenuation.

One benefit of plotting the difference spectrum is that it shows the operator which characteristic peaks require sample self-attenuation correction. If there is a noticeable difference-peak, then both the thick and thin peaks should be corrected for sample self-attenuation. The difference-spectrum in FIG. 29 shows that the four low-energy peaks 2902, 2904, 2906, and 2908 do require sample self-attenuation corrections, whereas loss of counts due to sample self-attenuation in the intermediate-energy peak 2910 could probably be ignored if the peak doesn't represent the greatest component of uncertainty in the final sample results. If samples are thin, then high-energy peaks may not require sample self-attenuation correction. However, if the samples are thick, then even the highest-energy peaks may show a significant difference in the peak count rate (CR_{Ei,dif f}) and should therefore be corrected for sample self-attenuation. In fact, nd: md apparatuses, methods, software and systems make such corrections to the thin and thick sample self-attenuations possible at all characteristic signal energies.

FIG. 29 shows, for genuine experimental data from a sample containing Am-243 and its daughter radioisotopes, that as the characteristic signal energy increases, the thick and thin peak count-rates 2922, 2924, 2926, 2928, and 2930 approach equality (CR_{Ei,smpl,md}→CR_{Ei,smpl,nd}) as Eᵢ increases, because sample self-attenuation decreases with increasing characteristic energy. Thus, matching high-energy peak pairs indicate that the two sample-free detected-fraction calibration terms (DetF_{Ei,smplFr,nd} and DetF_{Ei,smplFr,md}), although unknown, must have nearly the same value. In all cases, the calibration standard should be a low-z material, like an organic liquid, water, or weak acid, to minimize the role of sample self-attenuation at high energy.

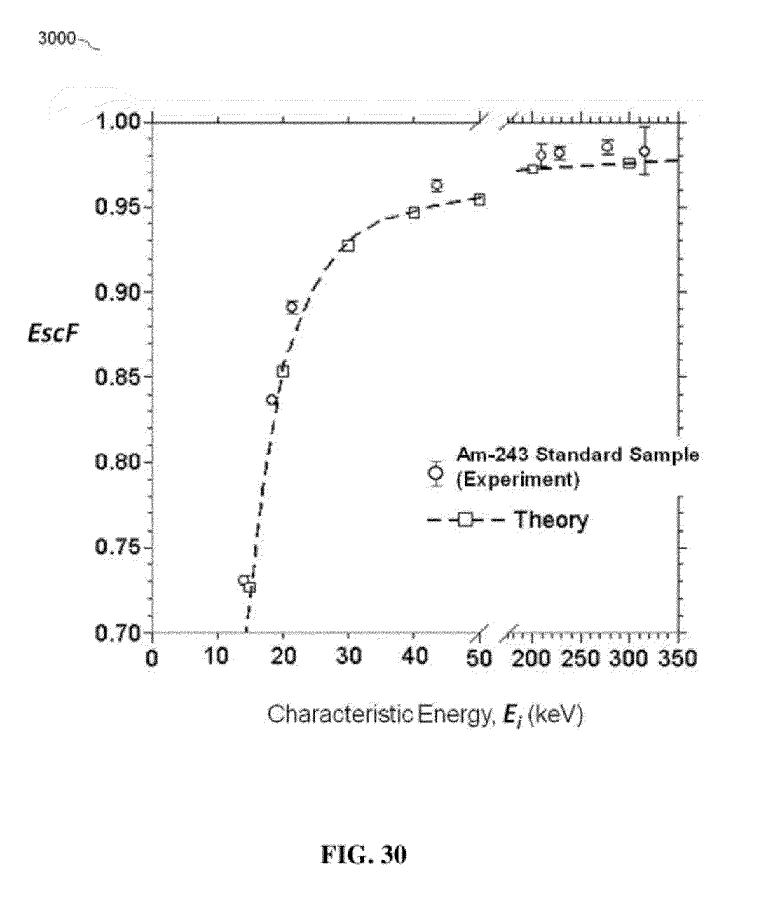

### Experimental nd:md EscF Result (FIG. 30)

FIG. 30 shows the performance graph 3000 of a comparison between the discrete computed sample-specific escaped-fraction (EscF_{Ei,stnd,nd}) (shown as circles with error bars) for the thin (nd) sample position of the same Am-243 standard-sample that produced the nd: md peak-pairs 2900 in FIG. 29, and the theoretical computed sample-specific escaped-fraction (EscF_{Ei,theory,nd}) (shown as a dashed-line fitted to discrete solutions, indicated by squares) based on the known photon-attenuation cross-sections for the known elemental composition of the Am-243 standard-sample. The theoretical sample and Am-243 standard-sample, sample-specific escaped-fraction values match quite well over the energy range shown, thus demonstrating the effectiveness of the nd:md multiple-thickness apparatus, methods, software, and systems for determining the fraction of characteristic signals that escape from a homogeneous sample, and by Equation [34a], the sample self-attenuation of those signals.

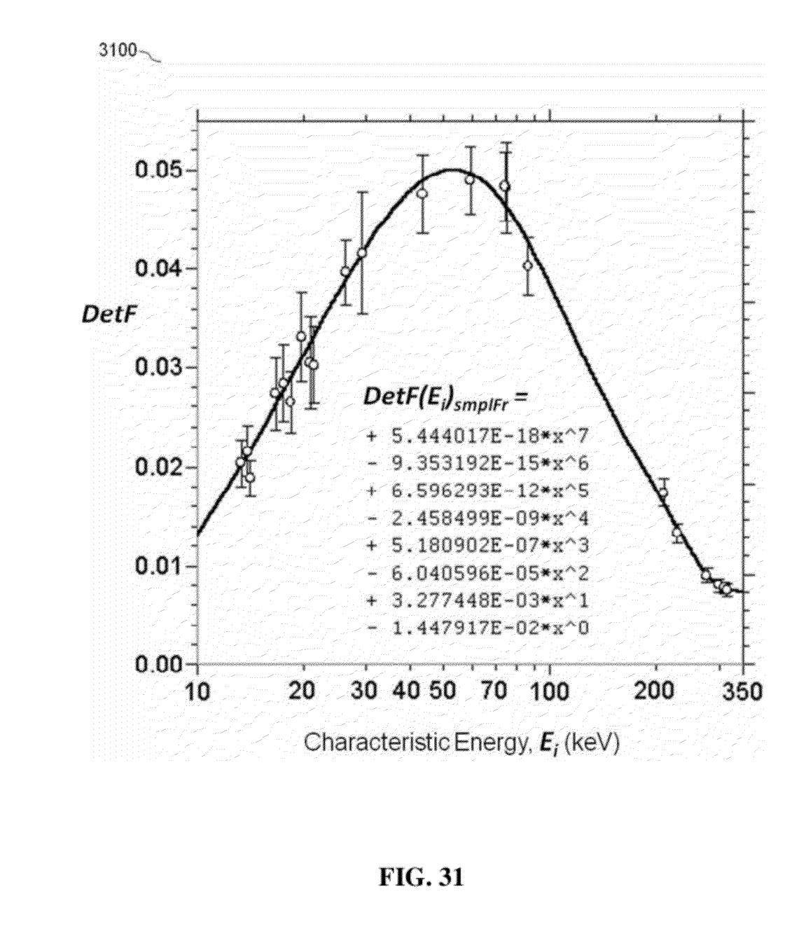

### Experimental nd:md DetF Calibration Result (FIG. 31)

FIG. 31 shows a graph 3100 of an actual determination of discrete sample-free detected-fraction calibration values (DetF_{Ei,smplFr}, shown as circles with error bars) and a fitted function, DetF(Eᵢ)_{smplFr} (the solid line), that covers the entire usable energy range. Three 1.3-mL standard-samples were counted in order to cover the full energy range with useful characteristic spectral peaks: the first standard-sample is the same Am-243 sample that produced the peak-pairs 2900 (in FIG. 29) and the sample-specific escaped-fraction values 3000 (in FIG. 30); the second standard-sample is an americium-241 (Am-241) sample; and the third standard-sample is a neptunium-237 (Np-237) sample. All three standard-samples were measured in the same type, shape, and size of nd:md multiple thickness sample-container apparatus, as that shown in FIGS. 25A through 25D; counted in the nd:md calibration system, as that shown in FIG. 27; and used the software model 2800 described in FIG. 28. Once calibrated, the detection system is ready to identify, measure, and compute quantities of signal emitters in unknown-samples.

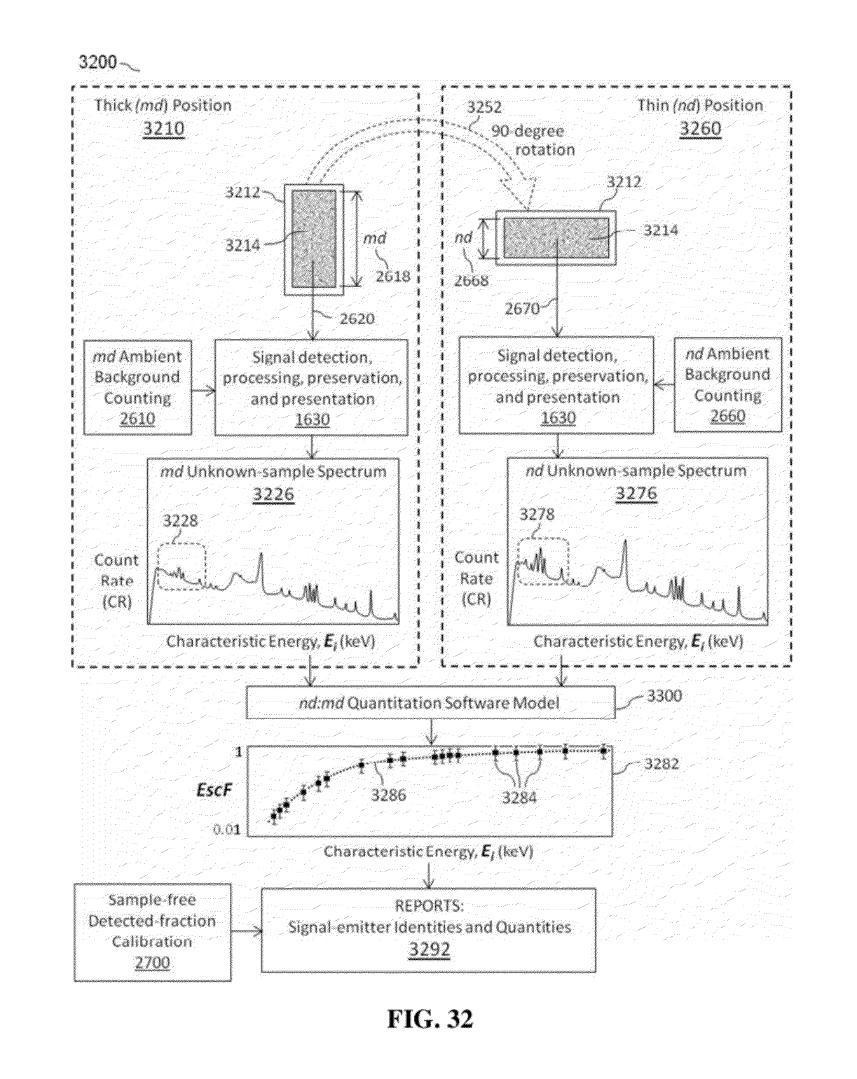

Part 3. “nd:md” Signal-Emitter Quantitation (FIG. 32)

FIG. 32 shows a system setup 3200 for analyzing and quantitating signal emitters in homogenous unknown-samples (“unkn”). A sample 3214, containing unknown signal-emitter identity or quantity, or both, is counted in both the thick (md) 3210 and thin (nd) 3260 counting positions, where the unknown-sample 3214 is placed into the same type of sample-container apparatus 3212 and placed into the same position relative to the detector, as was done to determine the ambient background signal spectra 2622 and 2672 in FIG. 26, and as was done to determine the standard-sample signal spectra 2722 and 2772 in FIG. 27.

In FIG. 32, the unknown-sample mass (Mᵤₙₖₙ) may be computed by Equation [86], where the mass of an empty sample-container apparatus (M_{cntr}) is subtracted from the combined mass of the sample-container apparatus and the unknown-sample (M_{cntr+unkn}), as follows:

Mᵤₙₖₙ=M_{cntr+unkn}−M_{cntr} [86]

It is presumed for this particular discussion that the unknown-sample 3214 is first counted in the thick (md) position 3210 in which the md sample-depth 2618 is in the direction 2620 of the signal detection, processing, preservation, and presentation subsystem 1630. (Note: in the alternative, the operator could have first placed the unknown-sample into the thin (nd) counting position 3260 instead and proceeded accordingly.) Characteristic signals that escape the thick (md) unknown-sample and are registered along with the ambient background signals in subsystem 1630, produce a “thick” gross composite spectrum (not shown).

Once the “thick” gross composite spectrum is obtained after a length of counting time (t_{unkn,md}), the counting is stopped, and the sample-container apparatus 3212 that holds the unknown-sample 3214 is rotated 90 degrees 3252 to the thin (nd) position 3260 such that the nd sample-depth 2668 is in the direction 2670 of subsystem 1630.

After another length of counting time (t_{unkn,nd}) the counting is stopped. Those characteristic signals that escape the thin (nd) sample-depth 2668 and that register, along with the ambient background signals in subsystem 1630, produce a “thin” gross composite spectrum (not shown).

To subtract-out the ambient background emission spectra 2610 and 2660 (in FIG. 26) from corresponding “thick” and “thin” gross composite spectra (not shown), it is convenient to first normalize the counting times of the ambient background emission spectra (t_{bkgd,nd} and t_{bkgd,md}) to the counting times of their corresponding “thick” and “thin” gross unknown-sample spectra (t_{unkn,nd} and t_{unkn,md}). Count-time normalization is usually accomplished by dividing the characteristic peak counts by the counting times to yield a count rate. Count rates are normalized as counts/unit-time, so that they can be compared directly. The characteristic thick (md) position and thin (nd) position ambient background counts (BC_{Ei,nd} and BC_{Ei,md}) are normalized to their respective ambient background count rates (BCR_{Ei,nd} and BCR_{Ei,md}), as follows:

$$\begin{matrix}{BCR}_{Ei , nd} = \frac{{BC}_{Ei , nd}}{{t}_{bkgd , nd}} & [ 86 a ] \\ {BCR}_{Ei , md} = \frac{{BC}_{Ei , md}}{{t}_{bkgd , md}} & [ 86 b ]\end{matrix}$$

The characteristic thick (md) position and thin (nd) position gross unknown-sample counts (GC_{Ei,unkn,nd} and GC_{Ei,unkn,md}) are normalized to their respective gross unknown-sample count rates (GCR_{Ei,unkn,nd} and GCR_{Ei,unkn,md}), as follows:

$$\begin{matrix}{GCR}_{Ei , unkn , nd} = \frac{{GC}_{Ei , unkn , nd}}{{t}_{unkn , nd}} & [ 87 a ] \\ {GCR}_{Ei , stnd , md} = \frac{{GC}_{Ei , unkn , md}}{{t}_{unkn , md}} & [ 87 b ]\end{matrix}$$

The ambient background signals 2610 and 2660 are subtracted from their corresponding “thick” and “thin” unknown-sample gross spectra (not shown) leaving their corresponding net unknown-sample spectra 3226 and 3276.

CR_{Ei,unkn,nd}=GCR_{Ei,unkn,nd}−BCR_{Ei,nd} [88a]

CR_{Ei,unkn,md}=GCR_{Ei,unkn,md}−BCR_{Ei,nd} [88b]

By comparing the net nd and md unknown-sample spectra 3228 and 3278 in FIG. 32, one notices a significant difference in the characteristic peak heights between the peak heights at the low-energy portion of the thick (md) and thin (nd) spectra 3228 and 3278. The highly attenuated peaks of the thick (md) unknown-sample counting 3210 are anticipated because, at low energy, more of the characteristic signals are attenuated when the unknown-sample is counted in the “thick” orientation 2618 relative to the subsystem 1630.

FIG. 32 shows the nd:md Quantitation Software Model 3300 that reads input of the thick and thin spectral peak data and computes, for each useful thick and thin characteristic spectral-peak pair, the discrete characteristic sample-specific escaped-fraction values (EscF_{Ei,unkn,nd} and EscF_{Ei,unkn,md}, but only one set of discrete values is shown 3284); interpolated or fitted sample-specific escaped-fraction functions [EscF(Eᵢ)_{unkn,nd} and EscF(Eᵢ)_{unkn,md}, but only one is shown as the dotted-line 3286]; and signal-emitter identities (Rⱼ) and corresponding specific-activity quantities (SpA_{Rj,unkn}) 3292.

All of the discrete sample-specific escaped-fraction values 3284, taken together, resemble the outline of a curve that spans the energy range of interest (represented by the dotted line 3286). Commonly, a function is fitted to these discrete values 3284 to cover the entire usable energy-detection range of the detection system. The discrete values 3284 and all of the possible fitted values 3286 of the sample-specific escaped-fraction are illustrated together 3282.

The specific-activity quantities (SpA_{Rj,unkn}) within the unknown-sample 3214 are computed from either Equations [89a] or [89b], whichever provides better statistics to the values of the specific-activity quantities, where the subsystem 2700 (in FIG. 27) computes the fitted sample-free detected-fraction calibration function [DetF(Eᵢ)_{smplFr}].

$$\begin{matrix}{SpA}_{Rj , unkn} = \frac{{CR}_{Ei , unkn , nd}}{{M}_{unkn} * {YF}_{Rj , Ei} * {EscF ( {E}_{i} )}_{unkn , nd} * {DetF ( {E}_{i} )}_{smplFr}} & [ 89 a ] \\ {SpA}_{Rj , unkn} = \frac{{CR}_{Ei , unkn , m}}{{M}_{unkn} * {YF}_{Rj , Ei} * {EscF ( {E}_{i} )}_{unkn , md} * {DetF ( {E}_{i} )}_{smplFr}} & [ 89 b ]\end{matrix}$$

Subsystem 3292 aggregates all of the processed data into user-selected or default formats, e.g. comma-separated-value (CSV) list, spreadsheet, computer screen, or other suitable output format.

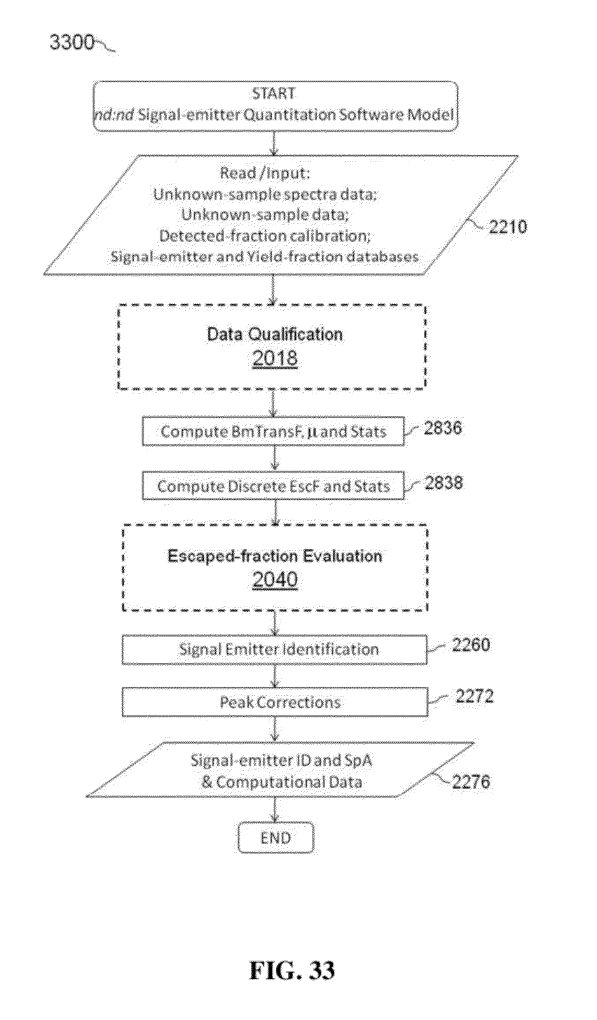

### nd:md Software Model for Signal-Emitter Quantitation (FIG. 33)

FIG. 33 depicts a flowchart of the nd: md Signal Emitter Quantitation Software Model (hereinafter, the “nd:md Quantitation. S/W Model”) 3300, which reads as input 2210 (a) the primary unknown-sample nd and md spectral data, which includes the nd and md characteristic-peak net count rates (CR_{Ei,unkn,nd} and CR_{Ei,unkn,md}); (b) unknown-sample data, e.g. the unknown-sample mass (Mᵤₙₖₙ); (c) the interpolated or fitted sample-free detected-fraction calibration function [DetF(Eᵢ)_{smplFr}]; and (d) signal-emitter (Rⱼ) and yield-fraction (YF_{Rj,Ei}) databases.

The Data Qualification Software Module 2018 (in FIG. 20) identifies those characteristic nd and md peak pairs useful for computing associated values of sample-specific beam-transmitted-fraction values (BmTrnsF_{Ei,unkn,nd} and BmTrnsF_{Ei,unkn,md}) and associated unknown-sample linear attenuation coefficient (μ_{Ei,unkn}) values.

For each characteristic peak pair, software module 2836, then computes the sample-specific beam-transmitted-fraction (BmTrnsF_{Ei,unkn,nd} and BmTrnsF_{Ei,unkn,md}) and the sample-specific linear attenuation coefficient (μ_{Ei,unkn}) values. The count rates for each characteristic-peak pair (or n-tuple of characteristic peaks from n-tuple different sample-depths, should three or more such depths be counted), and other related terms, are shown in the following count-rate balance equations, as follows:

CR_{Ei,unkn,nd}=Mᵤₙₖₙ*SpA_{Rj,unkn}*YF_{Rj,Ei}*EscF_{Ei,unkn,nd}*DetF_{Ei,smplFr,nd} [89c]

CR_{Ei,unkn,md}=Mᵤₙₖₙ*SpA_{Rj,unkn}*YF_{Rj,Ei}*EscF_{Ei,unkn,md}*DetF_{Ei,smplFr,md} [89d]

Equations [89c] and [89d] are two equations in four unknowns. The four unknowns are the two sample-specific escaped-fraction terms (EscF_{Ei,unkn,nd} and EscF_{Ei,unkn,md}), and the two sample-free detected-fraction calibration terms (DetF_{Ei,smplFr,nd} and DetF_{Ei,smplFr,md}). The known terms are the measured nd and md count rates (CR_{Ei,unkn,nd} and CR_{Ei,unkn,md}), the measured standard-sample mass (M_{stnd}), the reported signal emitters (Rⱼ) and their specific-activity quantities (SpA_{Rj,unkn}), and the widely published signal emitter characteristic (Eᵢ) emission yield-fractions (YF_{Rj,Ei}).

To reduce the number of unknowns, the approach is to take the ratio of the nd and md spectral peaks and their count-rate balance Equations [89c] and [89d] to give Equation [90a].

$$\frac{{CR}_{Ei , unkn , nd}}{{CR}_{Ei , unkn , md}} = \frac{{M}_{stnd} * {SpA}_{Rj , unkn} * {YF}_{Rj , Ei} * {EscF}_{Ei , unkn , nd} * {DetF}_{Ei , smplFr , nd}}{{M}_{stnd} * {SpA}_{Rj , unkn} * {YF}_{Rj , Ei} * {EscF}_{Ei , unkn , md} * {DetF}_{Ei , smplFrmd}} \qquad [ 90 a ]$$

Cancelling the equal terms in Equation [90a] leaves one Equation [90b] in four unknowns:

$$\frac{{CR}_{Ei , unkn , nd}}{{CR}_{Ei , unkn , md}} = \frac{{EscF}_{Ei , unkn , nd} * {DetF}_{Ei , smplFr , nd}}{{EscF}_{Ei , ukn , md} * {DetF}_{Ei , smplFr , md}} \qquad [ 90 b ]$$

Although the values of the two sample-free detected-fraction calibration terms (DetF_{Ei,smplFr,nd} and DetF_{Ei,smplFr,md}) are unknown, for the reasons described in the discussion surrounding FIG. 17 and Equations [38a] to [40],

$${DetF}_{Ei , smplFr} = \frac{{CR}_{Ei , unkn , nd}}{{M}_{unkn} * {SpA}_{Rj , unkn} * {Y}_{Rj , Ei} * {EscF}_{Ei , unkn , nd}} = \frac{{CR}_{Ei , unkn , md}}{{M}_{unkn} * {SpA}_{Rj , unkn} * {Y}_{Rj , Ei} * {EscF}_{Ei , unkn , md}} \qquad [ 91 ]$$

Replacing the two terms DetF Ei,smplFr,nd and DetF_{Ei,smplFr,md} in Equation [90b] with the single DetF_{Ei,smplFr} term in Equation [91] allows cancelling the two sample-free detected-fraction calibration terms in Equation [90b] to give:

$$\frac{{CR}_{Ei , unkn , nd}}{{CR}_{Ei , unkn , md}} = \frac{{EscF}_{Ei , unkn , nd}}{{EscF}_{Ei , unkn , md}} \qquad [ 92 ]$$

To solve Equation [92], which is one equation with two unknowns (EscF_{Ei,unkn,nd} and EscF_{Ei,unkn,md}), the two sample-specific escaped-fractions are redefined in terms of the fraction of a characteristic beam that transmits through a unit of sample thickness (d), the unit defined as one centimeter (1 cm), which allows defining a beam-transmitted-fraction BmTrnsF_{Ei,unkn,1cm} through a single centimeter of the standard-sample.

In a preliminary step, two unknowns terms in Equation [92] (EscF_{Ei,unkn,nd and} EscF_{Ei,unkn,md}) are redefined using a single common term, the energy-dependent “linear attenuation coefficient” (μ_{Ei,unkn}), which has the same value for both thick and thin unknown-samples of the same material at a given energy (Eᵢ). Following the reasoning in the discussion surrounding Equations [35a] through [41b], the thick (md) and thin (nd) sample orientations yield, (where d=1 cm):

$$\begin{matrix}{EscF}_{Ei , unkn , n} = \frac{1}{n} {\int }_{0}^{n} {e}^{- μ \cdot x} d x = \frac{1}{μ \cdot n} ( 1 - {e}^{- μ \cdot n} ) & [ 93 a ] \\ {EscF}_{Ei , unkn , m} = \frac{1}{m} {\int }_{0}^{m} {e}^{- μ \cdot x} d x = \frac{1}{μ \cdot m} ( 1 - {e}^{- μ \cdot m} ) & [ 93 b ]\end{matrix}$$

Knowing that a beam through each of the sample-depths (n and m) attenuates according to:

BmTrnsF_{Ei,unkn,n}=e^{-μ·n}=(e^{-μ})ⁿ=(BmTrnsF_{Ei,unkn,1cm})ⁿ [94a]

BmTrnsF_{Ei,unkn,m}=e^{-μ·m}=(e^{-μ})^{m}=(BmTrnsF_{Ei,unkn,1cm})^{m} [94b]

it follows that the linear attenuation per centimeter of thickness (cm⁻¹) of the unknown-sample is:

μ_{Ei,unkn}=−ln(BmTrnsF_{Ei,unkn,1cm}) [95]

Equations [93a] and [93b] can be simplified by substituting the term for a beam through a single centimeter of unknown-sample, BmTrnsF_{Ei,unkn,1cm} which yields:

$$\begin{matrix}{EscF}_{Ei , unkn , n} = \frac{{( {BmTrnsF}_{Ei , unkn , 1 cm} )}^{n} - 1}{n \cdot ln ( {BmTrnsF}_{Ei , unkn , 1 cm} )} & [ 96 a ] \\ {EscF}_{Ei , unkn , m} = \frac{{( {BmTrnsF}_{Ei , unkn , 1 cm} )}^{m} - 1}{m \cdot ln ( {BmTrnsF}_{Ei , unkn , 1 cm} )} & [ 96 b ]\end{matrix}$$

Then substituting the right-side terms in Equations [96a] and [96b] into Equation [92], and reducing terms:

$$\frac{{CR}_{Ei , unkn , n}}{{CR}_{Ei , unkn , m}} = \frac{m}{n} * \frac{[ {( {BmTrnsF}_{Ei , unkn , 1 cm} )}^{n} - 1 ]}{[ {( {BmTrnsF}_{Ei , unkn , 1 cm} )}^{m} - 1 ]} \qquad [ 97 ]$$

Equation [97] rearranges to:

$$[ \frac{{CR}_{Ei , unkn , n}}{{CR}_{Ei , unkn , m}} ] {( {BmTrnsF}_{Ei , unkn , 1 cm} )}^{m} - [ \frac{m}{n} ] {( {BmTrnsF}_{Ei , unkn , 1 cm} )}^{n} + [ \frac{m}{n} - \frac{{CR}_{Ei , unkn , n}}{{CR}_{Ei , unkn , m}} ] = 0 \qquad [ 98 ]$$

The only unknown in Equation [98] is the beam-transmitted-fraction through a unit (1 cm) of unknown-sample-depth (BmTrnsF_{Ei,unkn,1cm}), which is easily solved numerically by computer.

Although not required to be known to quantify the signal emitters of interest, there may nonetheless be an interest to know the standard-sample energy-specific linear attenuation coefficient (μ_{Ei,unkn}). Once the value of BmTrnsF_{Ei,unkn,1cm} is known from Equation [98], Equation [95] is used to compute the value of the linear attenuation coefficient (μ_{Ei,unkn}) for the unknown-sample composition.

Another software module 2838 (in FIG. 28) calls as inputs the count rates of the characteristic peak pairs and the corresponding characteristic values of BmTrnsF_{Ei,unkn,1cm}, and computes the associated sample specific escaped-fraction values (EscF_{Ei,unkn,nd} and EscF_{Ei,unkn,md}) using Equations [96a] and [96b].

Only one set of values for the discrete sample-specific escaped-fraction values 3284 is illustrated in FIG. 32 (either EscF_{Ei,unkn,nd} or EscF_{Ei,unkn,md}), because, by looking at Equations [99a] and [99b], it is seen that, although both equations determine the signal-emitter quantities (SpA_{Rj,unkn}), only one is needed, and the logical choice is the expression that leads to the better statistics for SpA_{Rj,unkn}.

$$\begin{matrix}{SpA}_{Rj , unkn} = \frac{{CR}_{Ei , unkn , nd}}{{M}_{unkn} * {YF}_{Rj , Ei} * {EscF ( {E}_{i} )}_{unkn , nd} * {DetF ( {E}_{i} )}_{smplFr}} & [ 99 a ] \\ {SpA}_{Rj , unkn} = \frac{{Cr}_{Ei , unkn , md}}{{M}_{unkn} * {YF}_{Rj , Ei} * {EscF ( {E}_{i} )}_{unkn , md} * {DetF ( {E}_{i} )}_{smplFr}} & [ 99 b ]\end{matrix}$$

The Escaped-fraction Evaluation Software Module 2040 (in FIG. 20) evaluates and processes the useful discrete sample-specific escaped-fraction values 3284 (in FIG. 32) and uncertainties for determining a sample-specific escaped-fraction function or interpolated curve 3286 (the dotted-line in FIG. 32) and computes the fitted, sample-specific escaped-fraction functions [EscF(Eᵢ)_{unkn,nd} and EscF(Eᵢ)_{unkn,nd}].

Another software module 2260 searches databases for known signal emitters (Rⱼ) and their characteristic (Eᵢ) yield-fractions (YF_{Rj,Ei}) that match the spectral peaks arising from unknown-samples. Spectrum analysis is performed, and the signal emitters are identified (Rⱼ) along with their yield-fractions (YF_{Rj,Ei}).

Another software module 2272 computes the specific-activity quantities (SpA_{Rj,unkn}) of the identified signal emitters and their associated uncertainties using Equations [99a] and [99b], to solve for the signal-emitter specific-activity quantities (SpA_{Rj,unkn}), and, with the interpolated or fitted sample-specific escaped-fraction functions EscF(Eᵢ)_{unkn,nd} and EscF(Eᵢ)_{unkn,md} used in place of the discrete-value terms (EscF_{Ei,unkn,nd} and EscF_{Ei,unkn,md}), as follows:

$$\begin{matrix}{SpA}_{Rj , unkn} = \frac{{C}_{Ei , unkn , nd}}{{M}_{unkn} * {YF}_{Rj , Ei} * {EscF ( {E}_{i} )}_{unkn , nd} * {DetF ( {E}_{i} )}_{smplFr} * {t}_{unkn , nd}} & [ 99 c ] \\ {SpA}_{Rj , unkn} = \frac{{C}_{Ei , unkn , md}}{{M}_{unkn} * {YF}_{Rj , Ei} * {EscF ( {E}_{i} )}_{unkn , md} * {DetF ( {E}_{i} )}_{smplFr} * {t}_{unkn , md}} & [ 99 d ]\end{matrix}$$

In some cases, operators choose to use the discrete values of the sample-specific escaped-fraction terms (EscF Ei,unkn,nd and EscF Ei,unkn,md) in Equations [99c] and [99d] in place of the fitted sample-specific escaped-fraction functions [EscF(Eᵢ)_{unkn,nd}] and [EscF(Eᵢ)_{unkn,nd}].

Software module 2272 also ‘flags’ which of the two expressions for the specific-activity quantities in Equations [99c] and [99d] provides the specific-activity having the better statistics.

Software module 2276 aggregates all of the data acquired from each of the other software modules in the nd:md Quantitation Software Model 2200 into user-selected or default formats, e.g. comma-separated-value (CSV) list, spreadsheet, computer screen, or other suitable output format.

The mathematical laws of error analysis are computed as appropriate alongside the mathematical operations on the values of the terms comprising the count rate balance Equations [89c] and [89d]; thus, the terms will have the form v±Δv, where v represents the numerical value of a particular term in Equations [89c] and [89d], and ±Δv is the uncertainty in v.

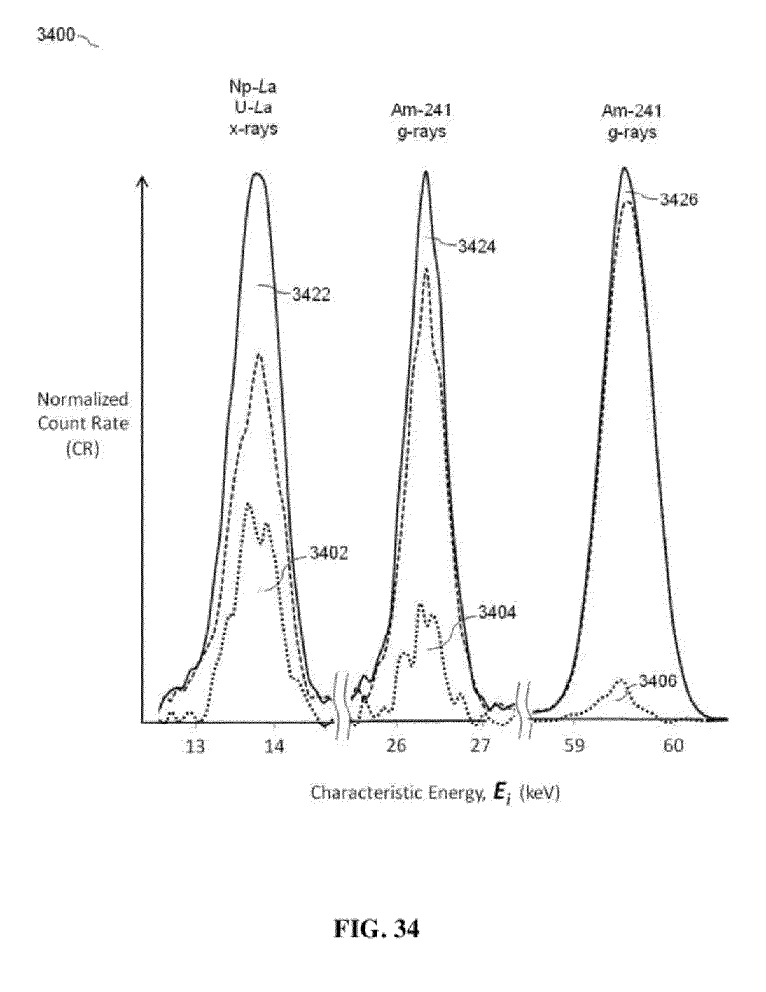

### Experimental nd and md Soil-Thickness Spectral Peaks (FIG. 34)

Count rates can be compared directly. FIG. 34 shows a graph 3400 of genuine experimental data from an actual prototype of an nd: md two-thickness analysis and quantitation of radioisotopes in about 1.3 grams of an unknown-sample (unkn) of contaminated soil labeled, “Soil-B”. Soil-B was placed into a two-thickness sample-container apparatus (“cuvette”) like that shown in FIGS. 25A through 25D, 26 and 27, where md≈0.958 cm, and nd≈0.412 cm. Thus, the ratio of the thin:thick depths is about nd:md≈0.43≈3:7.

The cuvette forms the unknown-sample into two different depths (nd and md) with respect to the detection system when each upright side, in turn, faces the detector. Graph 3400 shows three characteristic spectral peaks emitted from Soil-B. The three characteristic spectral peak pairs are primarily composed of neptunium (Np) and uranium (U) L-shell x-rays at about 14 keV 3402, americium-241 (Am-241) gamma-rays (g-rays) at 26.5 keV 3404, and Am-241 gamma-rays at 59.5 keV 3406. Three characteristic spectral traces are shown in FIG. 34 (upper solid-line, middle dashed-line, and lower dotted-line). The upper solid-line spectral trace is the characteristic (Eᵢ) count rate (CR_{Ei,SoilB,nd}) from the thin (nd) Soil-B position like that shown in 3260 (in FIG. 32). The middle dashed-line spectral trace is the characteristic count rate (CR_{Ei,SoilB,md}) from the thick (md) Soil-B position like that shown in 3210 (in FIG. 32).

At the higher signal emission energy, signals escape the thin and thick sample fairly easily, and the thin and thick peak count rates nearly equal each other 3426. As the peak energy decreases, the thick (md) sample self-attenuates faster than does the thin (nd) sample. Relative to the thin-spectrum count rate (CR_{Ei,SoilB,nd}), the thick-spectrum count rate (CR_{Ei,SoilB,md}) shows a rapidly degenerating peak height with decreasing characteristic energy (Eᵢ), because the thicker sample self-attenuates more characteristic signals. The lower dotted-line spectral trace is the difference spectrum (diff) between the thin and thick spectral count rates for each respective characteristic peak, as follows:

CR_{Ei,SoilB,diff}=CR_{Ei,SoilB,nd}−CR_{Ei,SoilB,md} [100]

Thus, three spectral traces are partially shown: the thin (nd) spectral trace (CR_{Ei,SoilB,nd}) represented by the uppermost, solid lines of all three peaks; the thick (md) spectral trace (CR_{Ei,SoilB,md}) represented by the middle, dashed lines of all three peaks; and the difference (diff) spectral trace (CR_{Ei,SoilB,diff}), represented by the lowest, dotted lines of all three peaks. FIG. 34 shows that, as the characteristic energy increases, the difference spectrum diminishes. At 14 keV, the difference peak 3402 is quite large; at 26.5 keV, the difference peak 3404 is smaller; and at 59.5 keV, the difference peak 3406 is smallest yet, but still easily observable. Although the difference (diff) peaks shown in FIG. 34 are all less than their associated thick (md) sample peaks, such may not always be the case and partly depends on the severity of the sample self-attenuation.

One benefit of plotting the difference (diff) spectrum is that it shows the operator which characteristic peaks require sample self-attenuation correction. If there is a noticeable difference (diff) peak, then both the thin (nd) and thick (md) peaks should be corrected for sample self-attenuation. The graph of the difference (diff) peaks 3400 shows that all three peaks 3402, 3404, and 3406 need sample self-attenuation corrections. Had the Soil-B samples been thicker, then larger attenuation corrections would be needed. In fact, nd: md apparatuses, methods, software and systems make such corrections to the thin (nd) and thick (md) sample self-attenuations possible at all characteristic signal energies.

FIG. 34 shows that, for genuine experimental data from a soil sample, as the characteristic signal energy increases, the thin (nd) and thick (md) peak count-rates 3422, 3424, and 3426 approach equality (CR_{Ei,SoilB,md}→CR_{Ei,SoilB,nd}) as Eᵢ increases, because sample self-attenuation decreases with increasing characteristic energy.

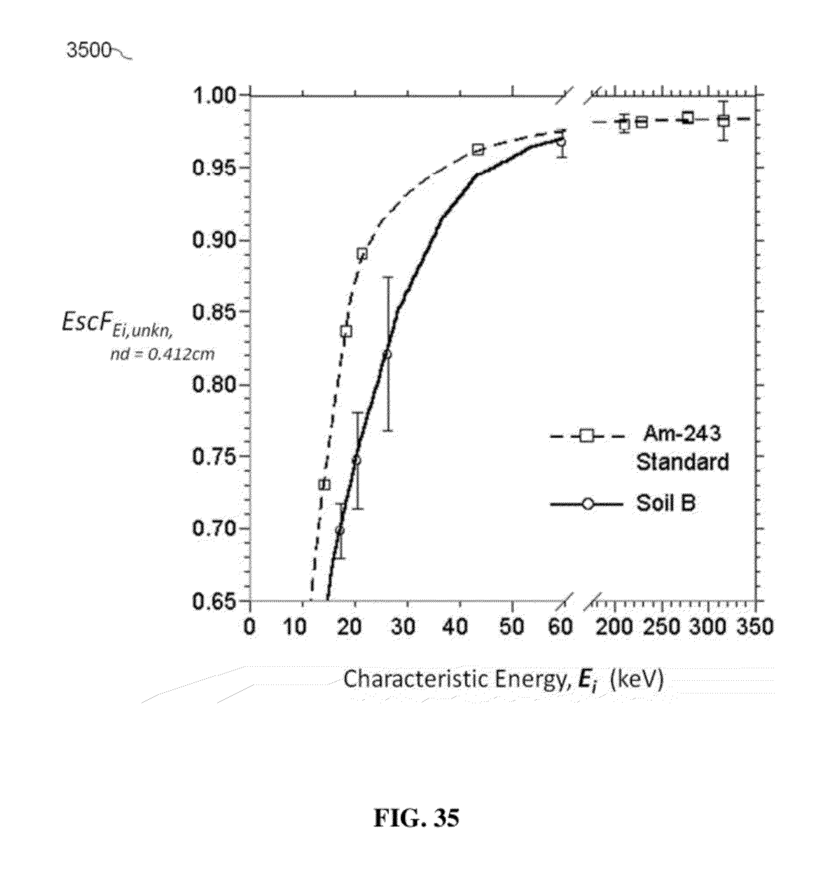

### Experimental nd:md Soil EscF Result (FIG. 35)

FIG. 35 shows a graphic comparison 3500 between the characteristic nd sample-specific escaped-fractions (EscF_{Ei,Am243,nd}) for the aqueous Am-243 standard-sample of FIG. 30 and the characteristic nd sample-specific escaped-fractions (EscF Ei,SoilB,nd) for the Soil-B unknown-sample. Graph 3500 shows that sample self-attenuation is greater in the Soil-B unknown-sample than in the aqueous Am-243 standard-sample, as expected, as the elemental atomic number of the Soil-B unknown-sample is higher than that of the aqueous Am-243 standard-sample, and therefore, the cross-section for attenuation is higher in Soil-B. The significance of Graph 3500 is that it demonstrates that the nd:md apparatuses, methods, software, and systems, working together, determine the extent of sample self-attenuation in an experimental individual homogeneous sample, via sample-specific escaped-fraction.

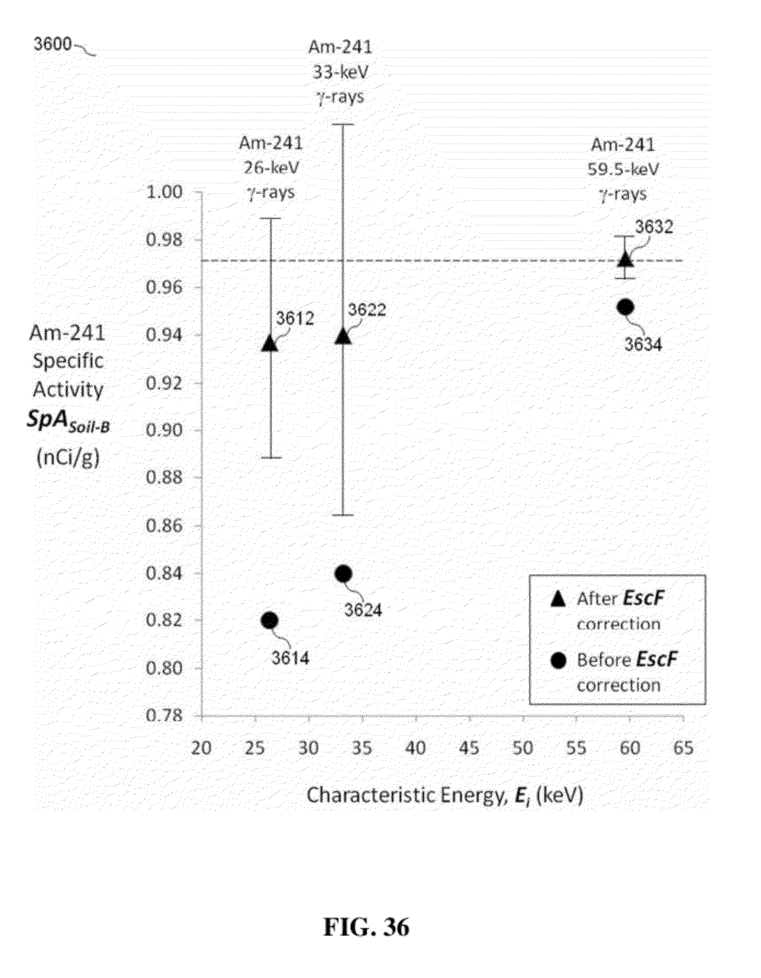

### Experimental nd:md Signal Emitter Quantitation (FIG. 36)

Now that the characteristic nd sample-specific escaped-fraction (EscF Ei,SoilB,nd) values for the Soil-B unknown-sample have been determined, and the fitted sample-free detected-fraction calibration function [DetF(Eᵢ)_{smplFr}] has been computed, Equations [99a] and [99b] are used to compute the specific-activity quantities of Am-241 (SpA_{Rj,Am241}) identified in Soil-B. FIG. 36 shows the “before” (solid circles) and “after” (solid triangles) results 3600 of the uncorrected (prior art) versus corrected (nd:md self-attenuation corrections) quantitation made on three Am-241 signal peaks from the 1.3-gram sample of Soil-B.

Without the nd:md self-attenuation corrections, the specific activity quantity of Am-241 would be reported as 0.82 nCi/g 3614, based on the 26 keV gamma-ray; 0.84 nCi/g 3624, based on the 33 keV gamma-ray; and 0.95 nCi/g 3634, based on the 59.5 keV gamma-ray. Thus, the lower the characteristic signal energy, the higher the error becomes.

However, when the nd: md self-attenuation correction factors are determined, a 14% increase in the specific activity quantity of Am-241 is reported as 0.935 nCi/g 3612 at 26 keV; a 12% increase is reported as 0.94 nCi/g 3622 at 33 keV; and a 2% increase is reported as 0.97 nCi/g 3632 at 59.5 keV. The error bars for the nd:md-corrected gamma-ray lines are also shown in Graph 3600 and indicate that all three gamma-ray lines are consistent with an Am-241 quantity between 0.96 and 0.98 nCi/g. In contrast, before the nd: md corrections, the 26 keV 3614 and 33 keV 3624 gamma-ray lines “disagree” with the 59.5 keV 3634 gamma-ray line.

Without the nd:md attenuation corrections demonstrated above, all three Am-241 gamma-ray lines would have led to radioactivity under-reporting. Had the Soil-B sample-depth been thicker or the measured spectral peak energies been lower, the radioactivity under-reporting would have been even worse.

II. The “sum-and-diff” Statistical Improvement

### Overview

For the “1d:2d” and “nd: md” techniques previously disclosed, various sample-depth orientations were counted, and, all other things being equal, usually the thin (nd) depth provided the spectral peaks (CR_{Ei,smpl,nd}) of the best statistics, which makes them the most useful for computing the sample-free detected-fraction calibration (DetF_{Ei,smplFr,nd}) and the specific-activity quantitation (SpA_{Rj,unkn,nd}). Thus, the best statistics were based on counting time of only one depth, out of a pair or n-tuple set of counting times, depending on the number of n-tuple sample-depths counted. The sum-and-diff method teaches a way to combine the counting statistics of all depth orientations to “capture back” much of the total counting time and thus improve the counting statistics over that of any single characteristic peak arising from a single sample-depth counting.

The sum-and-diff method can be extended to combine all of the countings of a sample through several different sample-depths. For simplicity, the discussion that follows teaches the combining of two different counting times (t_{smpl,n} and t_{smpl,m}), each through a different sample-depth (n and m), where one desires to take advantage of the total counting time to improve the statistics of the signal-detection-efficiency calibration and signal-emitter specific-activity quantities.

t_{smpl,tot}=t_{smpl,n}+t_{smpl,m} [101]

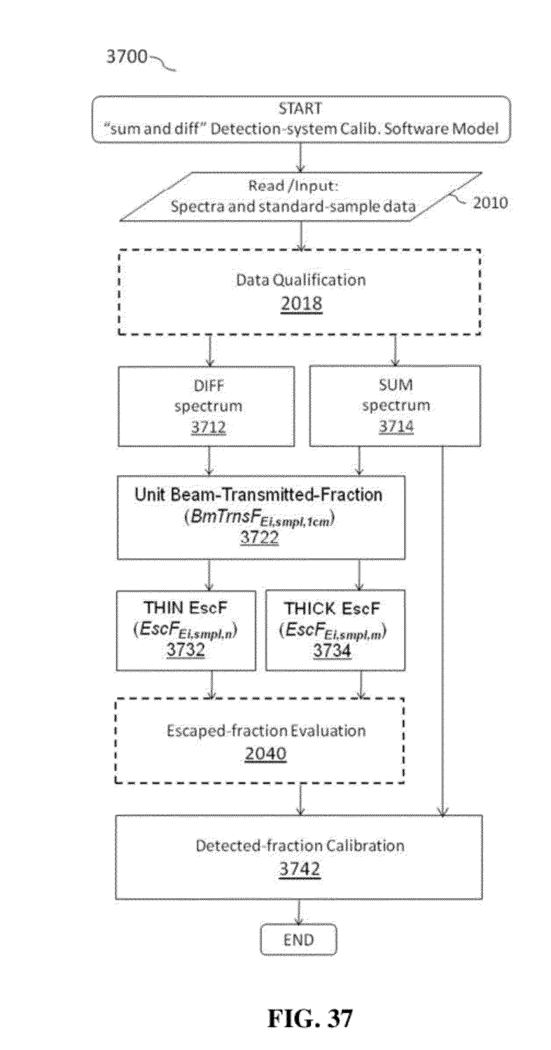

“sum-and-diff” Detection System Calib. Software Model (FIG. 37)

FIG. 37 shows the flowchart 3700 for counting through at least two different sample-depths (nd and md, where 0<n<m) of a standard-sample (“stnd”) for the purpose of computing the detection system sample-free detected-fraction (DetF_{Ei,smplFr}) calibrations for each of the two or more sample-to-detector orientations.

For the sake of simplifying the earlier 1d:2d and nd:md techniques, all counting times for each thickness were presumed to be identical to one another. In this teaching (sum-and-diff techniques), the equations will keep independent track of the counting times, allowing them to be different time periods for each counting of a single sample-depth.

For the same reasons described in the discussion surrounding Equations [75a] through [75f], the following equation is restated without reprinting the previous rationale, which is the same here:

DetF_{Ei,smplFr,n}=DetF_{Ei,smplFr,m}=DetF_{Ei,smplFr} [102]

Using Equation [102] for counting emitted signals of a sample that is shaped into two different thicknesses (nd and md) and counted in exactly two sample-to-detector orientations, the count-balance equations that count standard-samples (stnd) that are used to calibrate the detection system signal-detection efficiency, are as follows:

C_{Ei,stnd,n}=M_{stnd}*SpA_{Rj,stnd}*YF_{Rj,Ei}*EscF_{Ei,stnd,n}*DetF_{Ei,smplFr}*t_{stnd,n} [103a]

C_{Ei,stnd,m}=M_{stnd}*SpA_{Rj,stnd}*YF_{Rj,Ei}*EscF_{Ei,stnd,m}*DetF_{Ei,smplFr}*t_{stnd,m} [103b]

In FIG. 37, software model 3712 subtracts the thick (md) peak counts (C_{Ei,stnd,m}) from the thin (nd) peak counts (C_{Ei,stnd,n}), to arrive at the difference (diff) peak counts (C_{Ei,stnd,diff}), as follows:

$$\begin{matrix} {C}_{Ei , stnd , diff} = {C}_{Ei , stnd , n} - {C}_{Ei , stnd , m} & [ 104 a ] \\ {C}_{Ei , stnd , diff} = ( {M}_{stnd} * {SpA}_{Rj , stnd} * {YF}_{Rj , Ei} * {DetF}_{Ei , smplFr} ) [ ( {EscF}_{Ei , stnd , n} * {t}_{stnd , n} ) - ( {EscF}_{Ei , stnd , m} * {t}_{stnd , m} ) ] & [ 104 b ]\end{matrix}$$

Software model 3714 sums the thick (md) peak counts (C_{Ei,stnd,m}) and the thin (nd) peak counts (C_{Ei,stnd,n}) to arrive at the sum (sum) peak counts (C_{Ei,stnd,sum}) as follows:

$$\begin{matrix} {C}_{Ei , sum} = {C}_{Ei , n} + {C}_{Ei , m} & [ 105 a ] \\ {C}_{Ei , stnd , sum} = ( {M}_{stnd} * {SpA}_{Rj , stnd} * {YF}_{Rj , Ei} * {DetF}_{Ei , smplFr} ) [ ( {EscF}_{Ei , stnd , n} * {t}_{stnd , n} ) + ( {EscF}_{Ei , stnd , m} * {t}_{stnd , m} ) ] & [ 105 b ]\end{matrix}$$

Software module 3722 processes the sum and duff peak counts to compute the beam-transmitted-fraction through a unit of standard-sample thickness (BmTrnsF_{Ei,stnd,1cm}) and computes the standard-sample characteristic linear attenuation coefficient (μ_{Ei,stnd}) values.

The software model takes the ratio of the diff peaks to the sum peaks using Equations [104b] and [105b], and eliminates common factors to obtain:

$$\frac{{C}_{Ei , stnd , diff}}{{C}_{Ei , stnd , sum}} = \frac{( {EscF}_{Ei , stnd , n} * {t}_{stnd , n} ) - ( {EscF}_{Ei , stnd , m} * {t}_{stnd , m} )}{( {EscF}_{Ei , stnd , n} * {t}_{stnd , n} ) + ( {EscF}_{Ei , stnd , m} * {t}_{stnd , m} )} \qquad [ 106 a ]$$

Equation [106a] is one equation in two unknowns (EscF_{Ei,stnd,n} and EscF_{Ei,stnd,m}), and the prior teaching previously defined both of them in terms of attenuation through a single centimeter (1 cm) of standard-sample (BmTrnsF_{Ei,stnd,1cm}) in Equations [80a] and [80b]. The same approach is taken here, as follows:

$$\frac{{C}_{Ei , stnd , diff}}{{C}_{Ei , stnd , sum}} = \frac{\begin{matrix}{t}_{stnd , n} * [ \frac{{( {BmTrnsF}_{Ei , stnd , 1 cm} )}^{n} - 1}{n * ln ( {BmTrnsF}_{Ei , stnd , 1 cm} )} ] - \\ {t}_{stnd , m} * [ \frac{{( {BmTrnsF}_{Ei , stnd , 1 cm} )}^{m} - 1}{m * ln ( {BmTrnsF}_{Ei , stnd , 1 cm} )} ]\end{matrix}}{\begin{matrix}{t}_{stnd , n} * [ \frac{{( {BmTrnsF}_{Ei , stnd , 1 cm} )}^{n} - 1}{n * ln ( {BmTrnF}_{Ei , stnd , 1 cm} )} ] + \\ {t}_{stnd , m} * [ \frac{{( {BmTrnsF}_{Ei , stnd , 1 cm} )}^{m} - 1}{m * ln ( {BmTrnF}_{Ei , stnd , 1 cm} )} ]\end{matrix}} \qquad [ 106 b ]$$

Finding common denominators gives:

$$\frac{{C}_{Ei , stnd , diff}}{{C}_{Ei , stnd , sum}} = \frac{\begin{matrix}{t}_{stnd , n} * \{ \frac{m * {( {BmTrnsF}_{Ei , stnd , 1 cm} )}^{n} - 1}{m * n * ln ( {BmTrnsF}_{Ei , stnd , 1 cm} )} \} - \\ {t}_{stnd , m} * \{ \frac{n * {( {BmTrnsF}_{Ei , stnd , 1 cm} )}^{m} - 1}{n * m * ln ( {BmTrnsF}_{Ei , stnd , 1 cm} )} \}\end{matrix}}{\begin{matrix}{t}_{stnd , n} * \{ \frac{m * [ {( {BmTrnsF}_{Ei , stnd , 1 cm} )}^{n} - 1 ]}{m * n * ln ( {BmTrnF}_{Ei , stnd , 1 cm} )} \} + \\ {t}_{stnd , m} * \{ \frac{n * {( {BmTrnsF}_{Ei , stnd , 1 cm} )}^{m} - 1}{n * m * ln ( {BmTrnF}_{Ei , stnd , 1 cm} )} \}\end{matrix}} \qquad [ 106 c ]$$

Cancelling terms gives:

$$\frac{{C}_{Ei , stnd , diff}}{{C}_{Ei , stnd , sum}} = \frac{\begin{matrix}{t}_{stnd , n} * m * [ {( {BmTrnsF}_{Ei , stnd , 1 cm} )}^{n} - 1 ] - \\ {t}_{stnd , m} * n * [ {( {BmTrnsF}_{Ei , stnd , 1 cm} )}^{m} - 1 ]\end{matrix}}{\begin{matrix}{t}_{stnd , n} * m * [ {( {BmTrnsF}_{Ei , stnd , 1 cm} )}^{n} - 1 ] + \\ {t}_{stnd , m} * n * [ {( {BmTrnsF}_{Ei , stnd , 1 cm} )}^{m} - 1 ]\end{matrix}} \qquad [ 106 d ]$$

Equation [106d] is rearranged into standard form for polynomial equations, to solve for the only unknown, (BmTrnsF_{Ei,stnd,1cm}):

A*(BmTrnsF_{Ei,stnd,1cm})ⁿ+B*(BmTrnsF_{Ei,stnd,1cm})^{m}−C=0 [107a]

where A, B, and C are coefficients, such that:

$$\begin{matrix} A = {t}_{stnd , n} * m * ( \frac{{C}_{Ei , stnd , diff}}{{C}_{Ei , stnd , sum}} - 1 ) & [ 107 b ] \\ B = {t}_{stnd , m} * n * ( \frac{{C}_{Ei , stnd , diff}}{{C}_{Ei , stnd , sum}} + 1 ) & [ 107 c ] \\ C = [ {t}_{stnd , n} * m * ( \frac{{C}_{Ei , stnd , diff}}{{C}_{Ei , stnd , sum}} - 1 ) + {t}_{stnd , m} * n * ( \frac{{C}_{Ei , stnd , diff}}{{C}_{Ei , stnd , sum}} + 1 ) ] & [ 107 d ]\end{matrix}$$

The only unknown in Equation [107a] is the beam-transmitted-fraction through a 1-cm “slab” of the standard-sample (BmTrnsF_{Ei,stnd,1cm}), which is easily solved numerically by computer.

Although not required to be known to quantify the signal emitters of interest, there may nonetheless be an interest to knowing the standard-sample energy-specific linear attenuation coefficient (μ_{Ei,stnd}). Once the value of BmTrnsF_{Ei,stnd,1cm} is known from Equations [107a] through [107d], Equation [79] is used to compute the value of the linear attenuation coefficient (μ_{Ei,stnd}) for the standard-sample.

Software module 3732 computes the thin (n) sample-specific escaped-fraction (EscF_{Ei,stnd,n}) using Equation [80a], and software module 3734 computes the thick (m) sample-specific escaped-fraction (EscF_{Ei,stnd,m}) using Equation [80b].

Software module 2040 (in FIG. 20) evaluates the usability of the computed sample-specific escaped-fraction sets of values (EscF_{Ei,stnd,n} and EscF_{Ei,stnd,m}), and fits functions to each of such usable sets of values, [EscF(Eᵢ)_{stnd,n} and EscF(Eᵢ)_{stnd,m}].

Software module 2058 (in FIG. 20) computes the sample-free detected-fraction calibration discrete values (DetF_{Ei,smplFr}) by re-arranging the terms of Equation [105b], which yields:

$${DetF}_{Ei , smplFr} = \frac{{C}_{Ei , stnd , sum}}{\begin{matrix}( {M}_{stnd} * {SpA}_{Rj , stnd} * {YF}_{Rj , Ei} ) * \\ \{ [ {EscF ( {E}_{i} )}_{stnd , n} * {t}_{stnd , n} ] + [ EscF {( {E}_{i} )}_{stnd , m} * {t}_{stnd , m} ] \}\end{matrix}} \qquad [ 108 ]$$

Software module 2058 (in FIG. 20) also fits the sample-free detected-fraction calibration discrete values (DetF_{Ei,smplFr}) to a calibration function, [DetF(Eᵢ)_{Ei,smplFr}].

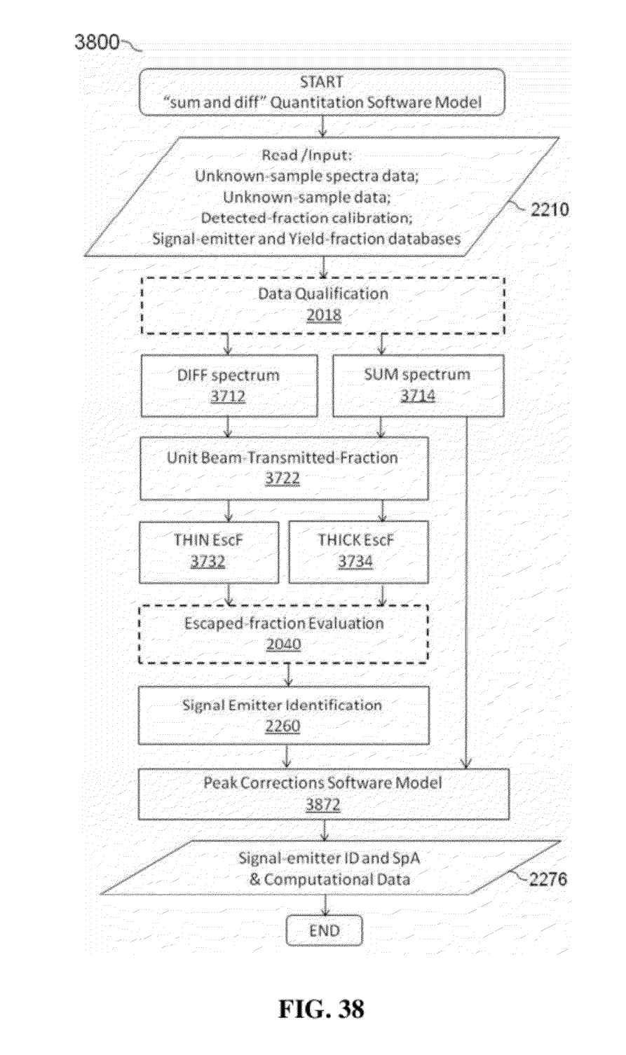

“sum-and-diff” Software Model for Quantitation (FIG. 38)

The sum-and-cliff method to process the spectral peaks can also be applied to the analysis and quantitation of signal emitters within homogenous unknown-samples (unkn). FIG. 38 shows the flowchart for software model 3800 for computing an improvement in counting statistics. Here, the Peak Corrections Software Module 3872 corrects the peak counts for losses, by re-arranging the terms of Equation [105b] to solve for the signal-emitter specific-activity quantities, as follows:

$${SpA}_{Rj , stnd} = \frac{{C}_{Ei , unkn , sum}}{\begin{matrix}[ {M}_{unkn} * {YF}_{Rj , Ei} * {DetF ( {E}_{i} )}_{Ei , smplFr} ] * \\ \{ [ {EscF ( {E}_{i} )}_{unkn , n} * {t}_{unkn , n} ] + [ {EscF ( {E}_{i} )}_{unkn , m} * {t}_{unkn , m} ] \}\end{matrix}} \qquad [ 109 ]$$

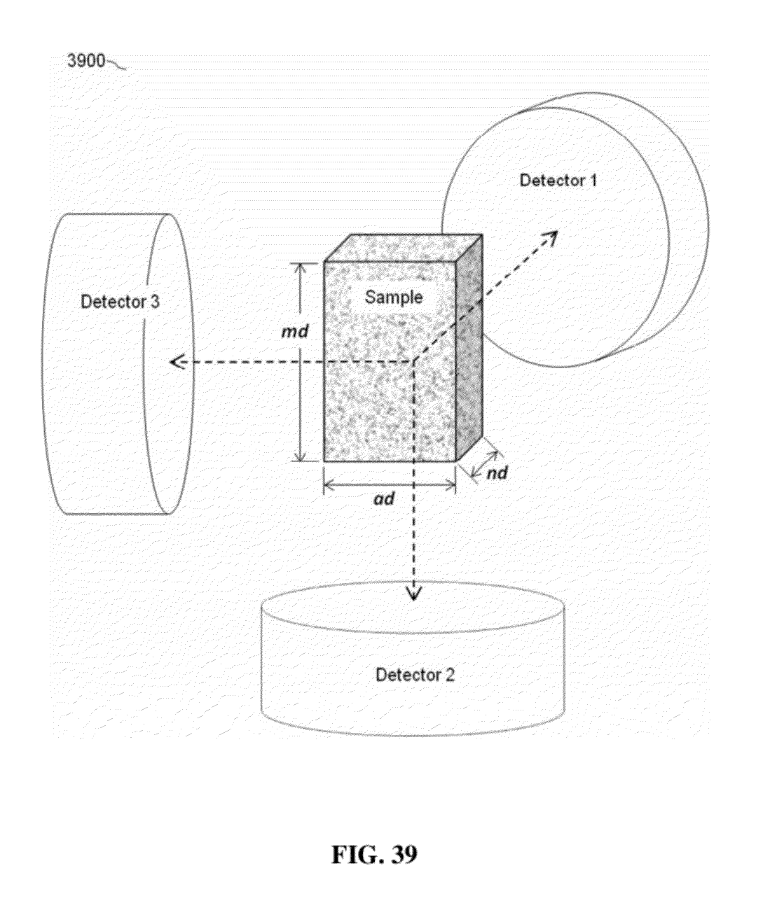

### nd:md Multi-Detector Sample Counting (FIG. 39)

FIG. 39 shows an apparatus 3900 comprised of a configuration of multiple detectors in which at least two different sample thicknesses are being observed by at least two detectors simultaneously. In the apparatus 3900 shown, there are three detectors, and each detector is looking through a different sample-depth, a thin (nd) depth, an intermediate (ad) depth, and a thick (md) depth, where:

0<n<a<m [110]

Although apparatus 3900 shows only three detectors for the rectangular cuboid-shaped sample, such apparatus could have e.g. six detectors: two detectors on opposite sides of the sample in each of three pre-determined, special dimensions at right angles (i.e. 90 degrees) to each other, where the direction of each detector is perpendicular to one of the sample surfaces for the particular sample-position-shape, with respect to the setup of the three detectors, as shown in FIG. 39. Other apparatuses could accommodate virtually any sample shape and could have a number of detectors surrounding it at various angles to each other and to the sample.

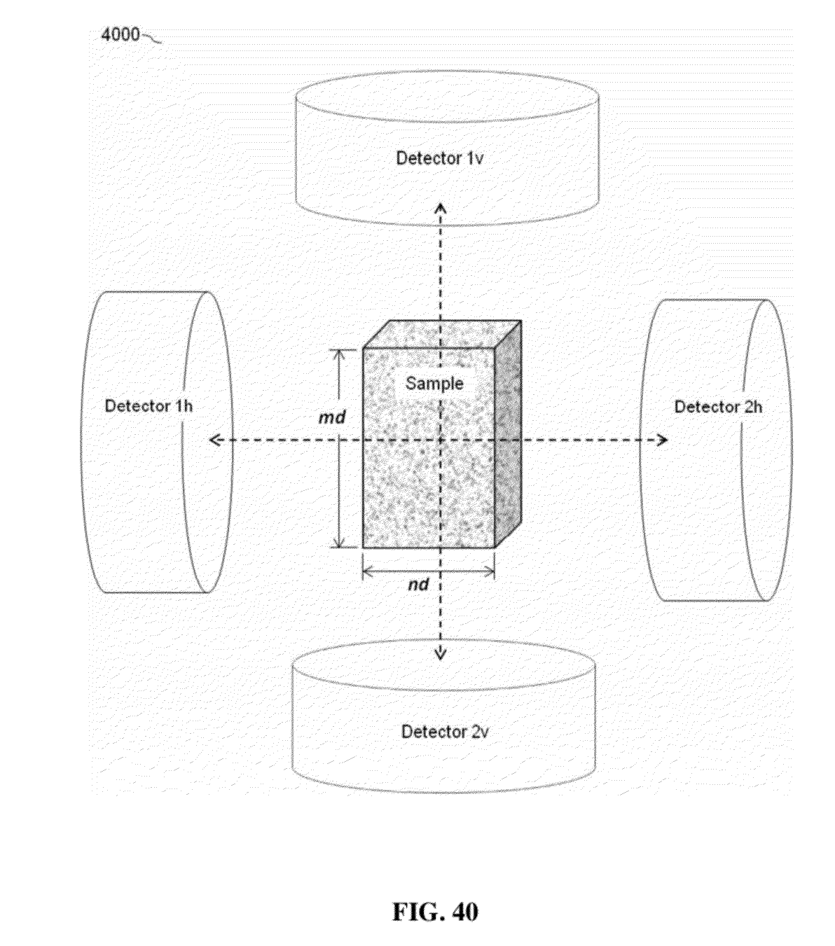

### nd:md Multi-Detector Sample-Homogeneity Confirmation (FIG. 40)

FIG. 40 shows an apparatus 4000, comprised of two pairs of opposing signal detectors, with each detector of a pair directly across from the other, on opposite sides of the sample; or, alternatively, by one or more signal detectors moved into different positions on opposite sides of the sample. Each opposing detector “pair” is looking through a different sample thickness. This particular arrangement, i.e. with opposing detectors on opposite sides of the sample, helps to determine whether or not the sample is homogeneous. If both opposing detectors and their detection system report equal corrected characteristic peak count rates, then such a result is consistent with a homogeneous sample.

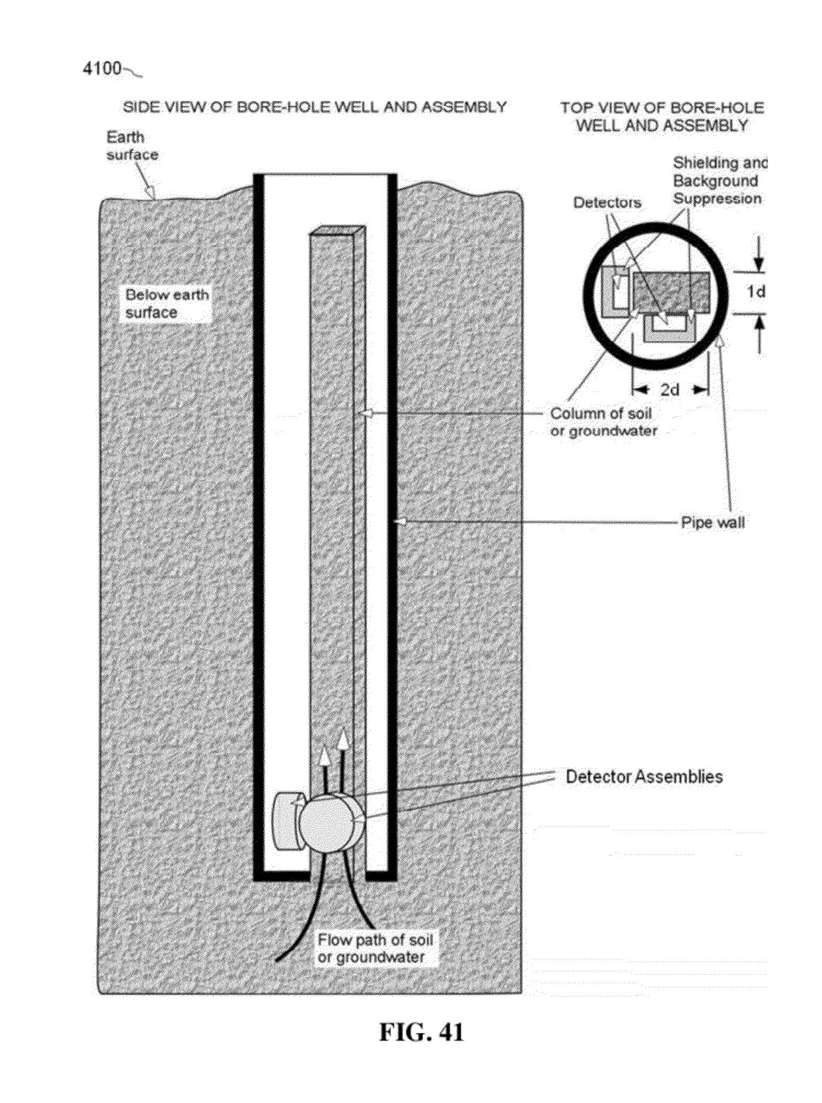

### nd:md Real-Time Sample Flow Measurement (FIG. 41)

FIG. 41 shows an apparatus 4100 comprised of at least two signal detectors facing in two orthogonal directions (i.e. at 90-degree angles to one another), just outside of a pipe of rectangular cross-section. If the sample inside the pipe were stationary, then the detectors could be moved along the pipe in discrete steps or in a continuous motion, and, thus, the nd: md techniques can be used to determine the sample attenuation of the signals emitted from the sample inside the pipe. This technique can also be used to calibrate a detection system signal-detection-efficiency if a standard-sample fills a pipe of similar dimension and composition; or the technique can be used to determine the specific-activity quantities of signal emitters within an unknown-sample inside the pipe. Alternatively, if the sample were flowing continuously through the pipe, then the signal detectors could remain stationary, and the nd:md techniques can be used to continuously analyze the unknown-sample self-attenuation and signal-emitter content over a length of time.

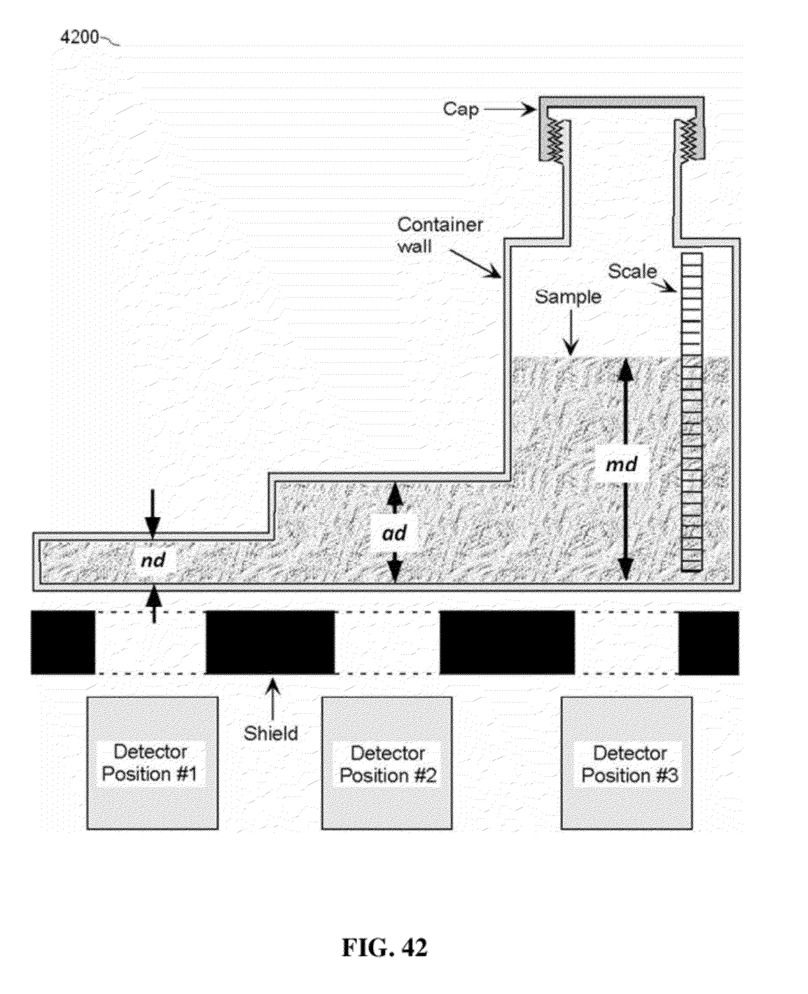

### nd:ad:md Multi-Level Sample-Container Apparatus (FIG. 42)

FIG. 42 shows an apparatus 4200 comprised of three signal detectors in three different positions simultaneously taking spectral measurement through three different sample thicknesses (nd, ad, and md, where 0<n<a<m) of a multi-level sample-container apparatus. An optional collimating shield restricts the volume of sample “seen” by a given signal detector. Alternatively, all three sample-depths can be counted, one at a time, using a single detector that moves from one position to the next; or, alternatively, a stationary detector remains in a single position as the sample-container apparatus moves into position over a collimator opening, where the sample-container apparatus pauses at each opening for a length of counting time.

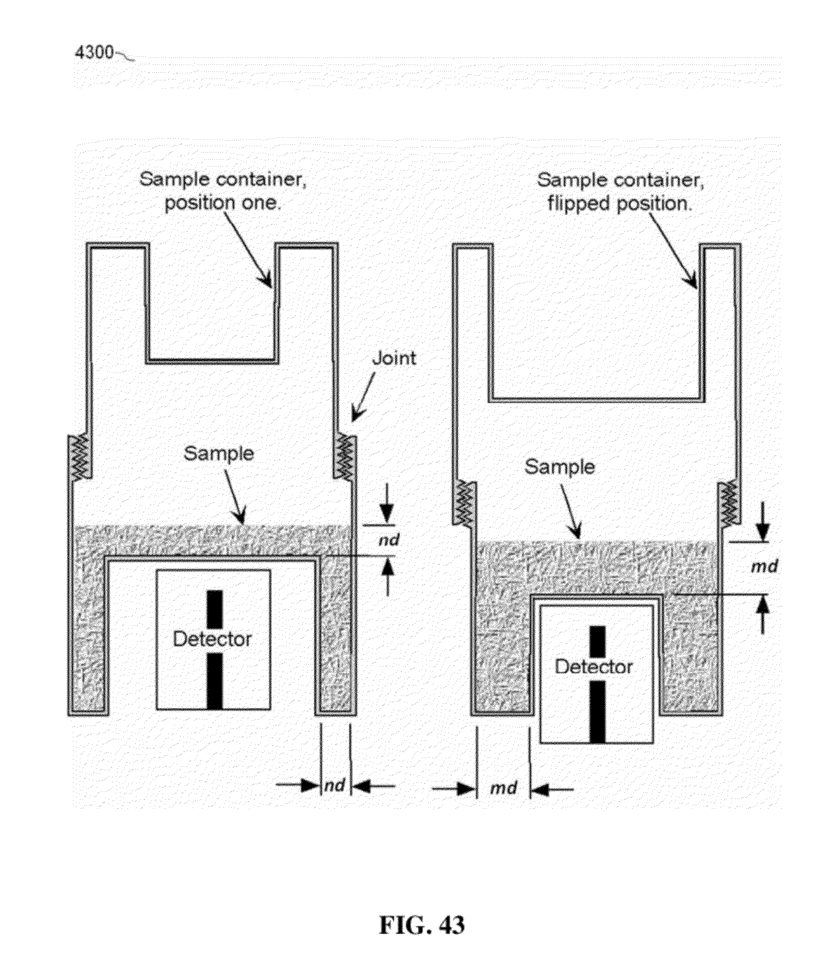

### Double-Sided Wrap-Around Sample-Container Apparatus (FIG. 43)

FIG. 43 shows an apparatus 4300 comprised of a coaxial-type signal detector and a double-sided, wrap-around sample-container apparatus. The sample-container apparatus “surmount s” the coaxial detector in order to increase the overall detection-system signal-detection efficiency. The wrap-around portions of the container form the sample, in turn, into nd and md thicknesses. The thickness of the sample positioned above the coaxial detector is also shown, in turn, as nd and md thicknesses; however, these thicknesses can vary from zero thickness to the maximum volume of the container. After counting the sample as it “sits” on one side of the double-sided container, the container is flipped 180 degrees with respect to the signal detector and counted again, so that the sample “falls” to the other side of the container, which then forms the sample into a different thickness with respect to the detector.

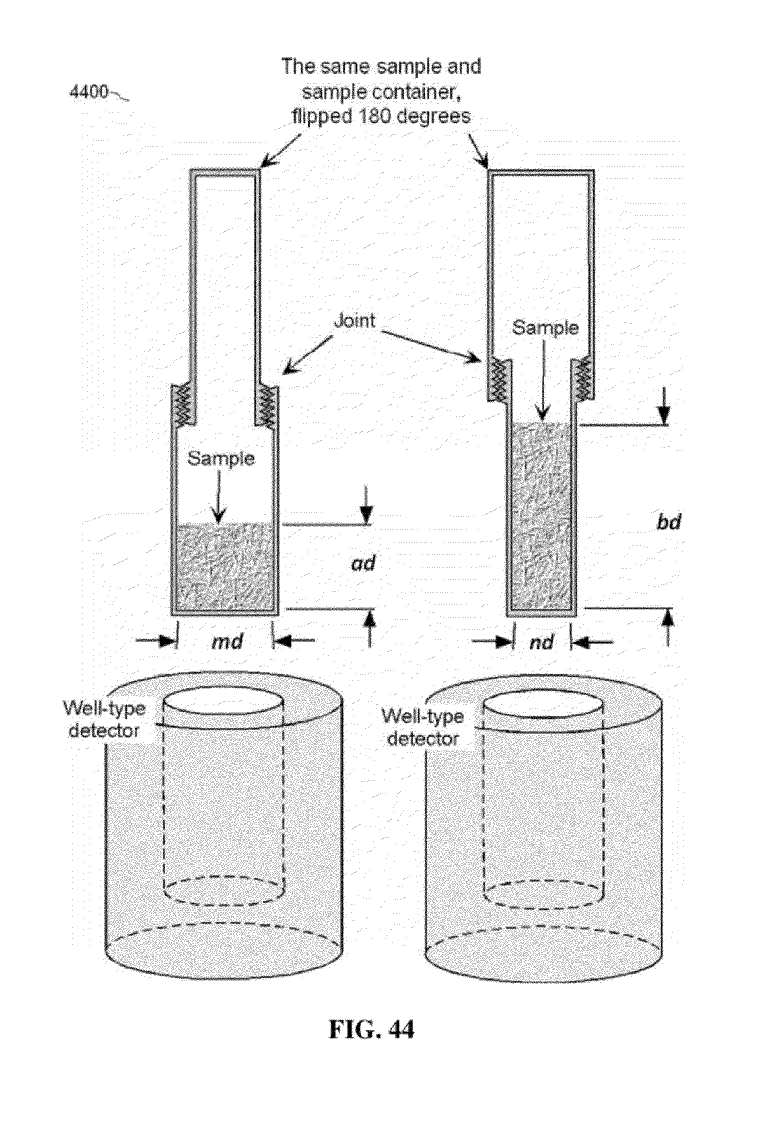

nd:md-Style Well-Type Sample-Container Apparatus (FIG. 44)

FIG. 44 shows an apparatus 4400 used in conjunction with a single well-type detector. The apparatus is shaped so that a double-sided nd: md sample may be “dropped into” the well-type detector for counting. This apparatus 4400 is well-suited for smaller samples and for low-energy characteristic signals that can escape from such small samples. The “height” (i.e. axial thickness) of the sample depends on the sample volume and diameter of the sample-container apparatus, which apparatus is limited only by the geometry of the well-type detector. The sample is counted as the sample-container apparatus “sits” inside the “well” of the well-type detector. After counting, the sample-container apparatus is “flipped” 180 degrees and counted again, but this time, the sample falls to the opposite side of the sample-container, where the sample forms into a different radial thickness, as the sample-container apparatus once again “sits” inside the “well” of the well-type detector.

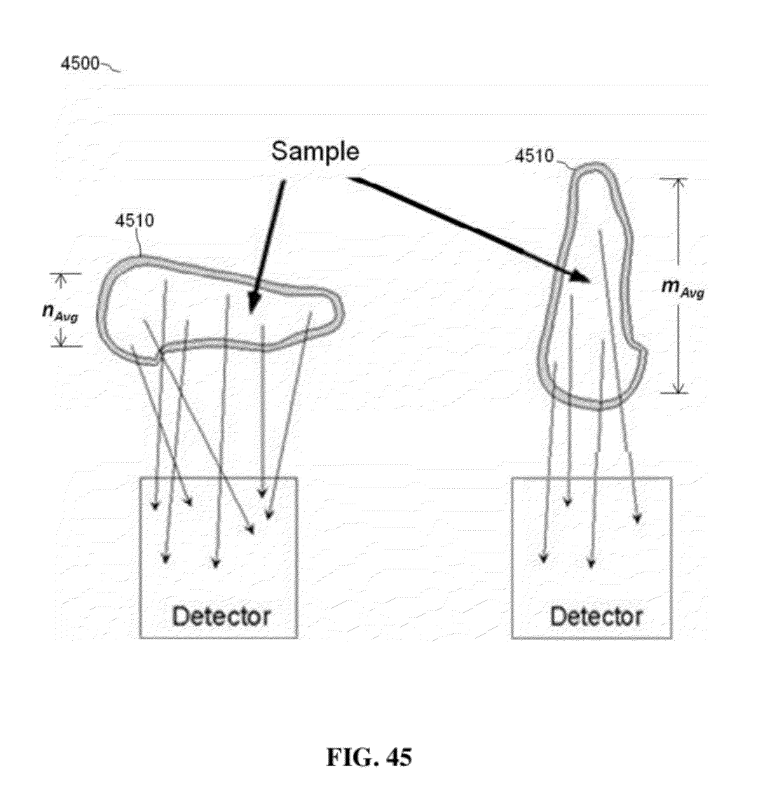

nd:md-Style Variable-Shape Sample (FIG. 45)

FIG. 45 shows an apparatus 4500 comprised of an irregularly shaped sample-container apparatus 4510 and at least one detector, where the irregularly shaped sample can be measured for an average thickness in at least two directions that result in at least two different average thicknesses, nd_{Avg} and md_{Avg}, or at which the two different average thicknesses may be estimated.

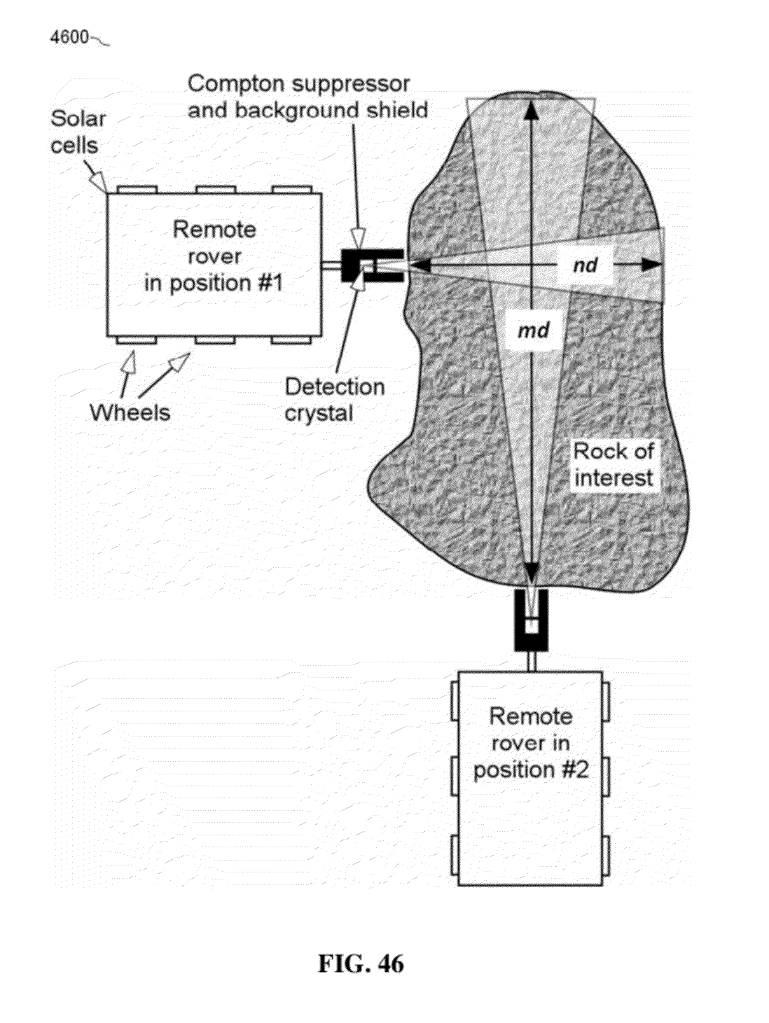

### Multiple-Sample-Thickness Rover Remote Monitoring (FIG. 46)

FIG. 46 shows a system 4600 comprised of at least one “rover” (i.e. a platform that can move on land or sea; through the air; or in outer space; and capable of transporting at least one signal detector) that can get close enough to count a sample, e.g. rock or cliff face, etc. The rover repositions itself as necessary so that the detector can count through at least two different thicknesses, nd and md, of the sample. Alternatively, two or more rovers may work in this system to simultaneously measure through two or more different thicknesses of the selected sample.

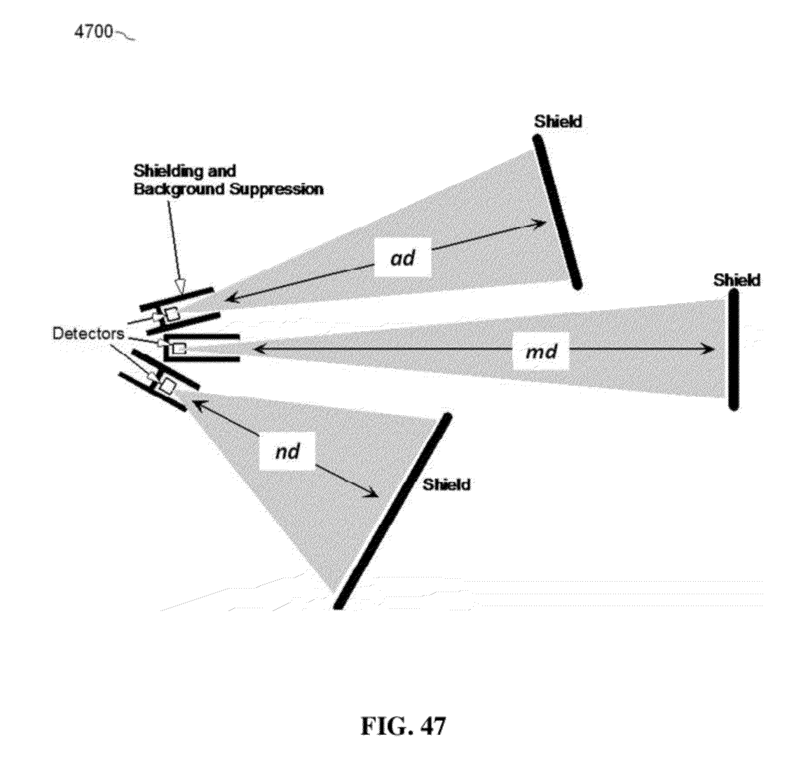

### nd:md Apparatuses and Methods for Gas-Sample-Depths (FIG. 47)

FIG. 47 shows a system 4700 of at least one detector surrounded by a collimator that defines the “cone” (i.e. sample-volume) of air to be counted, and extant shields or natural “backstops”, e.g. cliff-faces, that define the “thickness” of air being counted. If only one detector and collimator were used, then the detector or shield would need to be repositioned in order to form two different thicknesses of air to be counted. Alternatively, multiple detectors, collimators, and backstops can be used to permit simultaneous counting through two or more different thicknesses of gas or air.

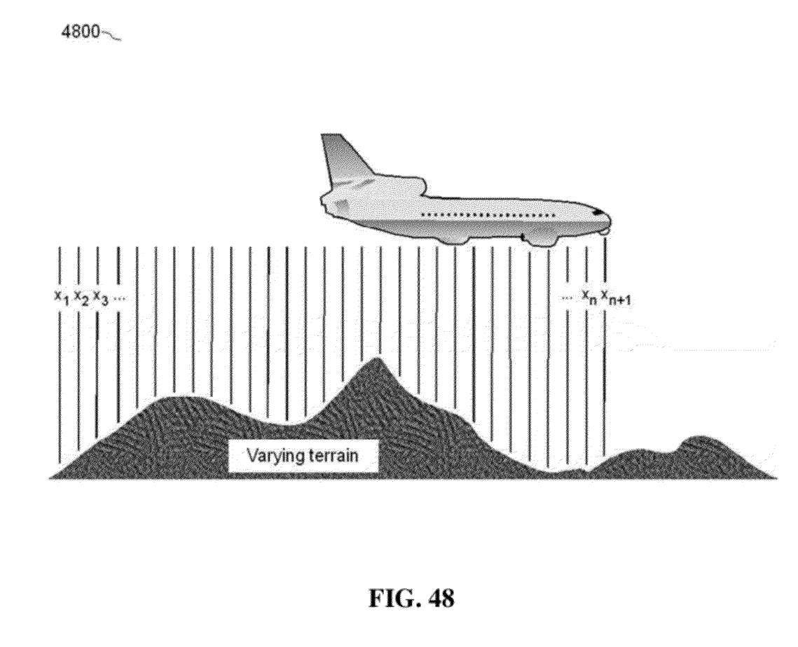

### Apparatuses and Methods for Air-Terrain Measurements (FIG. 48)

FIG. 48 shows a system 4800 of at least one airborne platform (e.g. airplane, helicopter, etc.) with at least one downward-facing signal-detection system, coupled with at least one downward-facing altimeter. As the airborne platform moves over terrain of varying heights, the altitude-measuring device computes the thickness of a column or “cone” of air, so that the nd: md techniques can be used to perform self-attenuation corrections ‘on the fly’ (no pun intended). Alternatively, a plurality of detector-collimators ‘pairs’ and range finders can be used simultaneously, with each detector-collimator and range-finder pointed at multiple, different angles toward the terrain, whether flat or irregular, so that each measures a different thickness of air-volume, so as to improve the overall statistics of the multiple measurements when ‘averaged’ together.

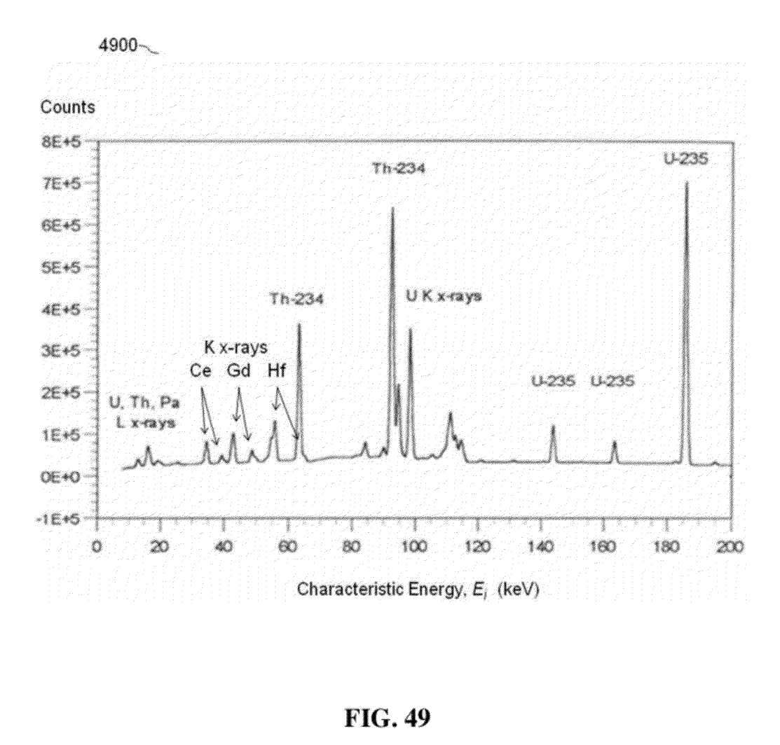

### Sample-Attenuation Via Internal Exciters (FIG. 49)

FIG. 49 shows a graph 4900 of a genuine, experimental spectrum of a heavy-metal ceramic “puck” containing a substantial quantity of uranium. The purpose of the “puck” is to isolate and store nuclear waste e.g. uranium, plutonium, other actinides, fission products, and other radioactive materials. The heavy metals in the puck, e.g. cerium, hafnium, gadolinium, zirconium, tungsten, etc., are good neutron absorbers that hinder unintentional criticality events when large numbers of pucks are stored together, and they also shield well against characteristic x-rays and gamma-rays. Nuclear weapon and nuclear reactor fuel production facilities need to dispose of high-level radioactive waste. Because of the nature of such nuclear materials, coupled with the fear of unintended criticality events, it is important to know the true composition of the sequestering materials used to contain radioactive atoms, like the heavy-metal ceramic pucks just described.

The alpha-decay of uranium and ‘daughter’ products cause other local, non-radioactive atoms to fluoresce in observable L-shell and K-shell x-ray energies characteristic to the atom emitting them. Cerium, gadolinium, and hafnium fluorescence K-shell x-ray peaks are indicated in the graph 4900. By counting the puck through at least two different thicknesses, the non-radioactive fluorescing atoms can be used to determine the “quality” (i.e. the integrity of the composition and structure) of the puck, as well as the sample-specific self-attenuation of the puck to lower-energy characteristic signals.

Normally, large samples or high-z materials like this puck wouldn't allow for beam-thru determination of sample self-attenuation below 100 keV because of the high sample self-attenuation. Determination of the concentration of the gamma-ray emitters above 100 keV allows such gamma-ray emitters to be used to calibrate down to lower energy, as low as 10 keV and possibly even lower, depending on the radioactive emitter present.

### Sample-Attenuation Via External Whole-Sample Activation

This teaching does not have a corresponding figure. In neutron activation analysis and its various forms, the sample is either put inside a reactor or within a beam port to the reactor core, and a high flux of neutrons is allowed to “soak” the sample. After soaking, or even during soaking, the sample is analyzed for gamma-ray emission from the just activated nuclides. Because x-rays and gamma-rays are emitted by the sample, nd:md techniques can be used to correct for sample self-attenuation.

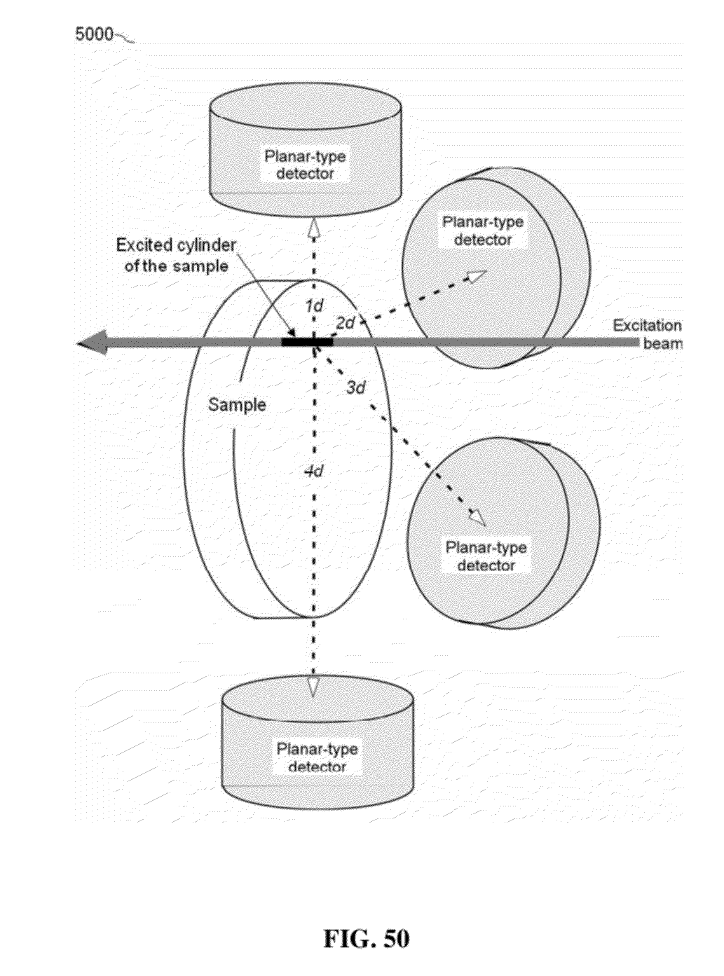

### Off-Center Narrow Beam-Thru Excitation (FIG. 50)

FIG. 50 shows a system 5000 comprised of a bulk sample; an excitation beam passing off-center through the bulk sample; and at least one detector that takes at least two sample countings through at least two different thicknesses of the bulk sample in the direction of the detector. System 5000 shows four de-excitation signals from the stimulated beam-thru volume-cylinder, that must pass through unexcited sample thicknesses (labeled, 1d, 2d, 3d, and 4d) of the bulk sample to reach the signal detectors. Applying nd: md techniques facilitates computing of the bulk sample self-attenuation of characteristic signals. Particle-induced x-ray emission using tightly focused beams-thru yield the additional capability of determining the distribution of trace elements in a wide range of bulk or other samples.

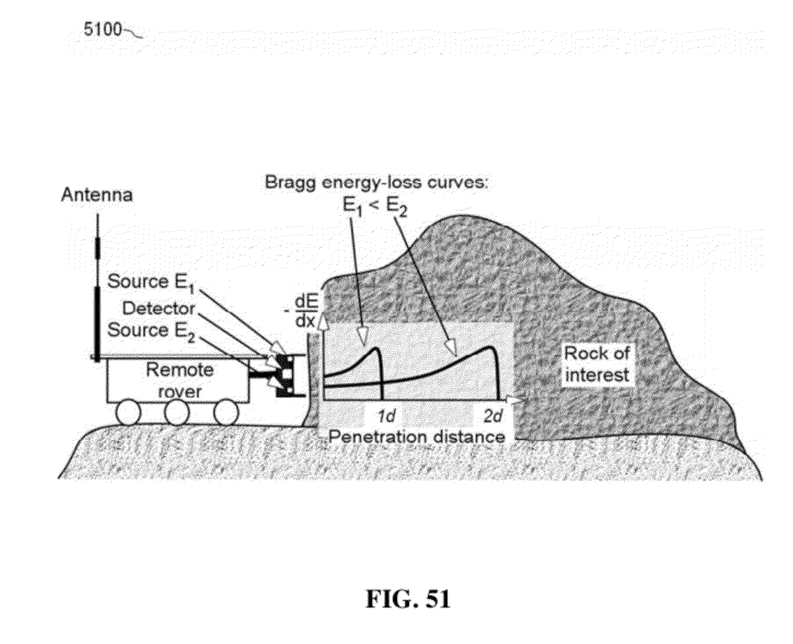

### nd:md and Multi-Energy-Beam Sample Analysis (FIG. 51)

FIG. 51 shows a system 5100 comprised of at least one “rover” (i.e. a platform that can move on land or sea; through the air; or in outer space; and capable of transporting at least one signal detector and at least two different beam energies) that can get close enough to beam to, and to count induced fluorescence from, at least two different depths of a sample, e.g. rock or cliff face, etc. System 5100 shows an example of two particle beams of different energies, passing into the sample, resulting in two different Bragg energy-loss curves, consistent with two different penetration sample-depths (called 1d and 2d).

The sample-depth at which the rapid loss of beam energy occurs depends largely on the initial energy of the penetrating particle. Thus, multiple energy particles lead to multiple-depth Bragg peaks, and such induced fluorescence x-ray or gamma-ray signals must pass through the different thicknesses of the sample in order to reach the rover-mounted detector, and thus nd:md principles can be applied to determine and correct for the sample self-attenuation.

What is claimed is:

1. An apparatus for detecting radiation signals emitted from an unknown homogeneous sample, comprising:
a sample holder comprising a plurality of holder configurations, each holder configuration enabling measurement of the radiation signals emitted by the homogeneous sample via at least two different thicknesses;
a detector system comprising one or more detectors to detect the radiation signals from different homogenous sample thicknesses; and
a computer to process the detected radiation signals and analyze the homogenous sample composition by comparing the radiation signals from different homogenous sample thicknesses by using a sample analysis software program.

2. The apparatus as in claim 1, wherein one of the sample holder configurations comprises a plurality of sample-container apparatuses, each sample-container apparatus having a different size and shape from other sample-container apparatuses such that the homogeneous sample forms different thicknesses when placed in different sample-container apparatuses.

3. The apparatus as in claim 2, wherein the sample-container apparatuses are connected with at least one shared opening to allow the homogeneous sample to transfer internally among the containers.

4. The apparatus as in claim 2, wherein the sample holder has two oppositely placed sample-container apparatuses connected with one shared opening to allow the homogeneous sample to transfer from one container to the other container when the sample holder is flipped 180 degrees.

5. The apparatus as in claim 4, wherein the two oppositely placed sample-container apparatuses are cylinders having predetermined diameters.

6. The apparatus as in claim 5, wherein the two oppositely placed sample-container apparatuses have their diameters in a ratio equal to √2:1 such that the homogeneous sample thickness ratio is 1:2 when the homogeneous sample is transferred from one container to the other container.

7. The apparatus as in claim 5, wherein the two oppositely placed sample-container apparatuses have their diameters in a ratio equal to √m:n such that the homogeneous sample thickness ratio is n:m when the homogeneous sample is transferred from one container to the other container.

8. The apparatus as in claim 4, wherein each of the two oppositely placed containers has an opening that can mate with the opening of the other container tightly.

9. The apparatus as in claim 8, wherein the mating of the containers is a thread type, a slide-on type, a vacuum-seal type, a pressure-seal type, or a compression-seal type.

10. The apparatus as in claim 1, wherein one of the sample holder configurations comprises a sample-container apparatus providing a different sample thickness relative to the detector system when the sample holder moves relative to the detector system.

11. The apparatus as in claim 10, wherein the sample in the sample-container apparatus has a rectangular cross section, wherein the short side and the long side of the rectangular container forms a ratio of n:m, wherein 0<n<m.

12. The apparatus as in claim 10, wherein the sample-container apparatus is a cuvette-type container.

13. The apparatus as in claim 10, wherein the sample-container apparatus has a stairs shape and the sample thickness relative to one or more detector systems is different for at least two steps of the stairs.

14. The apparatus as in claim 4, wherein the sample-container apparatus is a double-sided wrap-around type.

15. The apparatus as in claim 4, wherein the sample-container apparatus is a Marinelli-type container.

16. The apparatus as in claim 4, wherein the sample-container apparatus is a double-sided cylinder.

17. The apparatus as in claim 4, wherein the sample-container apparatus is a well-type container.

18. The detector system as in claim 1, comprising a plurality of detectors capable of detecting radiation signals emitted from the homogeneous sample in a predetermined energy range.

19. The detector system as in claim 18, wherein the detectors are static and the sample holder orientation moves such that the detectors measure the homogeneous sample at one or more homogeneous sample thicknesses at one time.

20. The detector system as in claim 19, wherein the detectors measure a plurality of homogeneous sample thicknesses from opposite sides of a plurality of homogeneous sample thicknesses.

21. The detector system as in claim 18, wherein the homogeneous sample is static and the plurality of detectors move such that the plurality of detectors measures multiple homogeneous sample thicknesses.

22. The detector system as in claim 18, wherein the detectors and the sample holder are static and the homogeneous sample is a flowing fluid.

23. An apparatus as in claim 1, wherein the homogeneous sample is a solid, a liquid, a gas, a plasma, or a mixture thereof.

24. The homogeneous sample as in claim 23 is flowing relative to the detector system.

25. The apparatus as in claim 1, wherein the detector system moves through the homogeneous sample and measures the homogeneous sample continuously.

26. The apparatus as in claim 1, further comprising an energy source to induce fluorescence from the homogeneous sample, wherein the energy source provides at least two different radiation energies, each having a characteristic penetration depth, wherein the penetration depth defines the homogeneous sample's thickness.

27. The apparatus as in claim 1, wherein the sample holder is made of materials such as glass, quartz, plastic, concrete, wood, ices, or ceramics.

28. The software program as in claim 1 is built based on a physics model.

29. The apparatus as in claim 1, further comprising a homogenous standard-sample emitting radiation signals in an energy range similar to the homogeneous unknown-sample to be measured.

30. The apparatus as in claim 1, wherein the software program comprises:
the signals input module for reading emitted signals from the homogeneous sample;
a background signal subtraction module;
a signal matching module, wherein each matched signal is emitted from a different thickness of the homogeneous sample;
a sample-specific escaped-fraction computation module, wherein the module comprises a first algorithm operating on signal count rates of different thicknesses of the homogeneous sample;
a standard-sample calibration module; and
a sample quantitation module.

31. The software program as in claim 30, further comprising a data qualification module comprising default or optional user-chosen qualification intervals.

32. The software program as in claim 31, further comprising a presentation module, wherein default or optional user-chosen colors for presentation purposes are assigned to qualification intervals.

33. The software program as in claim 30, further comprising a module for default or optional user-chosen removal of computed values of the sample-specific escaped-fraction term, wherein the default removal is based on qualification intervals.

34. The software program as in claim 30, further comprising a second algorithm, wherein the second algorithm comprises:
program codes to get the sum of the peak count rates,
program codes to get the difference of the peak count rates,
program codes to operate on the sum and difference of the peak count rates to improve the statistics.

35. A method for characterizing radiation signals emitted from an unknown homogeneous sample, the method comprising:
providing a radiation signal detector system comprising a plurality of detectors, a computer for analyzing the sample, and a sample holder, wherein the sample holder includes a plurality of containers, each sample-container apparatus has a different size from other sample-container apparatuses, such that the homogeneous sample forms different thickness when placed in different sample-container apparatuses;
performing background signal detection for each empty sample-container apparatus and determining a background signal count rate for each empty sample-container apparatus;
performing calibration signal detection by measuring a standard-sample sequentially in each sample-container apparatus and determining a standard signal count rate for each sample-container apparatus;
subtracting the background signal count rate from standard-sample signals for each container;
performing the signal detection for the unknown homogeneous sample in each sample-container apparatus;
subtracting the background signal count rate from the unknown homogeneous sample signals for each container;
measuring the characteristic signal count rates for the unknown-sample in each sample-container apparatus;
verifying the characteristic signal count rates to be qualified data; and
calculating the composition of the unknown homogeneous sample by comparing the characteristic signal count rates of the unknown-sample from different sample-container apparatuses using a software model.

36. The method as in claim 35, wherein the sample holder has two oppositely placed containers connected with one shared opening, and wherein performing the signal detection includes flipping the sample holder 180 degrees to allow the homogeneous sample transferring from one container to the other.

37. The method as in claim 36, wherein the two oppositely placed sample-container apparatuses are cylinders having predetermined diameters.

38. The method as in claim 37, wherein the two oppositely placed sample-container apparatuses have their diameters ratio equal to √2:1 and the sample thickness ratio is 1:2.

39. The method as in claim 35, wherein the signal detection for all sample-container apparatuses is performed sequentially.

40. The method as in claim 35, wherein the signal detection for all sample-container apparatuses is performed simultaneously.

41. The method as in claim 35, wherein verifying the characteristic signal count rates includes signal peak identification and correction.

42. A method for characterizing radiation signals emitted from an unknown homogeneous sample, the method comprising:
providing a radiation signal detecting system comprising a plurality of detectors, a computer for analyzing the sample composition, and a sample-container apparatus, the sample-container apparatus providing different sample thicknesses when the sample-container apparatus moves to a different position relative to the detector system;
performing background signal detection for each sample-container apparatus position and determining a background signal count rate for each position;
performing calibration signal detection by measuring a standard sample sequentially in each sample-container apparatus position and determining a standard signal count rate for each sample-container apparatus position;
subtracting the background signal count rate from standard sample signals for each container position;
performing the signal detection for the unknown homogeneous sample in each sample-container apparatus position;
subtracting the background signal count rate from the unknown homogeneous sample signals for each container position;
measuring the characteristic signal count rates for the unknown sample in each sample-container apparatus position;
verifying the characteristic signal count rates to be qualified data; and
calculating the composition of the unknown homogeneous sample by comparing the characteristic signal count rates of the unknown sample from different sample-container apparatuses using a software model.

43. The method as in claim 42, wherein the signal detection for all sample-container apparatus position is performed sequentially.

44. The method as in claim 42, wherein the signal detection for all sample-container apparatus positions is performed simultaneously.

45. The method as in claim 42, wherein verifying the characteristic signal count rates includes signal peak identification and correction.

46. A system for identifying radiation signals emitted from an unknown homogeneous sample, comprising:
a sample holder comprising a plurality of sample holder configurations, each sample holder configuration enabling measurement of the homogeneous sample via at least two different thicknesses;
a detector system to detect the radiation signals from different sample thicknesses, comprising at least one detector capable of detecting radiation signals emitted from the homogeneous sample in a predetermined energy range;
a standard sample emitting radiation signals in an energy range similar to the homogeneous sample to be measured; and
a software program capable of handing reading emitted signals from sample-container apparatuses, measuring a background signal, calibrating the standard sample, verifying and qualifying each signal peak in emitted signal spectrum from each sample-container apparatus, correcting emitted sample signal from each sample-container apparatus; and analyzing sample composition using a composition database; and a computer to process the detected signals and analyze the sample composition by comparing radiation signals at different sample thicknesses from different containers by using the software program.

47. The system as in claim 46, wherein one of the sample holder configurations comprises a plurality of sample-container apparatuses, each sample-container apparatus having a different size and shape from other sample-container apparatuses, so the homogeneous sample forms different thickness when placed in different sample-container apparatuses.

48. The system for identifying radiation signals as in claim 47, wherein the sample holder has two oppositely placed containers connected with one shared opening to allow the homogeneous sample transferring from one container to the other container when the sample holder is flipped 180 degrees; wherein the two oppositely placed sample-container apparatuses are cylinders having predetermined diameters.

49. The system as in claim 48, the two oppositely placed sample-container apparatuses have their diameters ratio equal to √2:1 and the sample thickness ratio is 1:2 when the homogeneous sample is transferred from one container to the other container.

50. The system as in claim 46, wherein one of the sample holder configurations comprises a sample-container apparatus providing different sample thicknesses when the sample holder moves relative to the detector system.

51. The system as in claim 50, wherein the sample in the sample-container apparatus has a rectangular cross section.

52. The system as in claim 51, wherein the long side and the short side of the rectangular container forms a ratio of n:m, wherein 0<n<m.

53. A software product embedded in a computer readable medium for providing analysis in material spectra characterization, the software product comprising:
program codes for reading the emitted signals from the homogeneous sample;
program codes for subtracting a background signal;
program codes for matching signals emitted from a different thickness of the homogeneous sample;
program codes for operating on signal count rates of different thicknesses of the homogeneous sample;
program codes for calibrating a standard sample signals; and
program codes for quantization of the material spectra.

54. The software product as in claim 53, further comprising program codes to choose a default or optional user-chosen intervals.

55. The software product as in claim 53, further comprising program codes to present default or optional user-chosen colors as qualification intervals.

56. The software product as in claim 53, further comprising program codes to present default or optional user-chosen colors as qualification intervals.

57. The software program as in claim 53, further comprising program codes to calculate the sum and the difference of the homogeneous sample peak count rates at different thicknesses, and to operate on the sum and difference of the peak count rates to improve the statistics.
